(19) United States
(12) Patent Application Publication
(10) Pub. No.: US 2012/0021943 A1
(43) Pub. Date: Jan. 26, 2012

(54) MULTIPLE GENETIC DISEASE DIAGNOSTIC PANELS BY ONE SINGLE TEST USING MICROARRAY TECHNOLOGY

(75) Inventors: Purificação Tavares, Porto (PT); Aida Palmeiro, Coimbra (PT); Paula Rendeiro, Porto (PT)

(73) Assignee: CGC GENETICS/CENTRO DE GENETICA CLINICA, SA, Porto (PT)

(21) Appl. No.: 13/148,829

(22) PCT Filed: Feb. 11, 2009
(86) PCT No.: PCT/IB2009/000434

§ 371 Date: Oct. 11, 2011

(51) Int. Cl. C40B 30/04; C40B 50/00; C40B 40/06; C40B 50/02

(52) U.S. Cl. 506/9; 506/24; 506/23; 506/16

(57) ABSTRACT

The invention utilizes clinical features of diseases with a genetic background to define logical panels of diseases which have shared signs or symptoms. The invention includes methods for collecting data for use in determining a cause or risk factor for disease and includes micro arrays for use in detecting mutations associated with the diseases set forth in the panel.

### FIELD OF THE INVENTION

The present invention relates to methods of achieving fast and inexpensive determination of a cause or risk factor of diseases with genetic background and to kits and arrays that are useful for the diagnoses of disease. The method of the invention includes tests for mutations in the genes most commonly involved in the diseases or disorders, using capture nucleotide sequence micro array techniques.

### BACKGROUND OF THE INVENTION

Genetic diagnosis, nowadays, is based on clinical evaluation and differential diagnosis, whereby one hypothesis is raised, to be confirmed or excluded by molecular methods. If this one is negative, another hypothesis is raised and tested. If this is also negative, another will be tested and so on. This makes genetic diagnosis a long, complex, time consuming and expensive process.

There are 6,000 genetic diseases and 1,100 molecular genetic tests (Khoury et al, 2008). The decision to perform a certain test is determined by familial and personal history and, especially, by the proband's clinical features.

Diseases with genetic background affect different organ systems not only as a primary disease, but very often as a syndromic entity that can include metabolic, neurological, musculoskeletal or developmental symptoms. The consequences of one single point mutation, can be detected by different medical specialties as affecting different body systems. In fact, syndromes resulting from single point mutations can be observed in all medical specialties.

As a consequence of the current approach, the skills necessary to approach the correct syndrome hypothesis require a profile in medical genetics so broad that very few specialists have it. What is needed is a device and method to achieve diagnosis that allows diverse specialists to reach a correct diagnosis.

Clinical features of a specific disease are often variable from one patient to another, due to expression and penetrance of each condition. On the other hand, there is a large overlap of specific clinical characteristics between diseases. This means that symptoms observed can correspond to many more than one pathology, and the molecular diagnosis can implicate testing for a large number of genes. This reality makes genetic diagnosis a time-consuming and expensive process, while the individual remains undiagnosed.

The long and expensive testing currently available has consequences on the routine healthcare of the patients: increased risk of inappropriate therapeutic decisions, delay of important clinical decisions, and lack of prenatal diagnosis for the disease available for pregnant relatives. The anxiety created by the uncertainty of obtaining a diagnosis in an individual or family, along with this multiple unsuccessful testing, generates absentism and is an important stress factor both in the familial and social environment.

The currently available technical approaches are inadequate. There is a need for a new tool for genetic diagnosis that is: solid, consistent, fast, cost-effective; that has valuable and crucial clinical utility; and that could be used in many cases where the diagnosis is not well defined, as well as be used by other physicians besides medical geneticists.

Molecular genetic techniques are the tools used to confirm clinical diagnosis of genetic diseases, by searching for mutations in a specific gene that can explain these pathologies. However, these techniques have limitations, namely the time needed for completion of the study and the cost of the tests. A genetic diagnosis usually entails a sequential study of different genes, and continues as long as all the diagnostic hypotheses need to be excluded. For each patient a succession of genes must be studied, one at a time (study gene A, if negative go to gene B, if negative go to gene C, and so on). There is also the circumstance that in some diseases, several genes could be involved. Nonetheless, in such a case, the approach currently used is the sequential analysis, exactly because of the cost of testing.

### SUMMARY OF THE INVENTION

The present invention relates to methods of achieving a fast, inexpensive diagnosis of diseases with genetic background, using a unique approach. This invention utilizes clinical features of the diseases to define logical panels of study arranged by groups of signs or symptoms of the diseases. The method of the invention includes tests for point mutations described in the genes most commonly involved in the diseases or disorders, using capture nucleotide sequence micro array techniques.

Thus, the present invention relates to the selection of several panels of genetic diseases with shared signs and symptoms. The disease panels are used to organize the preparation of custom made DNA arrays capable of detecting the respective gene mutations associated with the diseases in a panel. The DNA arrays are used to screen patient samples for the respective gene mutations and the results can be useful in diagnosis of genetic diseases. Preferably, prenatal and pediatric diseases can be screened.

The organization of genes and mutations of diseases with shared symptoms and signs makes a unique method in pediatric and prenatal care, by reducing not only the costs of sequential genetic testing, but also reducing the time needed to complete genetic evaluation, and therefore making this process of crucial clinical utility.

The present invention includes custom made micro arrays that can detect point mutations related to the different diseases grouped into the logical panels described above and methods for using such arrays. For example, the diagnostic arrays can be used in prenatal and pediatric testing for diseases with a genetic background.

An additional aspect of the invention is a method for determining a cause or a risk factor of symptoms of a disease or disorder, wherein the method includes obtaining a sample from a patient, testing the sample for the presence or absence of alleles associated with a disease or disorder included in a test panel of diseases or disorders and making a determination based upon the result of the test. The method can be of useful assistance in the diagnosis of a disease.

In one single test the custom made arrays offer the result for a hypothesis that has been raised and offer the result for diseases that constitute diagnostic alternatives as well.

Accordingly, in a first aspect, the invention features a method of collecting data for use in determining a cause of diseases or disorders with genetic background, comprising: a) organizing diseases or disorders with genetic background into panels of diseases or disorders, wherein a panel is a group of diseases or disorders having shared signs or symptoms; b) matching a patient's signs and symptoms to the signs and symptoms of a first panel; c) testing a sample derived from the patient's genetic material using a micro array that comprises nucleotide sequences capable of detecting genetic mutations associated with each of the diseases of the first panel; and d) detecting whether the patient sample includes one or more genetic mutations associated with one or more diseases of the panel.

In a preferred embodiment, the panels comprise:

a. genetic diseases with obesity with mental retardation;

b. genetic diseases with post-natal short stature, broad or webbed neck, heart defects including cardiomyopathy, psychomotor developmental delay, macrocephaly;

c. genetic diseases with “special” behaviour and microcephaly;

d. genetic diseases with craniosynostosis;

e. genetic diseases with chondrodysplasia;

f. genetic diseases with bone dysplasias;

g. genetic metabolic diseases;

h. genetic diseases with neurological disorders;

i. genetic diseases with syndromic and non-syndromic hearing loss;

j. genetic diseases with “special” behaviour—autism;

k. genetic diseases with retinopathy; and

l. genetic diseases with seizures (epilepsy).

In another aspect, the invention features a method of organizing data for use in determining a cause of genetic diseases or disorders comprising: identifying genes associated with genetic diseases or disorders, identifying point mutations within the genes, and programming a computer to categorize for each genetic disease: a) the mutations known to directly cause the disease, b) the most frequent mutations of the disease, and c) the mutations described in more than one patient history. In an alternative embodiment, the method further categorizes mutations with an ethnic distribution for consideration when a patient is a member of an ethnic group associated with such a mutation. In an alternative embodiment, private and familial mutations are excluded from consideration. In a preferred embodiment, the diseases or disorders are organized into panels according to shared phenotypic signs or symptoms. In one embodiment the panels described above are used and the diseases and gene mutations set forth in the tables are considered.

In another aspect, the invention features a method for organizing genetic causes of disease, wherein the method comprises: a) grouping genetic diseases with similar symptoms and physical signs into panels; b) identifying the genes associated with each of the diseases; c) identifying point mutations within each of the genes, the mutations being associated with the disease state; and d) creating one or more micro array(s) containing capture nucleotide sequences, each of the capture nucleotide sequences being capable of hybridizing to a nucleotide sequence containing a point mutation identified in step (c). In a preferred embodiment, the method also includes the steps of e) hybridizing the micro array(s) with nucleotide sequences obtained by processing a sample of patient tissue; and f) detecting hybridized sequence(s).

In yet another aspect, the invention features a method for collecting data for use in diagnosing a disease, comprising: a) testing a tissue sample from a patient for the presence or absence of one or more alleles associated with a disease, wherein the testing comprises processing the sample to obtain nucleotide sequences consistent with sequences in the patient's genome and hybridizing one or more of the patient's genomic nucleotide sequences to one or more probe nucleotide sequences, wherein each of the probe nucleotide sequences hybridizes to at least part of an allele associated with a known disease or disorder, and b) detecting whether the patient has the allele associated with the known disease or disorder.

Another aspect of the invention features a method for determining a cause for a disease or a group of diseases with a genetic background, comprising: obtaining a sample from a patient; testing the sample for the presence or absence of alleles of at least one mutation associated with the disease; obtaining a result of the testing and making a determination whether the patient has the allele associated with the disease based upon the result of the screening.

One aspect of the invention is a micro array for a panel of diseases or disorders with genetic background wherein the micro array comprises nucleotide sequences capable of detecting point mutations of genes related to each of the diseases or disorders in the panel. In a preferred embodiment, the panels of diseases comprise the twelve panels previously enumerated with regard to the inventive methods.

Yet another aspect of the invention features a kit for a single sampling diagnostic test for a broad array of diseases comprising: a) a collection device for a patient sample; b) a solution of assay-specific primer nucleic acid sequences for producing nucleic acid sequences associated with particular diseases or disorders with genetic background; and c) a micro array as described above.

Other features and advantages of the invention will be apparent from the following detailed description, and from the claims.

### BRIEF DESCRIPTION OF THE DRAWINGS

FIG. 1 is a stylized overview of interconnected computer system networks.

FIG. 2 is a flow diagram of a system for implementing the method of organizing data for use in determining a cause of genetic diseases or disorders.

### DETAILED DESCRIPTION OF CERTAIN EMBODIMENTS

Micro-array is a recent technology that allows multiplex detection of genetic markers (more than 100), including point mutations, in one single assay. Briefly this methodology consists of DNA extraction from a patient's tissue sample, amplification of determined DNA sequences (the genetic markers), hybridization with capture sequences and detection. The use of specific bioinformatics tools provides a short term analysis of the detected sequences, thus making this technology a fast and less costly way of studying genes.

The possibility of studying a group or panel of multiple genes associated with a specific clinical profile (not a syndrome alone but a group of features common to several diseases), represents a unique step in pediatric and prenatal care, by reducing not only the costs of sequential genetic testing, but also reducing the time needed to complete genetic evaluation, and therefore making this process of crucial clinical utility.

Micro-array methodologies allow the study of multiple mutations associated with multiple genes, in short turnaround time and at much reduced cost, as much as 90% reduction, thus making possible the organization of tests oriented to the study of the mutations in genes involved in groups of diseases with a specific panel of overlapping symptoms or signs.

In the case of prenatal diagnosis or diagnosis of pediatric diseases, or other diseases with a known genetic component, it is important to organize the panels of the possible genetic causes in order to provide a rapid and informative result about several similar conditions.

The approach we are creating is based on a method of grouping diseases with similar signs and symptoms. This inventive organization of information enables selection of the genes and the mutations in each gene to be analyzed, in a broad sweep, making it easier for the physician requesting the test, and providing, in one single step, results that are clinically diagnostic.

For each genetic disease, the gene(s) and important mutations were characterized, evaluated and selected. For example: for Noonan Syndrome 4 genes (KRAS, PTPN11, RAF1, SOS1 ) and 96 mutations were selected, making this the largest panel ever available. The criteria for inclusion of mutations were: 1) all the mutations directly causing the possible disease, 2) the most frequent and 3) those described at least in more than one case (private and familial mutations were excluded). Mutations with an ethnic distribution were also included, to be used only in respective groups.

After the final list of diseases was compiled, review of their phenotypes was done by a board of pediatricians and clinical geneticists, in order to determine their shared signs and symptoms (ie. mental retardation, short stature, hearing loss, craniosynostosis, bone dysplasias, etc). This was done for all the diseases on the list.

With the evaluation described above consistent groups of diseases by signs and symptoms were organized. For example: a child with post-natal short stature, broad or webbed neck, heart defects including cardiomiopathy, psychomotor developmental delay, macrocephaly; would be included in a panel, which includes diagnosis for: Noonan Syndrome, Costello Syndrome, LEOPARD Syndrome and Cardiofaciocutaneous Syndrome.

The groups of signs and symptoms created are:

1. Genetic diseases with obesity with mental retardation;

2. Genetic diseases with post-natal short stature, broad or webbed neck, heart defects including cardiomiopathy, psychomotor developmental delay, macrocephaly;

3. Genetic diseases with “special” behaviour and microcephaly;

4. Genetic diseases with craniosynostosis;

5. Genetic diseases with chondrodysplasia;

6. Genetic diseases with bone dysplasias;

7. Genetic metabolic diseases;

8. Genetic diseases with neurological disorders;

9. Genetic diseases with syndromic and non-syndromic hearing loss;

10. Genetic diseases with “special” behaviour—autism;

11. Genetic diseases with retinopathy;

12. Genetic diseases with seizures (epilepsy)

Applying the criteria defined for the selection of the genes and respective mutations, the panels for each group include the diseases with a genetic background, the genes and number of mutations as follows:
1. Genetic diseases with obesity with mental retardation
   Bardet-Biedl syndrome, genes BBS1 (25 mutations), BBS10 (19 mutations), BBS12 (7 mutations), BBS2 (16 mutations), BBS4 (12 mutations), BBS5 (5 mutations), BBS4 (12 mutations), BBS9 (5 mutations), TRIM32 (3 mutations), MKKS/BBS6 (22 mutations), ARL6/BBS3 (5 mutations) and TTC8/BBS8 (3 mutations)
   Cohen syndrome, gene VPS13B (3 mutations)
2. Genetic diseases with post-natal short stature, broad or webbed neck, heart defects including cardiomiopathy, psychomotor developmental delay, macrocephaly
   Costello syndrome, gene HRAS (7 mutations)
   LEOPARD syndrome, gene PTPN11 (7 mutations)
   Noonan syndrome, genes KRAS (9 mutations), PTPN11 (50 mutations), RAF1 (14 mutations) and SOS1(23 mutations)
   Cardiofaciocutaneous syndrome, genes MAP2K1 (7 mutations), MAP2K2 (10 mutatons), KRAS (4 mutations) and BRAF (26 mutations)
3. Genetic diseases with “special” behaviour and microcephaly
   Rett syndrome, genes MECP2 (8 mutations)
   Cornelia de Lange, gene NIPBL (3 mutations)
   Smith-Magenis syndrome gene RAI1 (3 mutations)
4. Genetic diseases with craniosynostosis
   Muenke syndrome, gene FGFR3 (1 mutations)
   Apert syndrome, gene FGFR2 (1 mutation)
   Crouzon syndrome, genes FGFR2 (1 mutation) and FGFR2 (1 mutation)
   Jackson-Weiss syndrome, gene FGFR2 (1 mutation)
   Pfeiffer syndrome, gene FGFR1 (1 mutation)
   Saethre-Chotzen syndrome, gene FGFR2 (1 mutation)
   Craniosynostosis with elbow joint contracture, gene FGFR2 (1 mutation)
   Carpenter syndrome, gene RAB23 (2 mutations)
5. Genetic diseases with chondrodysplasia
   Zellweger Syndrome, genes PEX1 (3 mutations) and PEX26 (2 mutations)
   Rhizomelic Chondrodysplasia Punctata Type 1, gene PEX7 (8 mutations)
   Recessive Chondrodysplasia Punctata 1, X-Linked, gene ARSE (6 mutations)
   CHILD syndrome gene EPB (1 mutation)
   Conradi-Hünermann syndrome, X-linked dominant, gene EPB (2 mutation)
   Autosomal dominant multiple epiphyseal dysplasia, genes COMP (6 mutations) and MATN3 (1 mutation)
6. Genetic diseases with bone dysplasias
   Achondrogenesis II-hypochondrogenesis gene COL2A1 (3 mutations)
   Achondrogenesis type 1B, gene SLC26A2 (4 mutations)
   Achondroplasia, gene FGFR3 (3 mutations)
   Thanatophoric dysplasia, gene FGFR3 (5 mutations)
   Osteogenesis imperfecta, autosomal recessive genes CRTAP (4 mutations) and LEPRE1 (3 mutations)
   Campomelic dysplasia, gene SOX9 (20 mutations)
7. Genetic metabolic diseases
   Alkaptonuria, gene HGD (5 mutations)
   Alpha-mannosidosis, gene MAN2B 1 (4 mutations)
   Biotinidase deficiency, gene BTD (6 mutations)
   Carnitine palmitoyltransferase II deficiency, gene CPT2 (8 mutations)
   Medium-chain acyl-coenzyme A dehydrogenase, gene ACADM (1 mutation)
   LCHAD, gene HADHA (2 mutation)
   Tyrosinemia, gene FAH (7 mutation)
   Galactosemia (including Duarte variant) gene GALT (8 mutation)
   Gaucher disease, gene GBA (9 mutation)
   Glycogen storage disease type I, genes G6PC (3 mutation) and SLC37A4 (1 mutation)
   Glycogen storage Tipe II (Pompe disease), gene GAA (3 mutations)
   Glycogen storage Tipe type V (McArdle disease), gene PYGM (4 mutations)
   Hexosaminidase A deficiency (Tay-Sachs disease) gene HEXA (8 mutations)
   Krabbe disease (late onset) gene GALC (1 mutation)
   Wilson disease, gene ATP7B (1 mutation)
   Metachromatic leukodystrophy, gene ARSA (5 mutation)
   Jansky-Bielschovsky Disease, gene CLN2 (2 mutation)
   Neuronal ceroid lipofuscinoses, genes CLN5 (5 mutations), CLN8 (1 mutation) and NPC1 (3 mutations)
   Niemann-Pick disease type C, genes NPC1 (5 mutations) and NPC2 (6 mutations)
8. Genetic diseases with neurological disorders
   Hyperkalaemic periodic paralysis, genes SCN4A (26 mutations) and CACNA1S (5 mutations)
   Paramyotonia congenita, gene SCN4A (8 mutations)
   Spastic paralysis, infantile-onset ALS2 (2 mutations)
9. Genetic diseases with syndromic and non-syndromic hearing loss
   Hearing loss, non-syndromic, autosomal dominant, genes ACTG1 (6 mutations), COCH (1 mutation), CRYM (2 mutations), DFNA5 (2 mutations), DIAPH1 (1 mutation), GJB2 (10 mutations), GJB3 (3 mutation), GJB6 (1 mutation), KCNQ4 (1 mutation), MYH14 (5 mutations), MYO1A (7 mutations), MYO7A (4 mutations), TECTA (7 mutations) and WFS1 (1 mutation)
   Hearing loss, non-syndromic, autosomal recessive, genes GJB2 (79 mutations), SLC26A4 (38 mutations), OTOF (33 mutations), CDH23 (21 mutations), GJB3 (3 mutations), GJA1 (2 mutations), MYO7A (2 mutations), OTOA (1 mutation), TECTA(1 mutation) and TMC1 (1 mutation)
   Branchiootorenal syndrome, genes EYA1 (3 mutations), SIX1 (2 mutations) and SIX5 (4 mutations)
   Pendred syndrome, recessive, nonsyndromic, gene SLC26A5 (1 mutation) and syndromic, gene SLC26A4 (57 mutations)
   Usher syndrome Type I, genes MYO7A (52 mutations), USH1C (2 mutations), USH1G (3 mutations), CDH23 (20 mutations) and PCHD15 (10 mutations)
   Waardenburg syndrome, gene PAX3 (42 mutations)
   X-linked mixed deafness gene POU3F4 (13 mutations)
10. Genetic diseases with “special” behaviour—Autism
   Autism; genes NLGN4 (4 mutations), PTEN (4 mutations), NLG3 (1 mutation), MECP2 (5 mutation) and SCN2A (1 mutation)
11. Genetic diseases with retinopathy
   Leber congenital amaurosis, genes CRB1 (49 mutations), AIPL1 (22 mutations), GUCY2D (55 mutations), RPE65 (40 mutations), CEP290 (19 mutations), RPGRIP1 (23 mutations), RDH12 (8 mutations) and CRX (8 mutations)
   Retinitis pigmentosa autosomal dominant, genes RP1 (23 mutations), ROH (108 mutations), IMPDH1 (9 mutations), PRPF31 (20 mutations) and NR2E3 (1 mutation)
   Retinitis pigmentosa autossomal recessive, genes RPE65 (19 mutations), ABCA4 (7 mutations), USH2A (5 mutations), PDE6B (19 mutations) and PDE6A (10 mutations)
   Retinitis pigmentosa X 1Inked, genes RPGR (73 mutation) and RP2 (33 mutation)
12. Genetic diseases with seizures (epilepsy)
   Neonatal-infantile seizures, gene SCN2A (9 mutations)
   Benign neonatal included with myokymia epilepsy, gene KCNQ2 (38 mutations)
   Different degrees of febrile seizures, gene GABRG2 (5 mutations)
   Epilepsy with nocturnal wandering and ictal fear, gene CHRNA2 (1 mutations)
   Nocturnal frontal lobe epilepsy, genes CHRNA4 (3 mutations) and CHRNB2 (5 mutations)
   Progressive myoclonus epilepsy, genes CSTB (6 mutations) and EPM2A (24 mutations)
   Myoclonic epilepsy of Lafora, gene NHLRC 1 (34 mutations)
   Pyridoxine-dependent epilepsy, gene ALDH7A1 (20 mutations)
   Neonatal epileptic encephalopathy, gene PNPO (4 mutations)
   Partial epilepsy with auditory features, gene LGI1 (1 mutation)
   Generalised epilepsy with febrile seizures, gene SCN1B (4 mutations)
   Rett syndrome variant with infantile spasms, gene CDKL5 (3 mutations)
   Encephalopathy with early epilepsy, gene CDKL5 (2 mutations)

Micro-arrays are robust methodologies which allow the study of multiple mutations, associated with multiple genes, in a short turnaround time and much reduced costs, as much as 90% reduction, and thus making possible the organization of tests oriented to the study of the mutations in genes involved in groups of diseases with a specific panel of overlapping symptoms or signs.

A representative commercial system suitable for running the assays is the Illumina GoldenGate Genotyping Assay with the VeraCode Techology. The system is considered one of the most robust systems for SNP genotyping at this moment, is ideally suited for custom assay panels, and can achieve 96 and 384 multiplexing within a single well of a standard microplate.

The ease of the GoldenGate Assay workflow allows for a high degree of multiplexing during the extension and amplification steps, thereby minimizing time, reagent volumes, and material requirements of the process and the solution-based kinetics of VeraCode technology enables data quality at a fraction of the price of other technologies. The Illumina GoldenGate Assay has been shown over the years to be a highly robust SNP genotyping assay and was used to generate approximately 70% of the Phase I International HapMap Project.

The VeraCode Technology platform is composed of two major components. The first is the VeraCode Bead, a holographically inscribed silica glass cylinder with dimensions of 28 by 240 microns. Because the beads are made of silica, their surfaces are well suited as substrates for molecular assays.

The VeraCode Beads are hybridized in suspension and represent an assay with a solid substrate but with the advantageous kinetics and handling characteristics of a solution.

The second component of the platform is the BeadXpress™ Reader, a two-color detection instrument that identifies individual bead types and detects their assay hybridization signals, detecting the results from both alleles of 96 or 384 different SNP loci per sample.

The adaptation of the GoldenGate Assay for the VeraCode platform maintains the consistency between this assay and the existing Sentrix® Array Matrix protocols with the benefits from the refinement and validation gained from supporting the assay for more than four years across hundreds of sites worldwide. The current protocol on the VeraCode platform is identical to the previous protocol for all steps before the suspension of assay targets in hybridization buffer. Hybridization steps were optimized to take advantage of the strengths of the VeraCode system and of the fact that beads are suspended in solution, which reduces the hybridization time to three hours, compared to the 16 hours needed in the SAM platform, which employs solid-phase planar array hybridization. The substantial improvement in hybridization time reduces the total assay time from three days to two. (The VeraCode tecnology and the BeadXpress is covered by U.S. Pat. Nos. 6,355,431, 6,489,606, 6,681,067, 7,106,513, 7,126,755 and pending patent applications) the entirety of which is hereby incorporated by reference into this application.

In some embodiments of the invention, a sample of nucleic acid extracted from a small blood sample, saliva, aminiotic fluid or chorionic villi is used to carry out the micro array screening or testing procedure. Once a nucleic acid sample is obtained for an individual, it can be manipulated in a number of ways to prepare it for analysis on a micro array. The preparatory techniques mentioned above are familiar to those of skill in the art.

The advantages of a micro array-based diagnosis are its accuracy, simplicity, efficiency and extreme cost-effectiveness when employed on a systematic basis. Using conventional technology, detection for specific mutations of all possible genes would be infinitely complex, expensive and time consuming (years in some cases).

The invention further relates to a method and system of online evaluation of a patient in which the patient's signs and symptoms are matched to the signs and symptoms of predetermined panels of diseases that share common signs and symptoms. Once the association to one or more panels is made, further genetic data of the patient can be considered to assist in determining a cause or risk factor of the patient's condition.

Although the present invention which includes a method and system for organizing data with online access is particularly well suited for implementation as an independent software system and shall be so described, the present invention is equally well suited for implementation as a functional/library module, an applet, a plug in software application, as a device plug in, and in a microchip implementation.

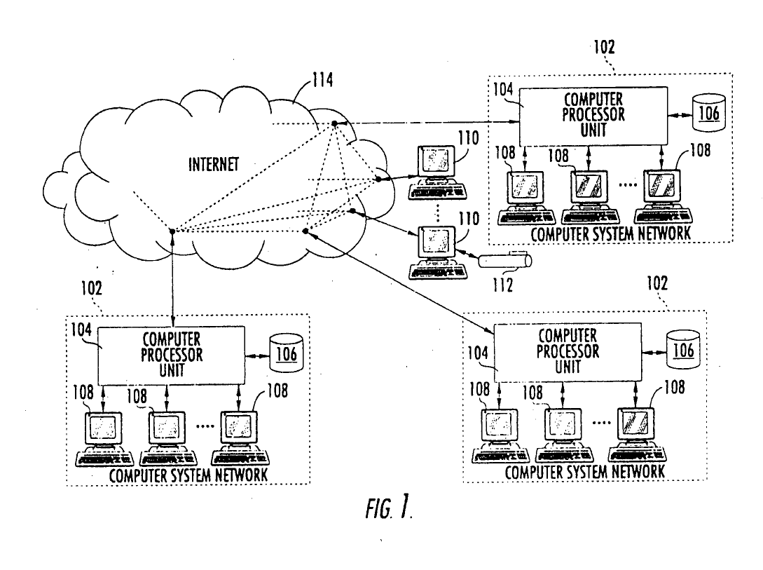

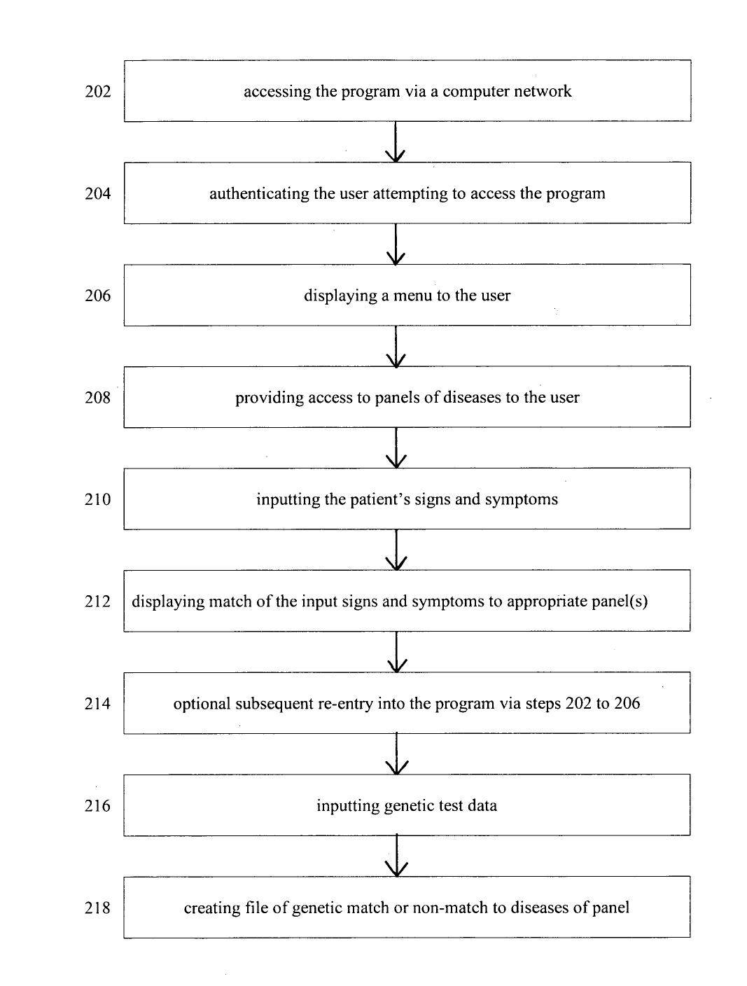

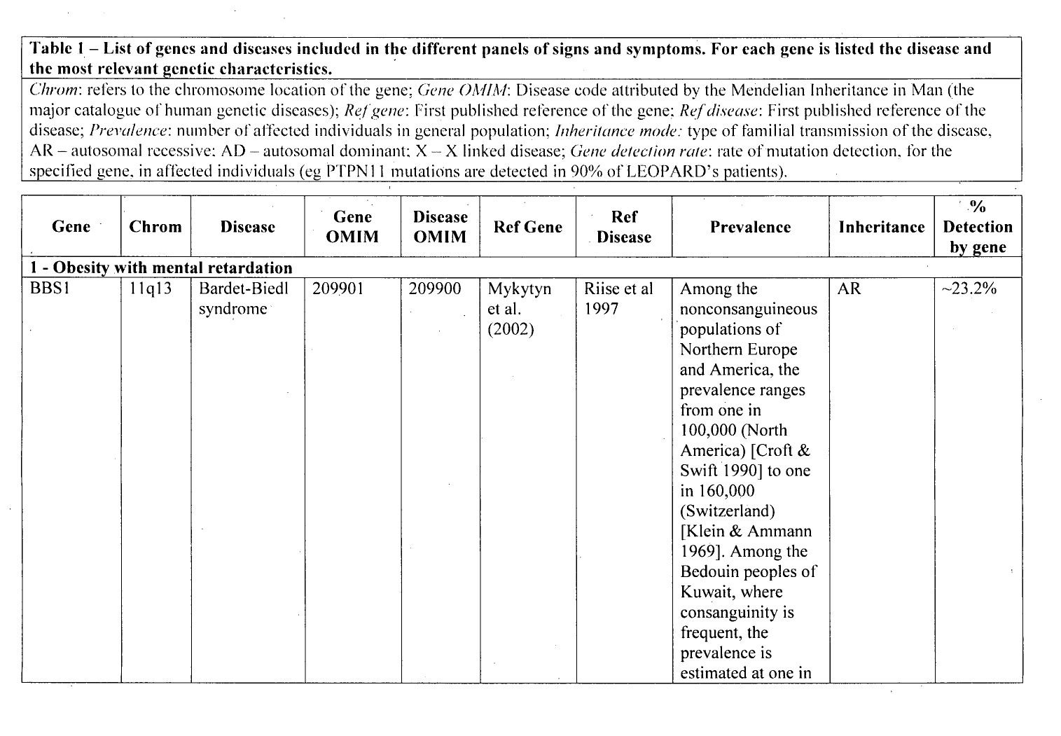

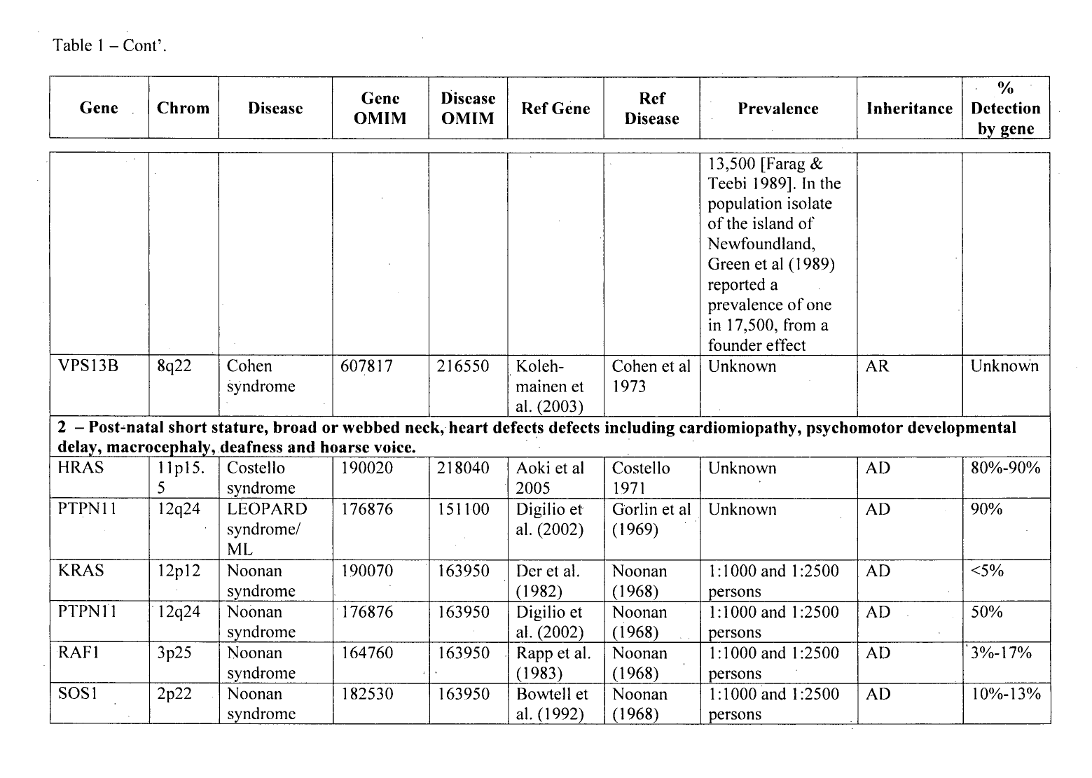

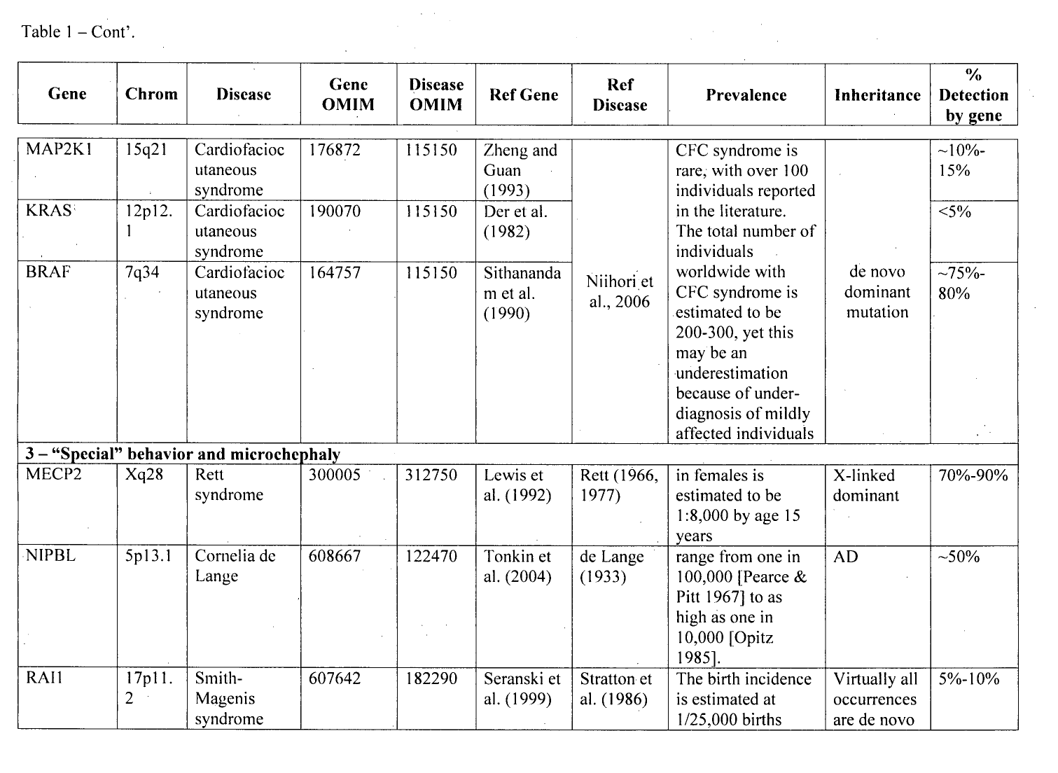

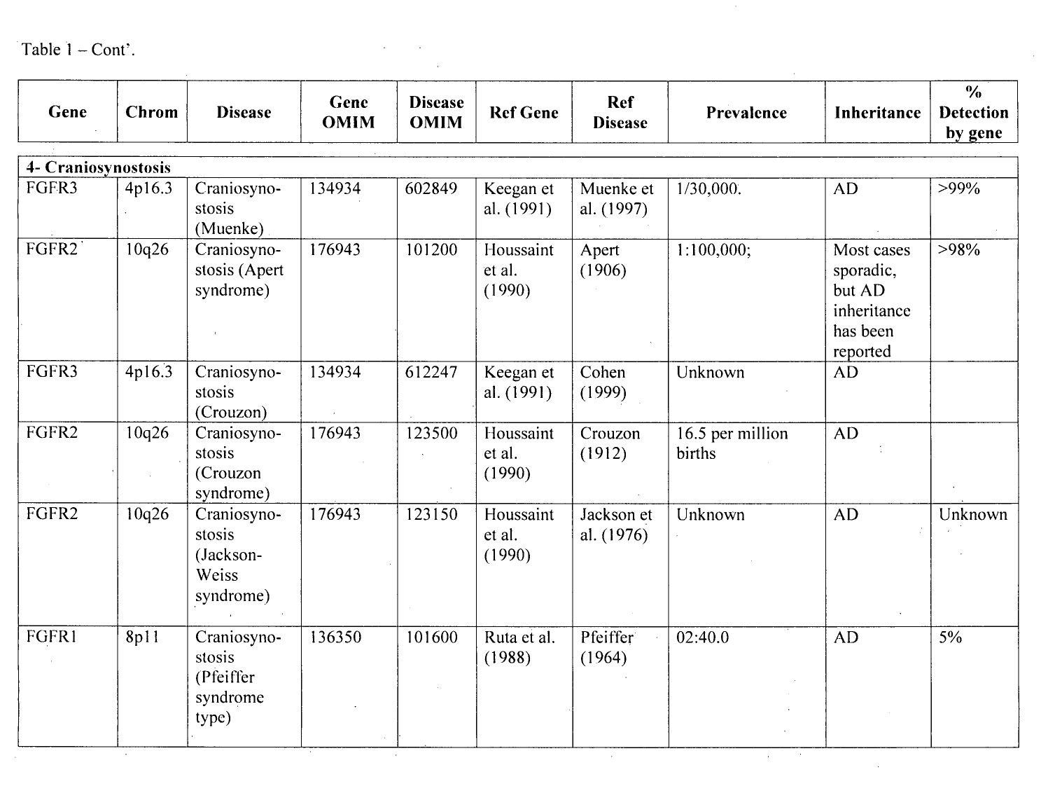

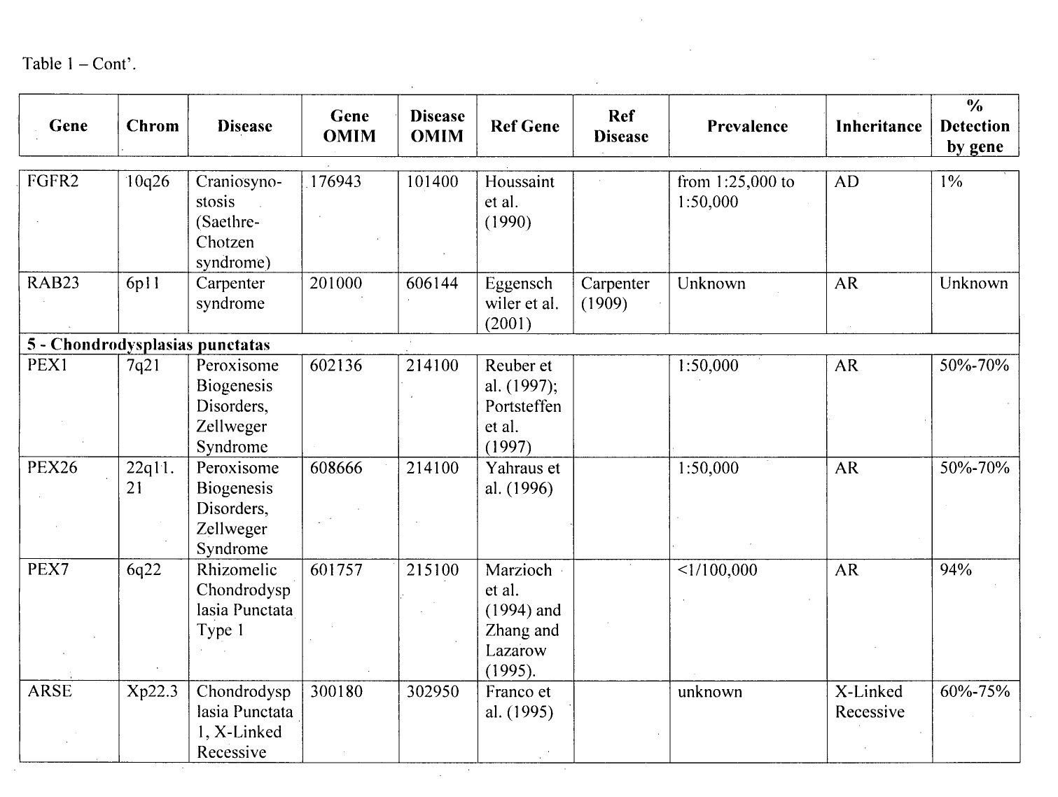

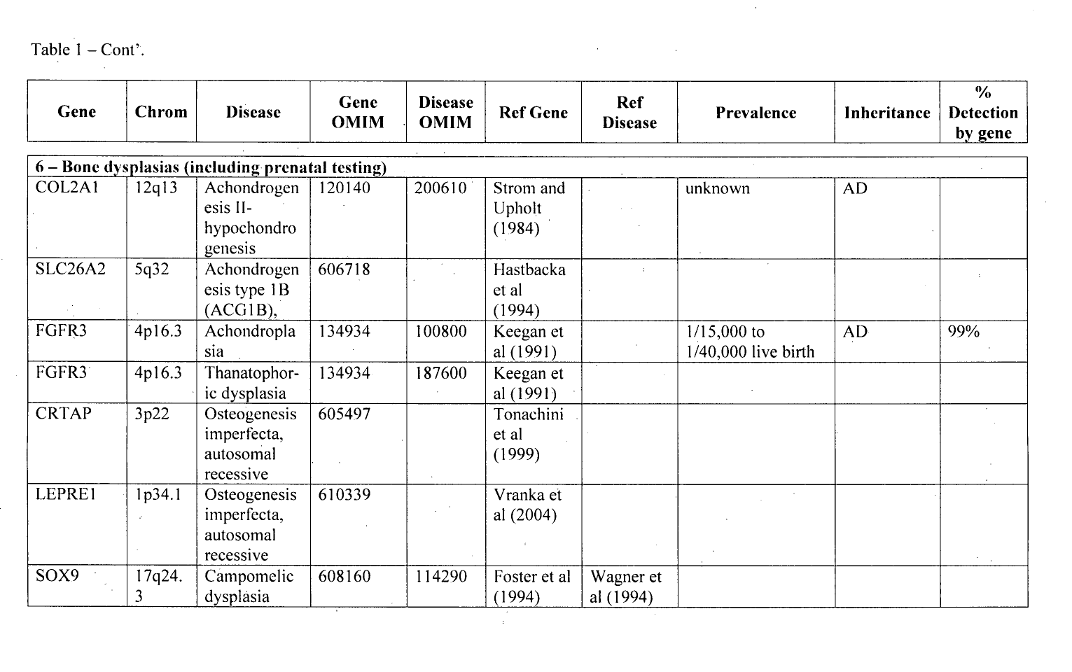

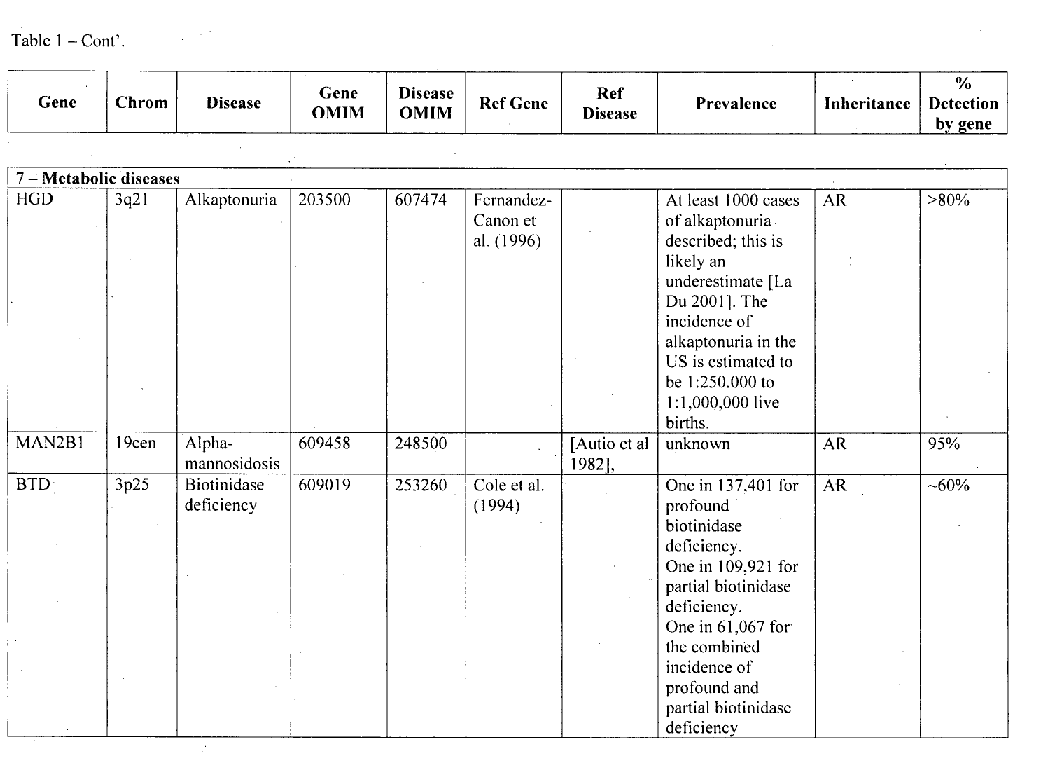

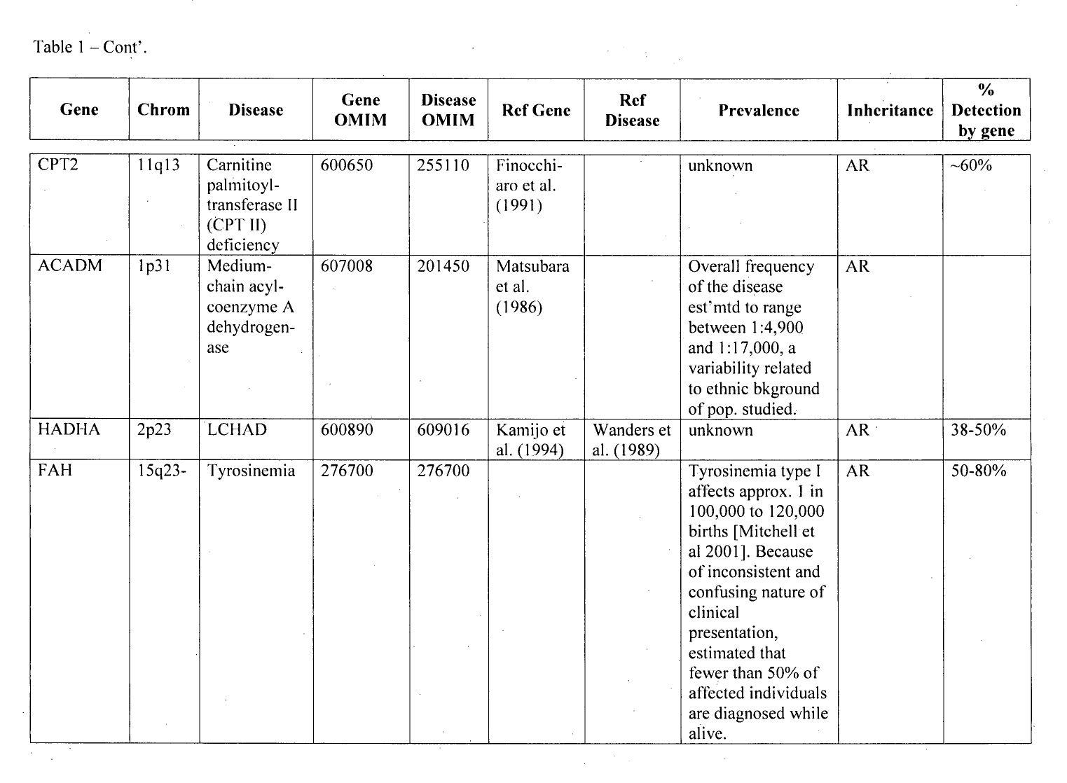

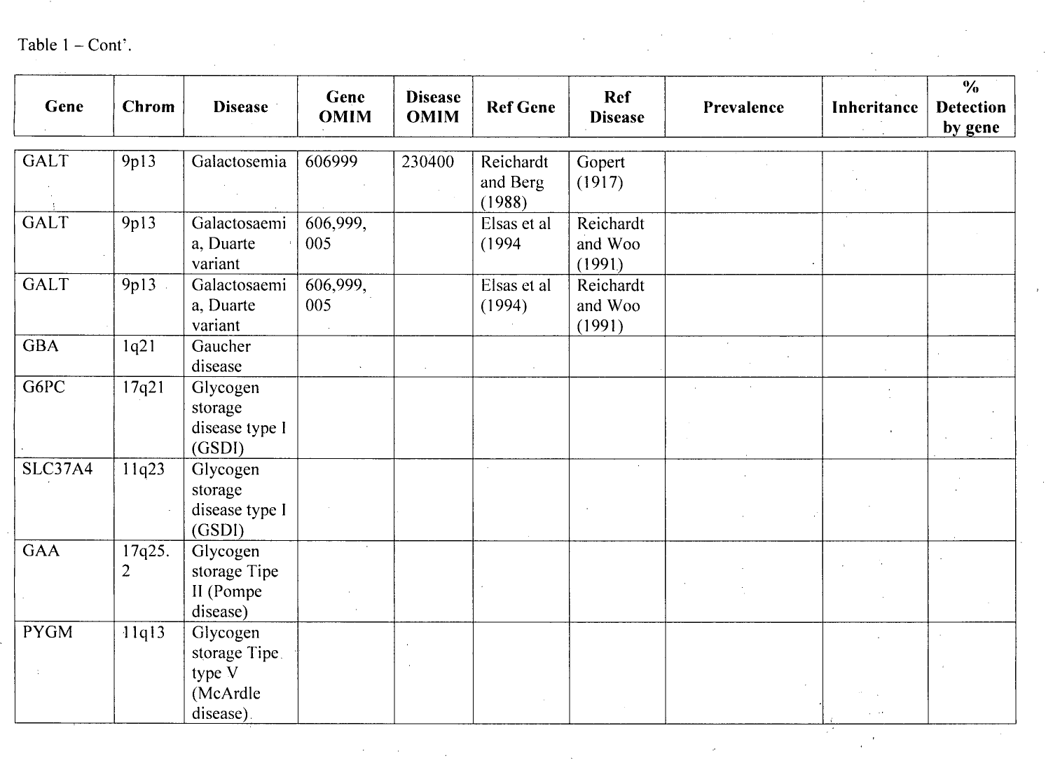

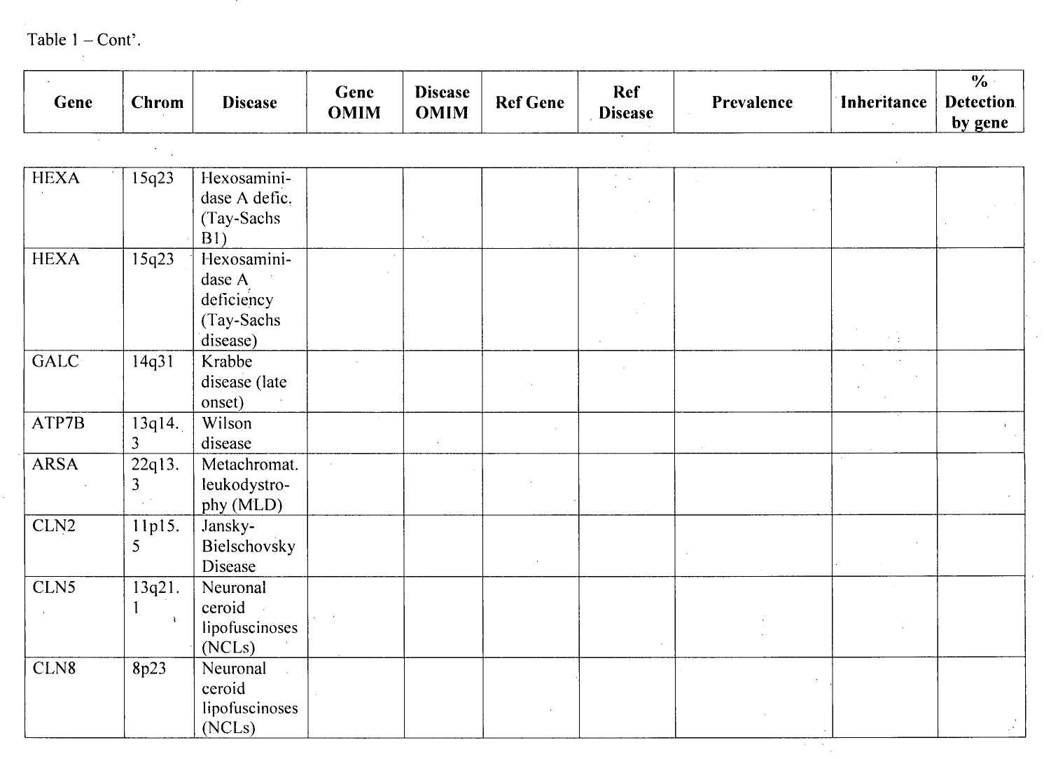

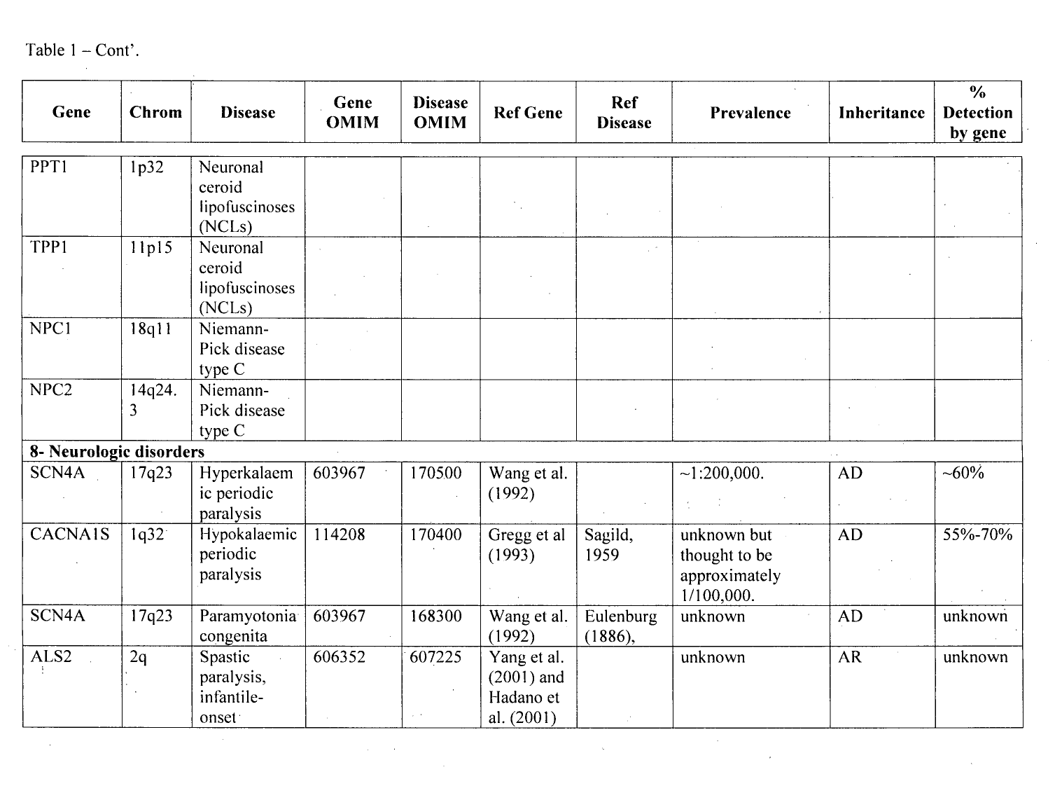

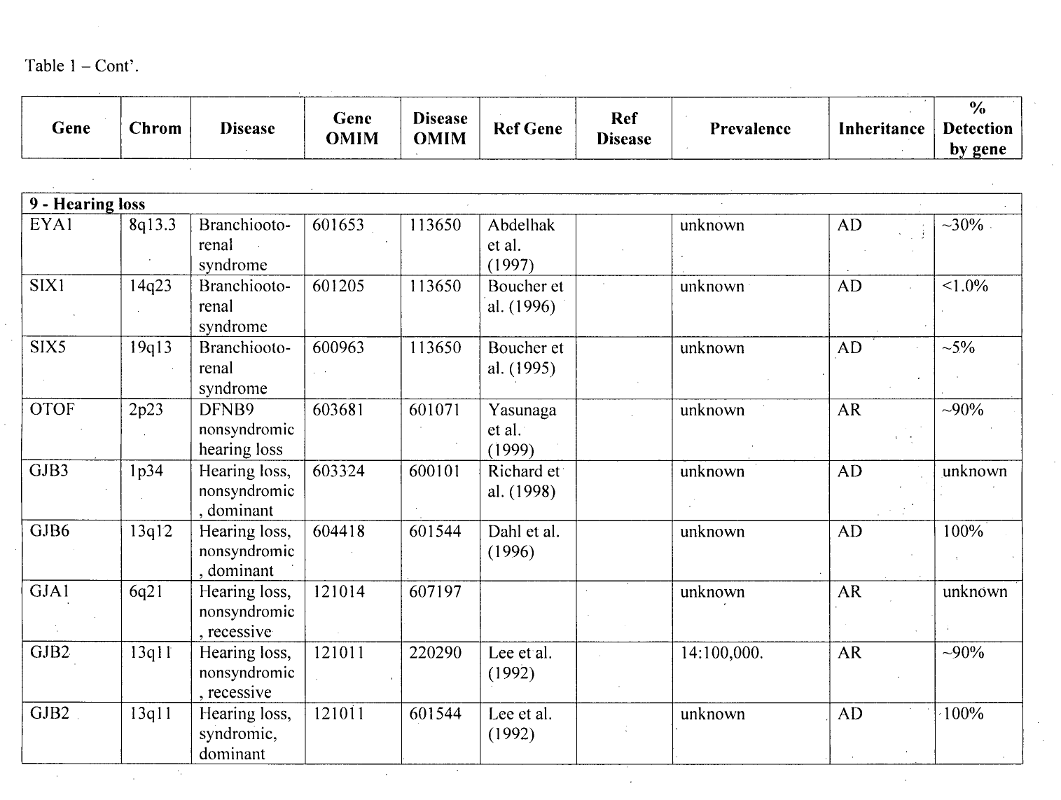

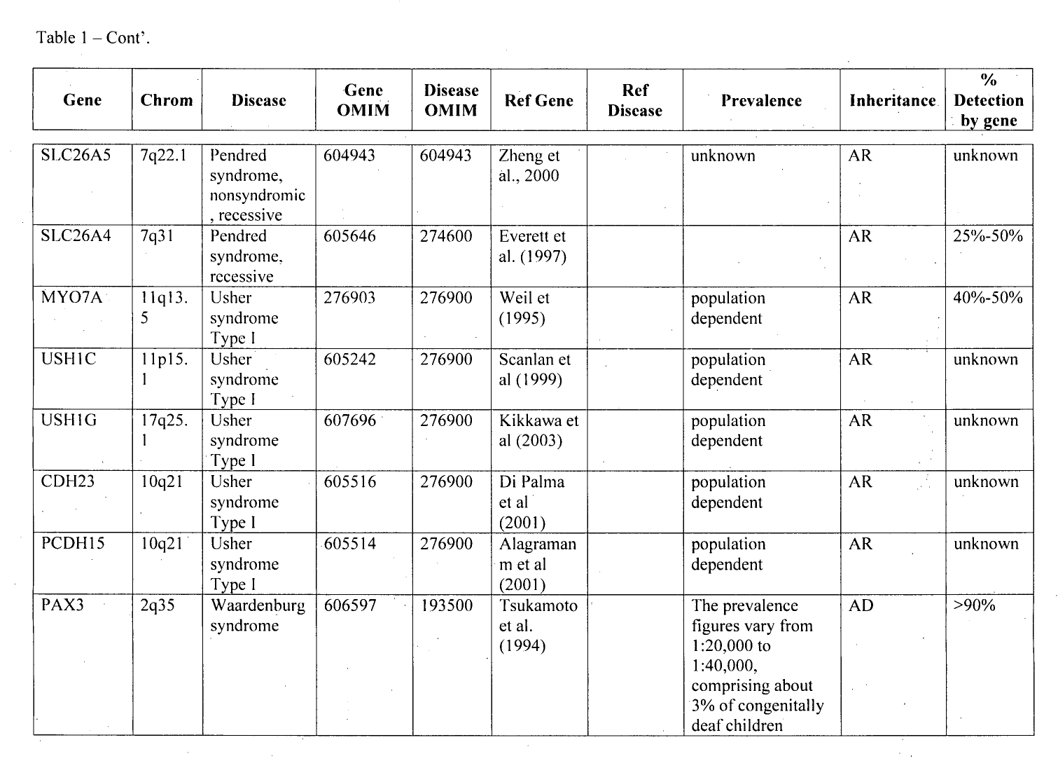

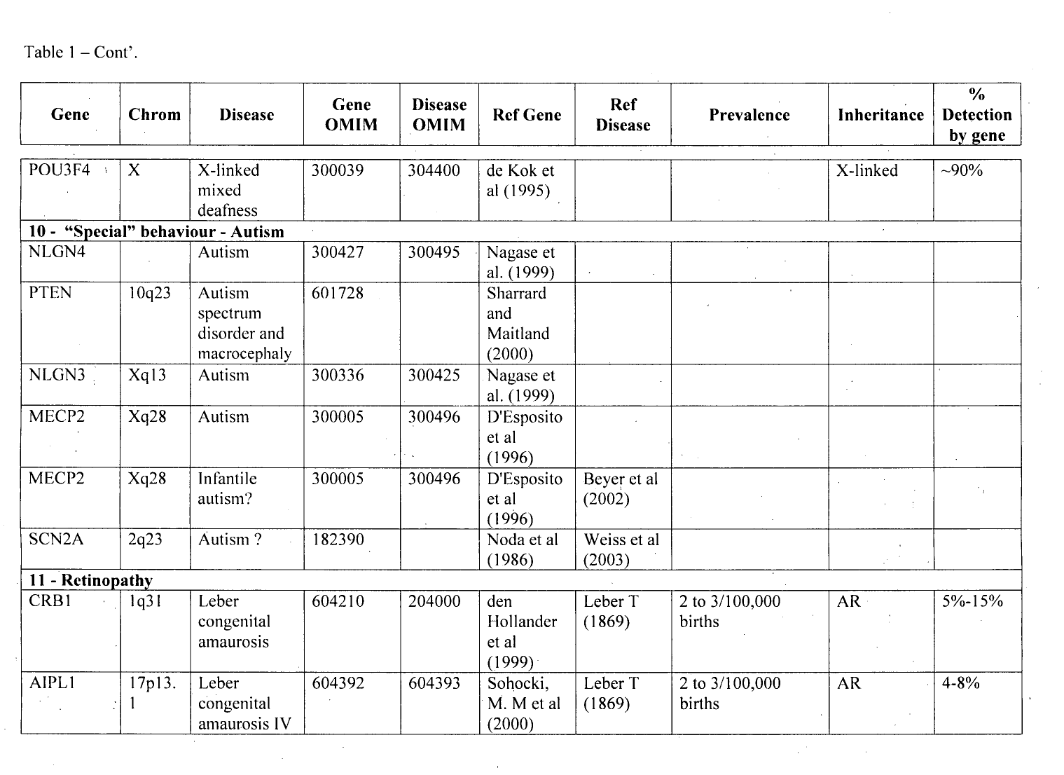

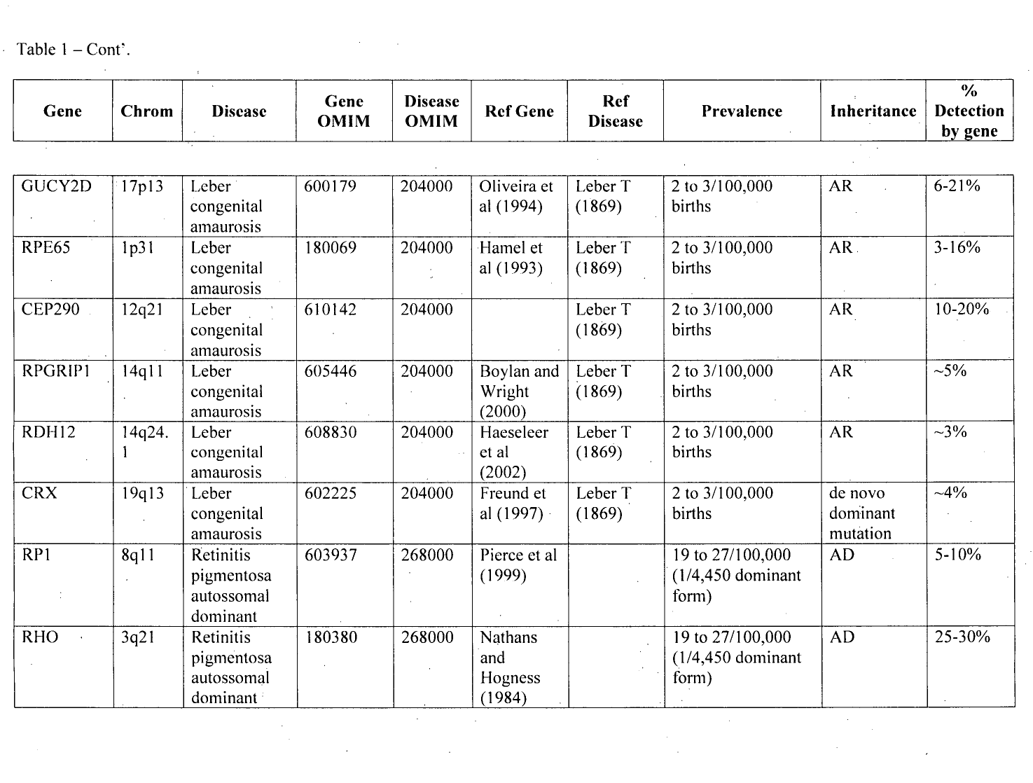

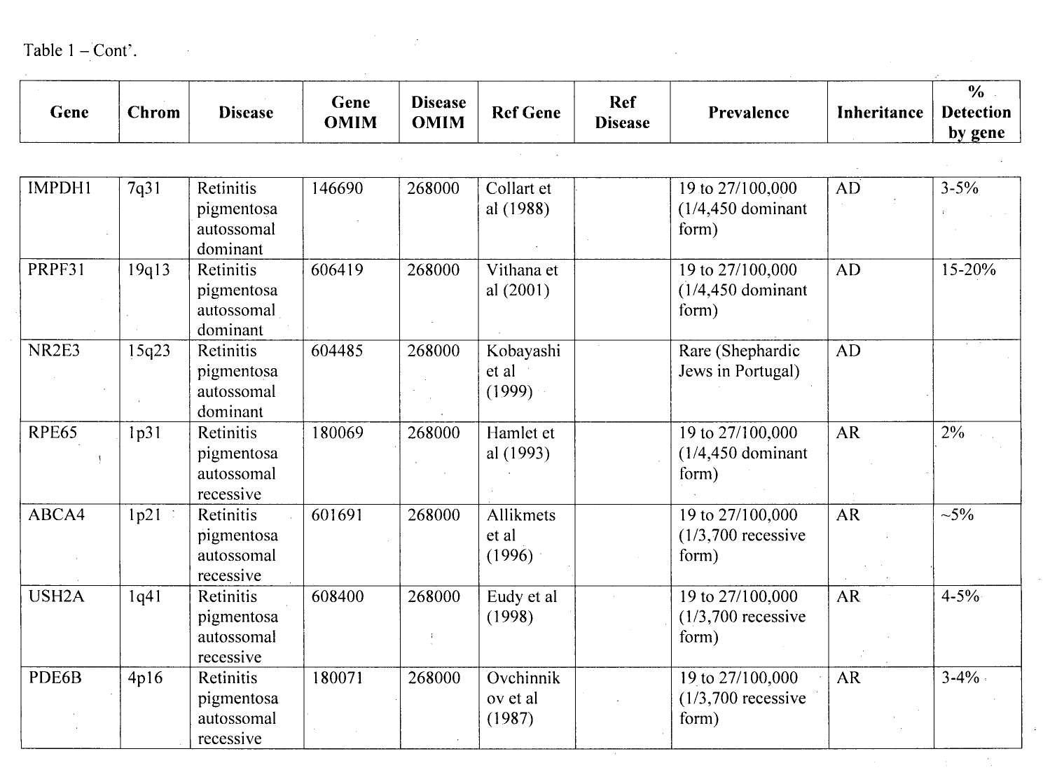

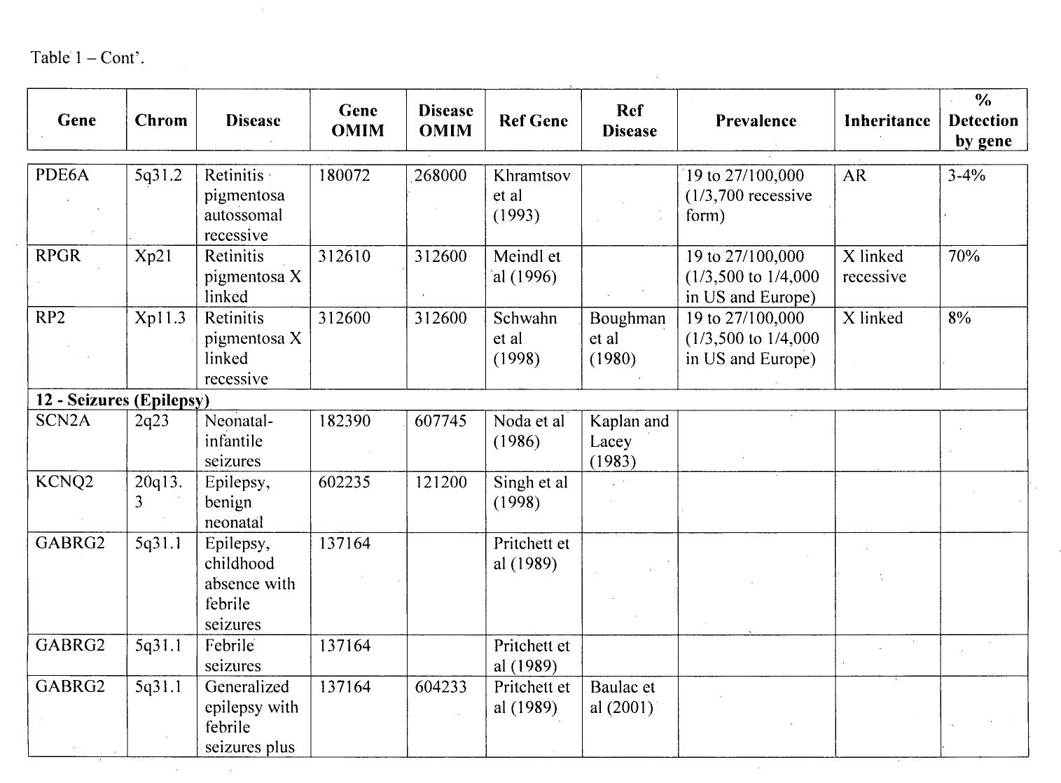

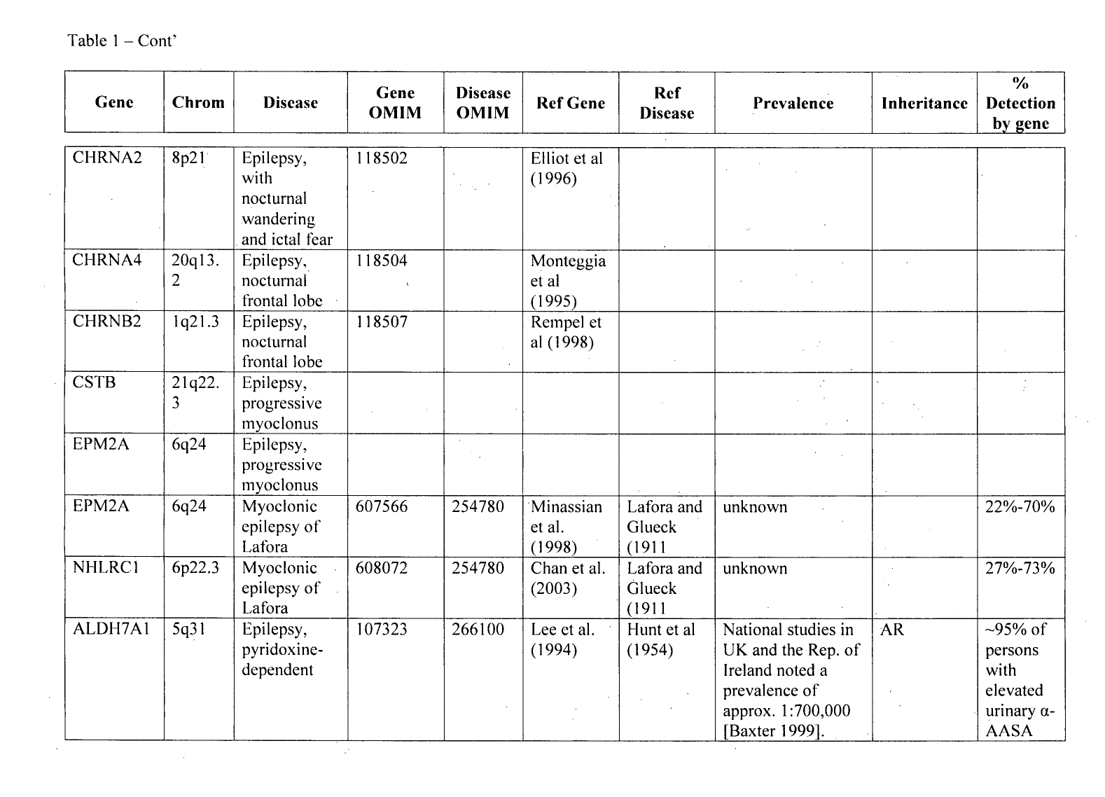

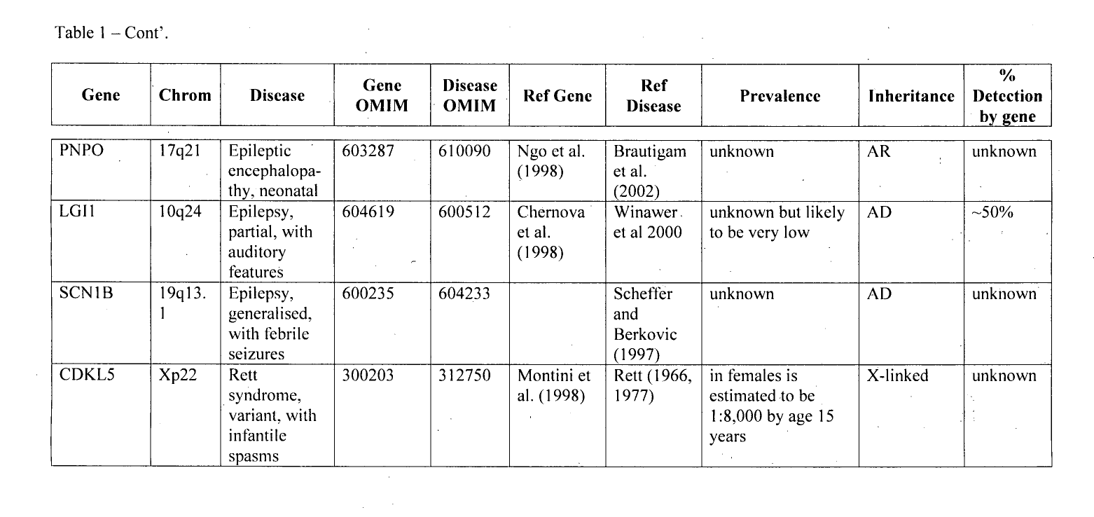

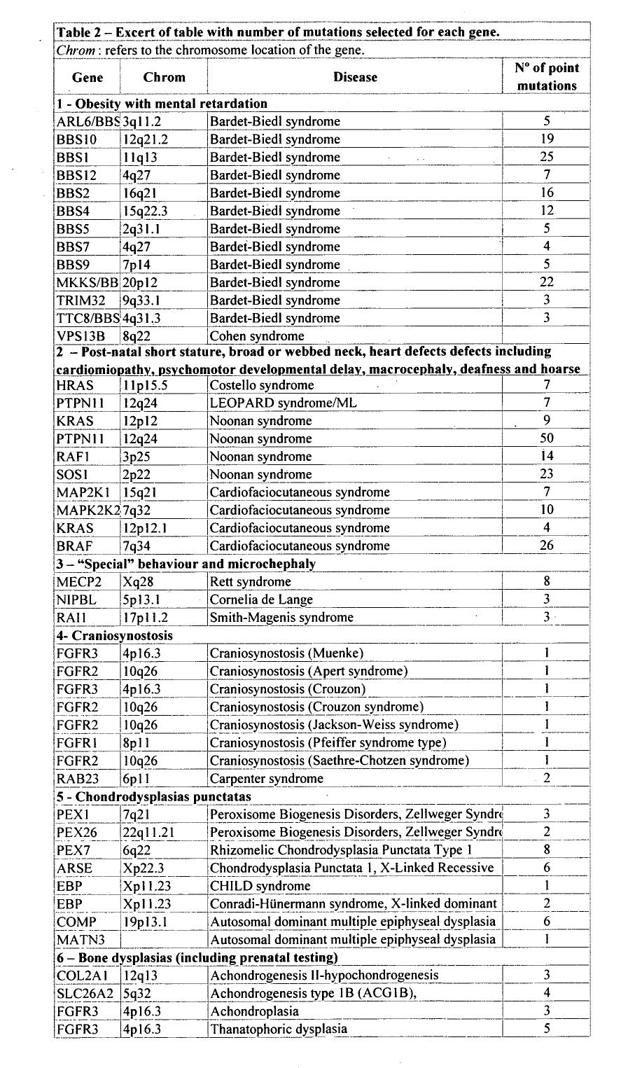

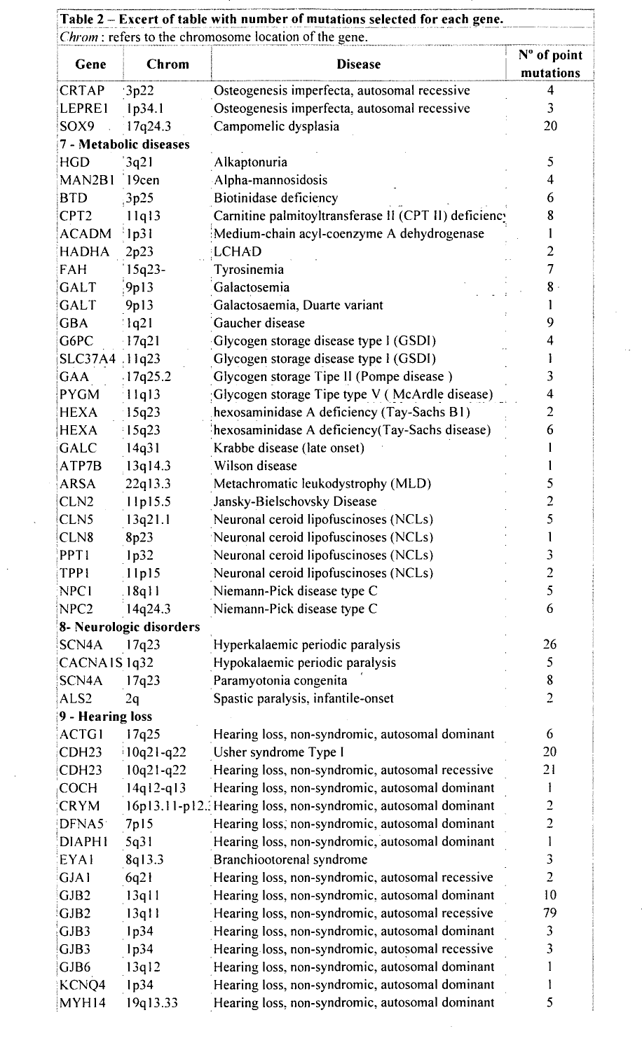

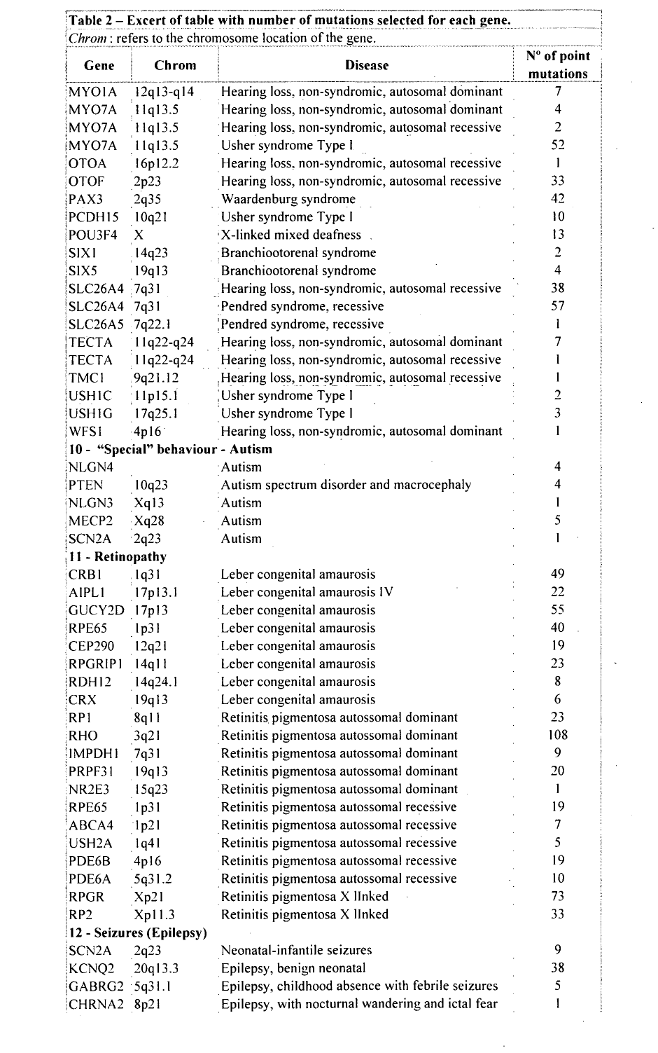

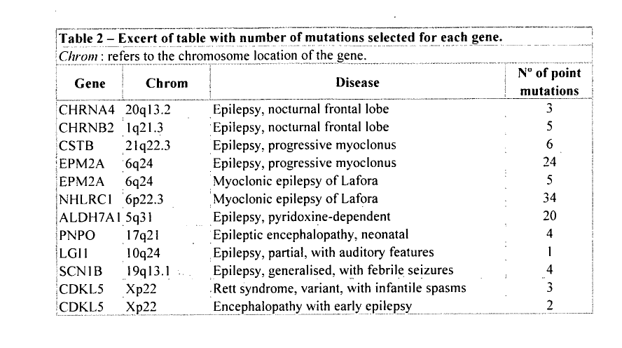

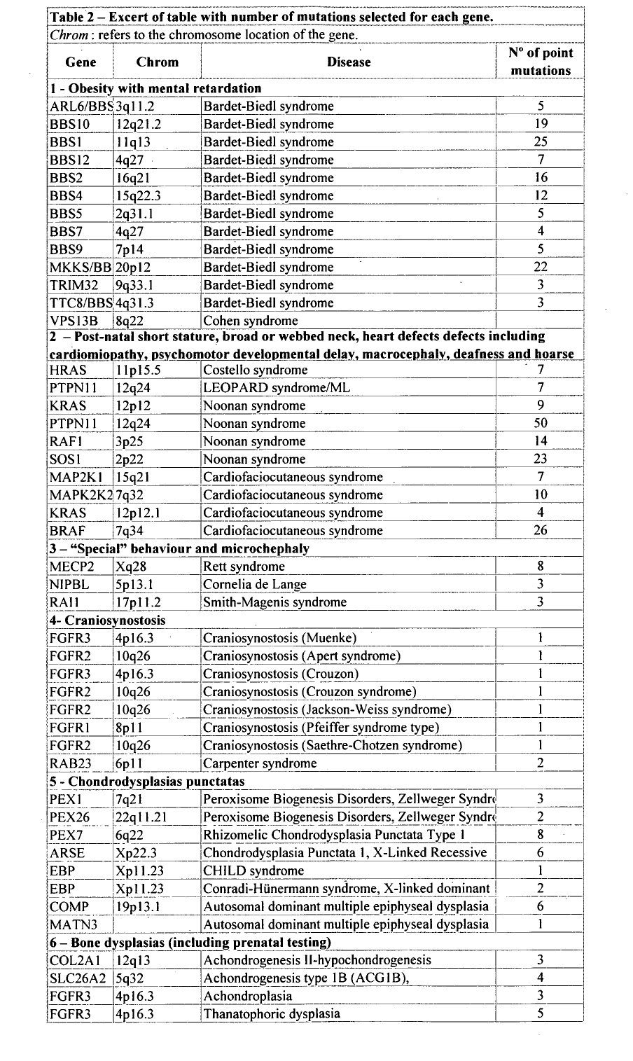

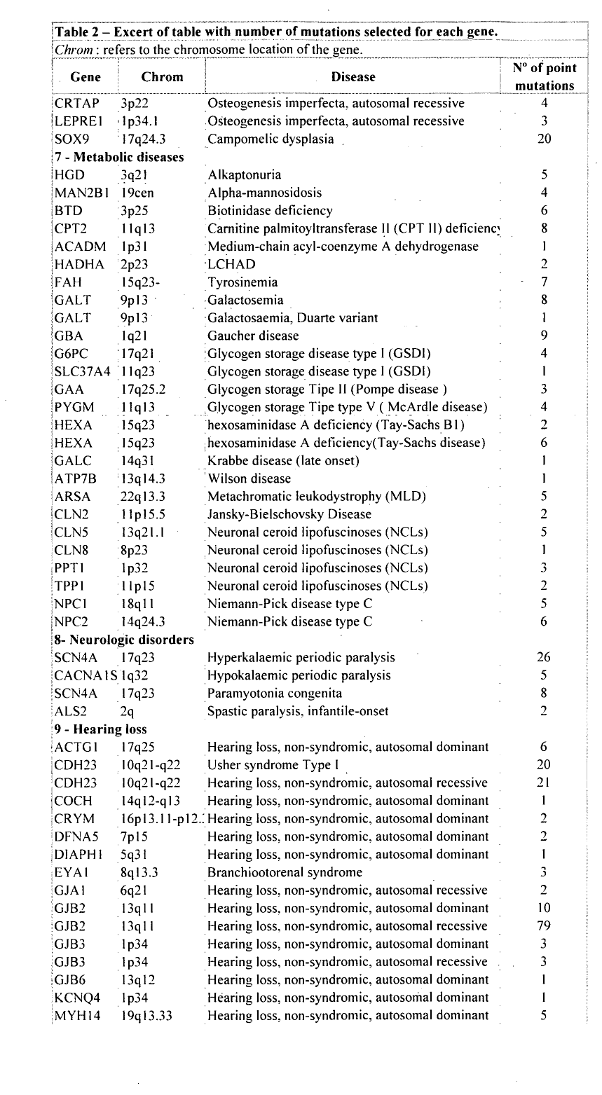

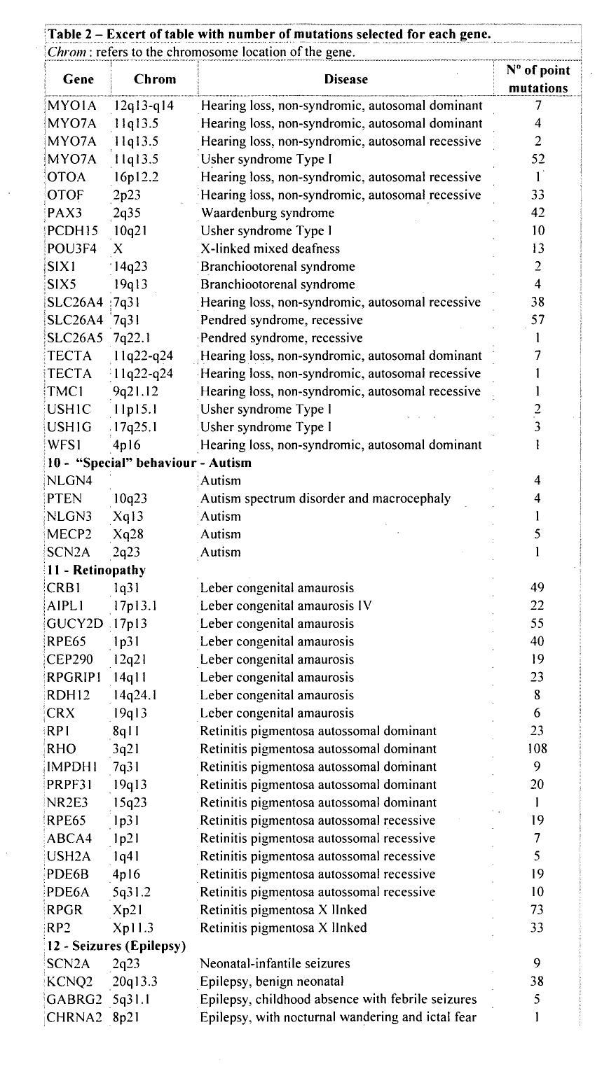

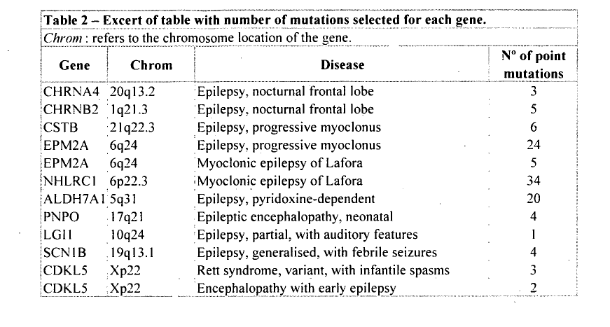

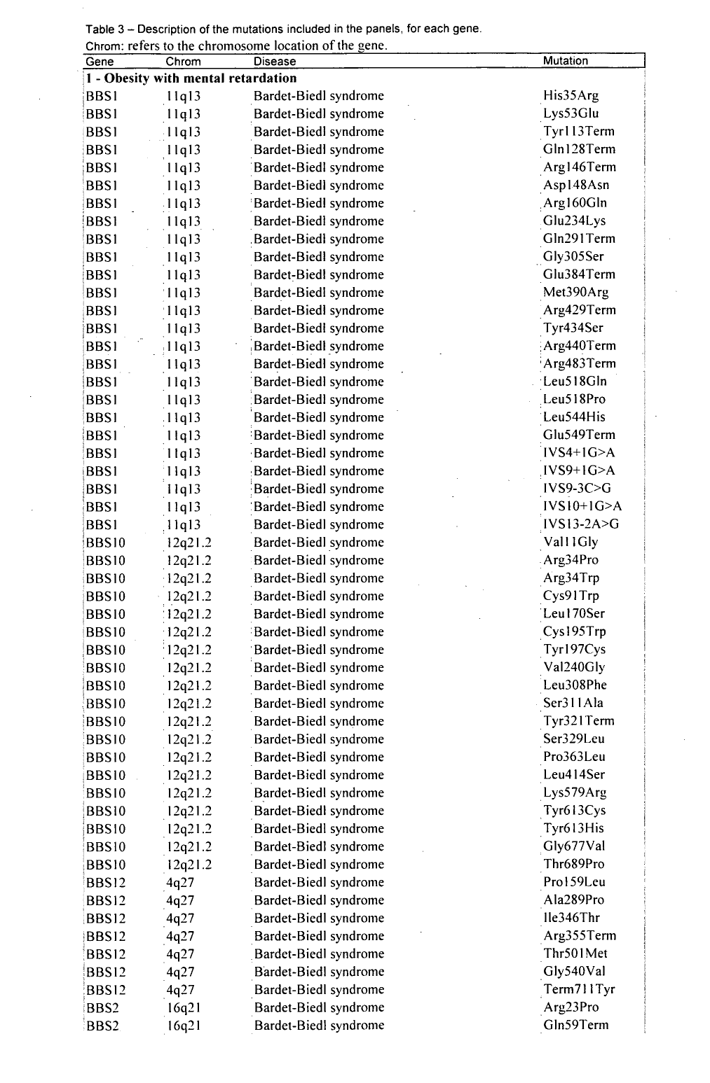

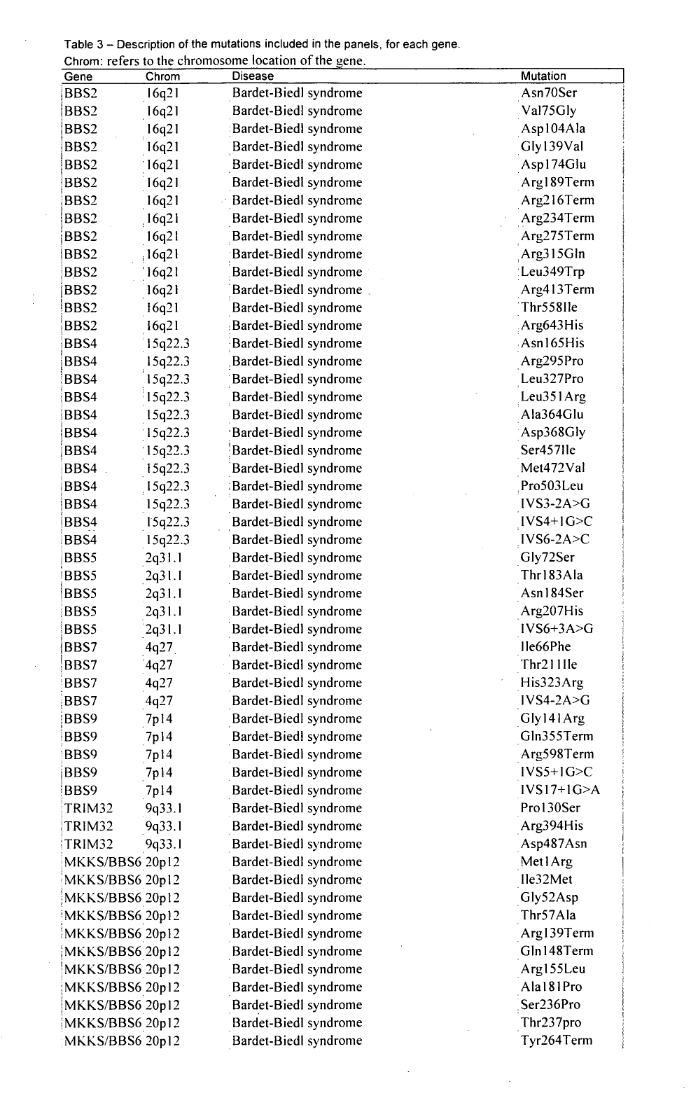

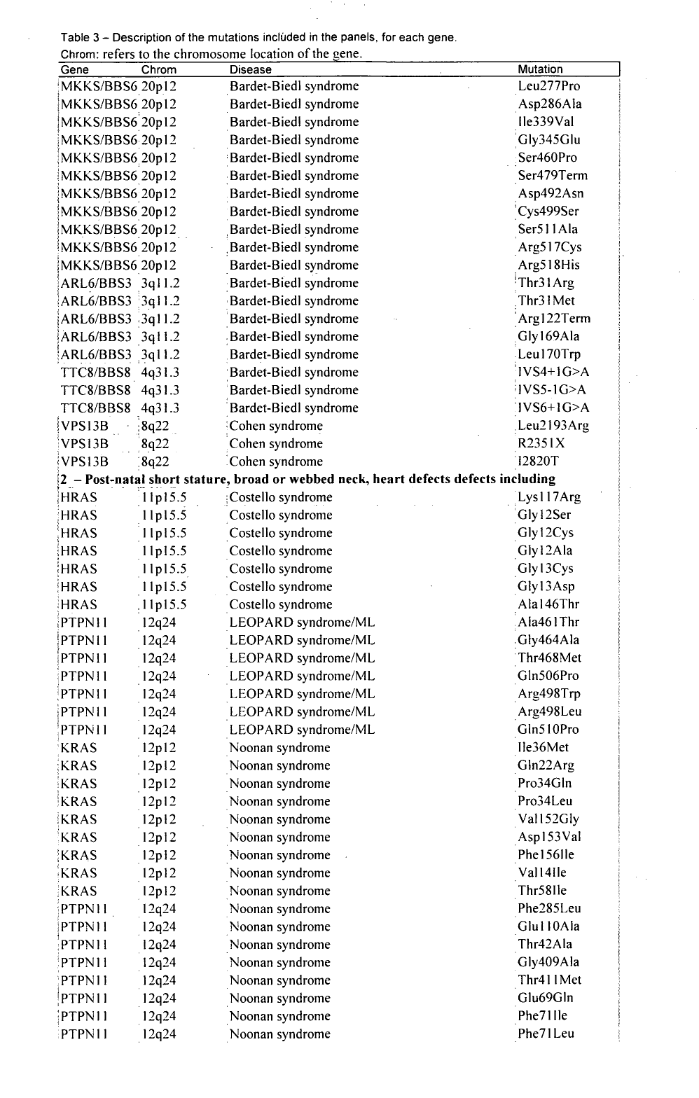

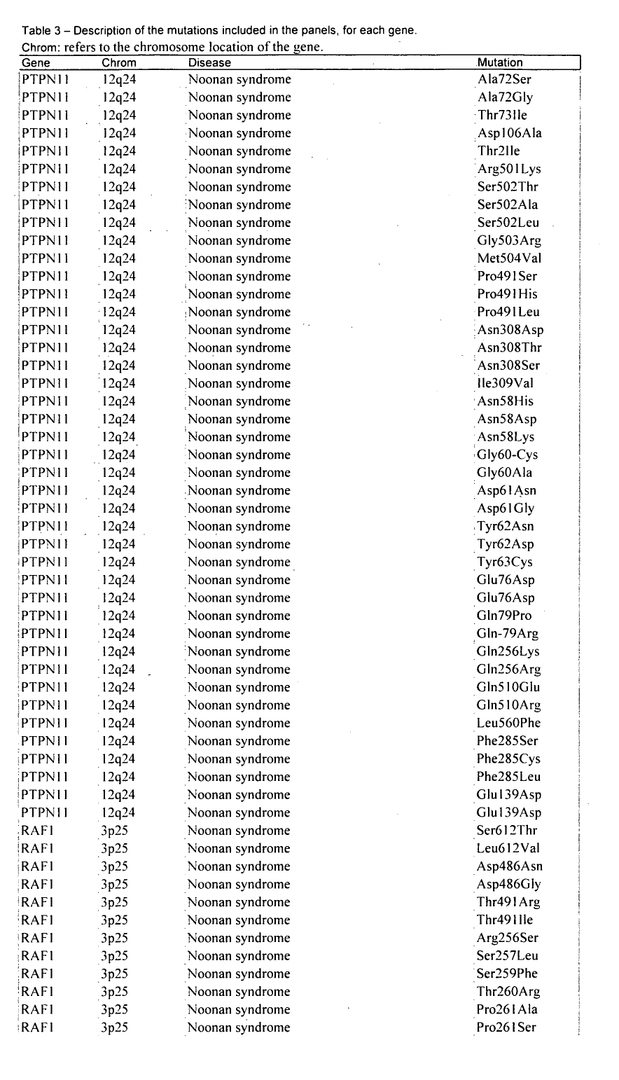

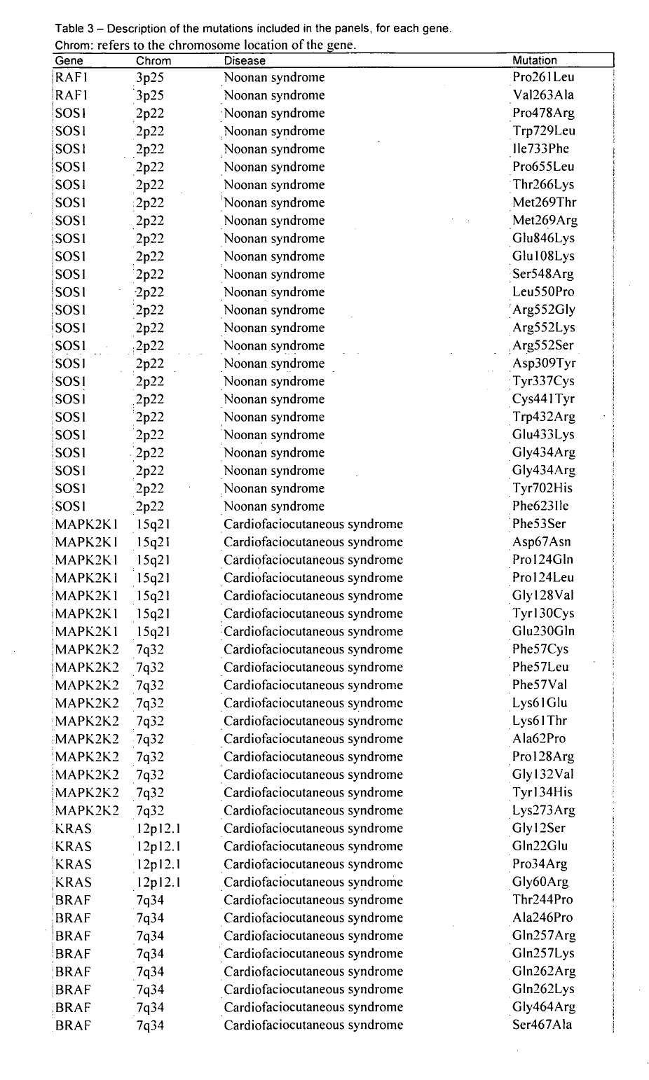

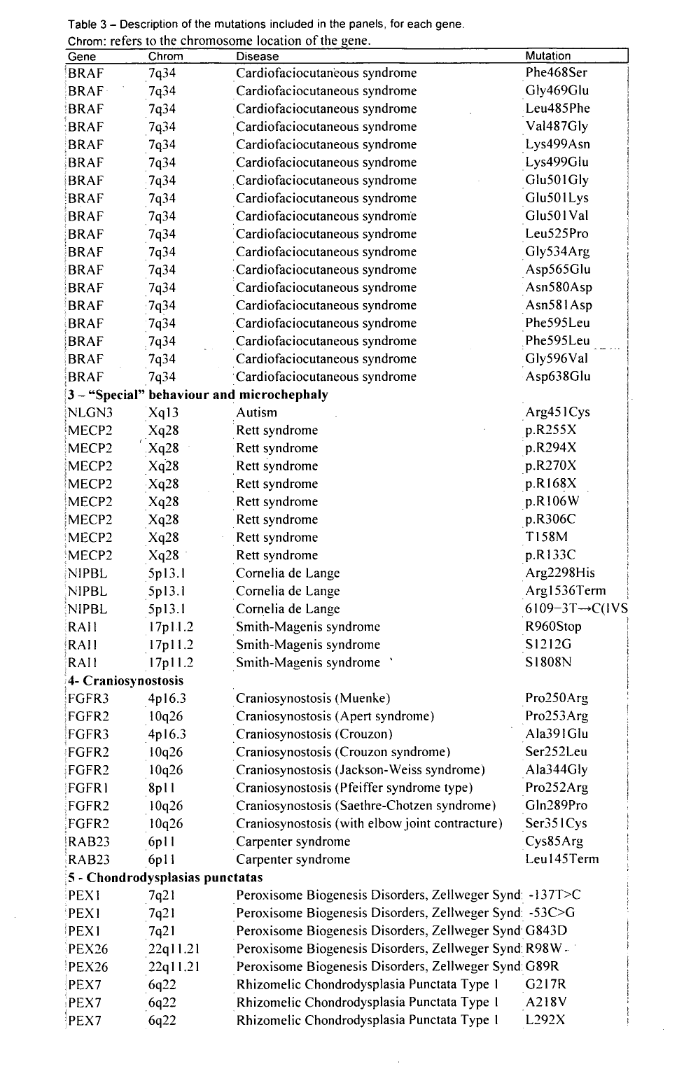

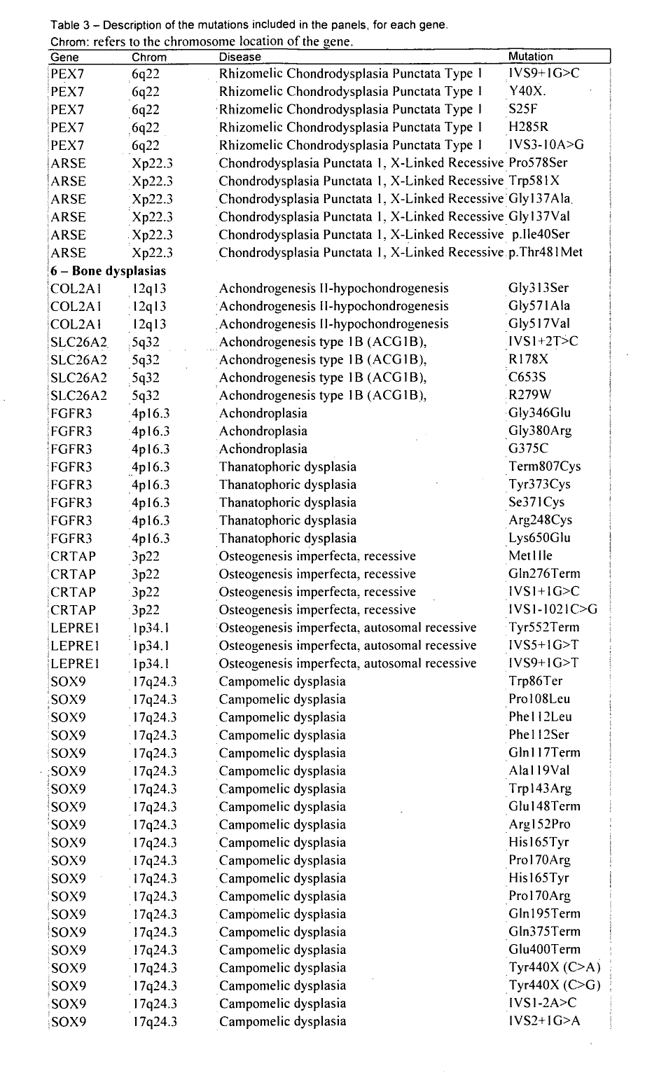

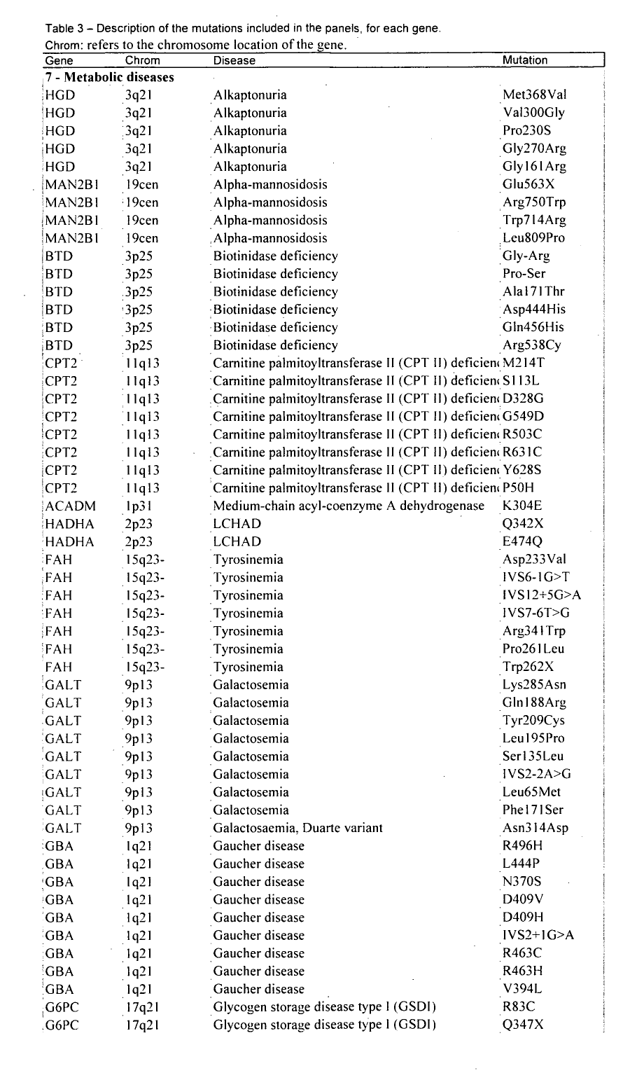

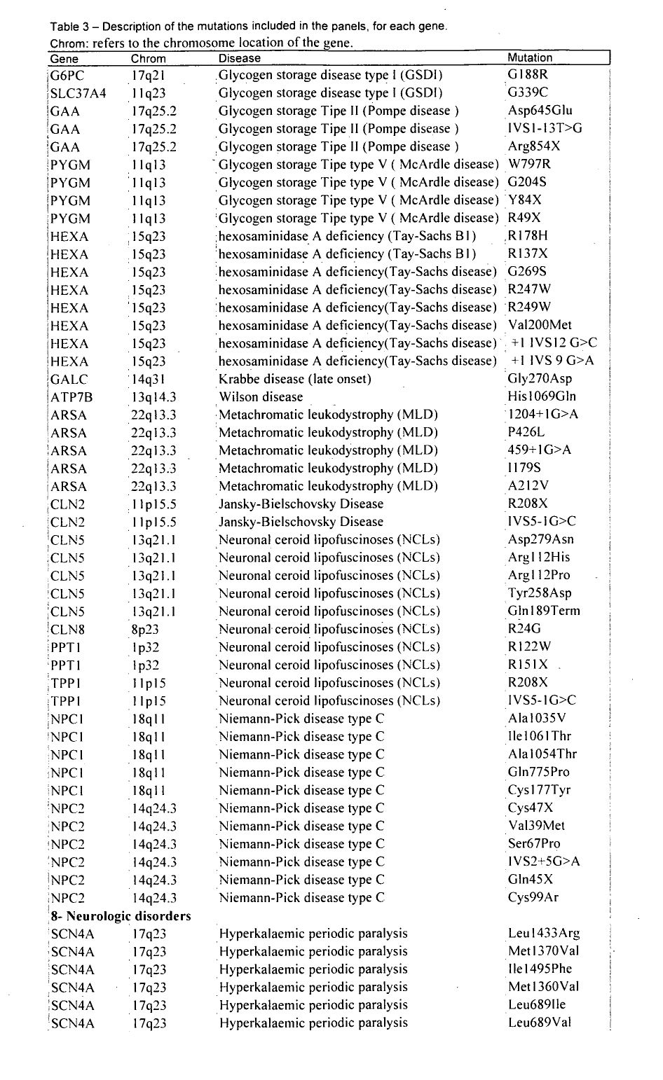

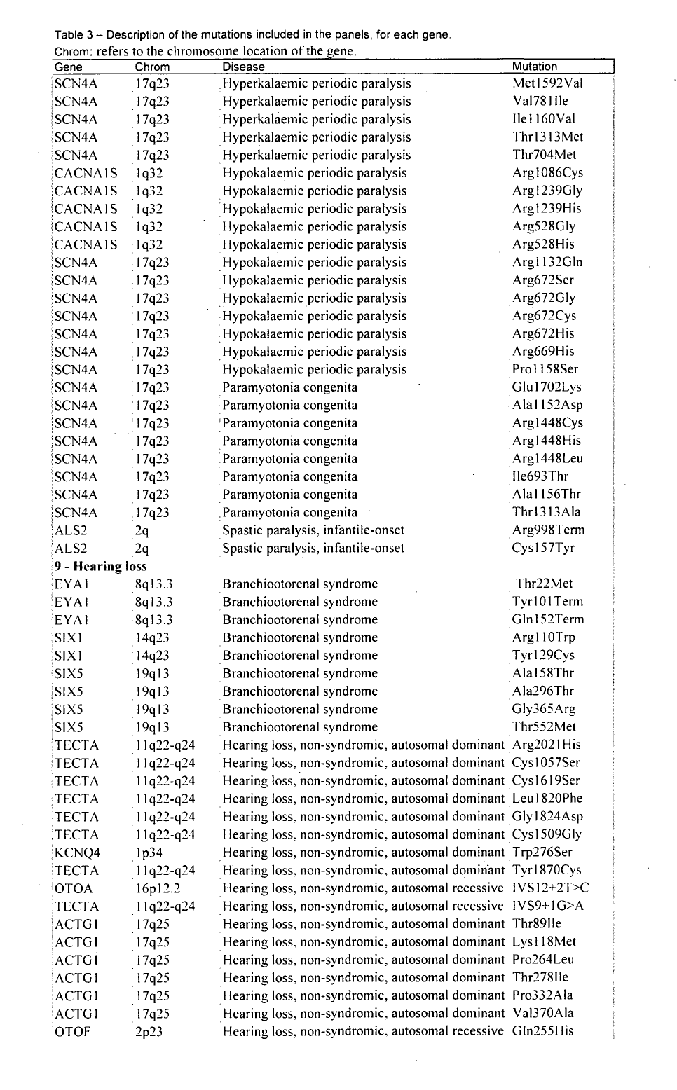

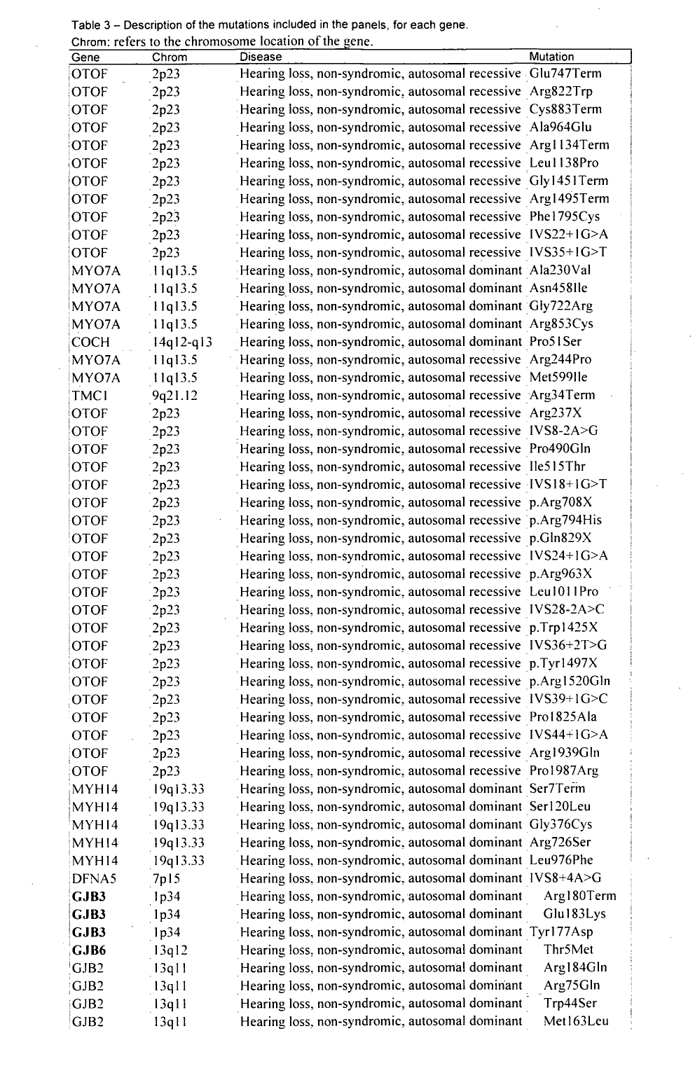

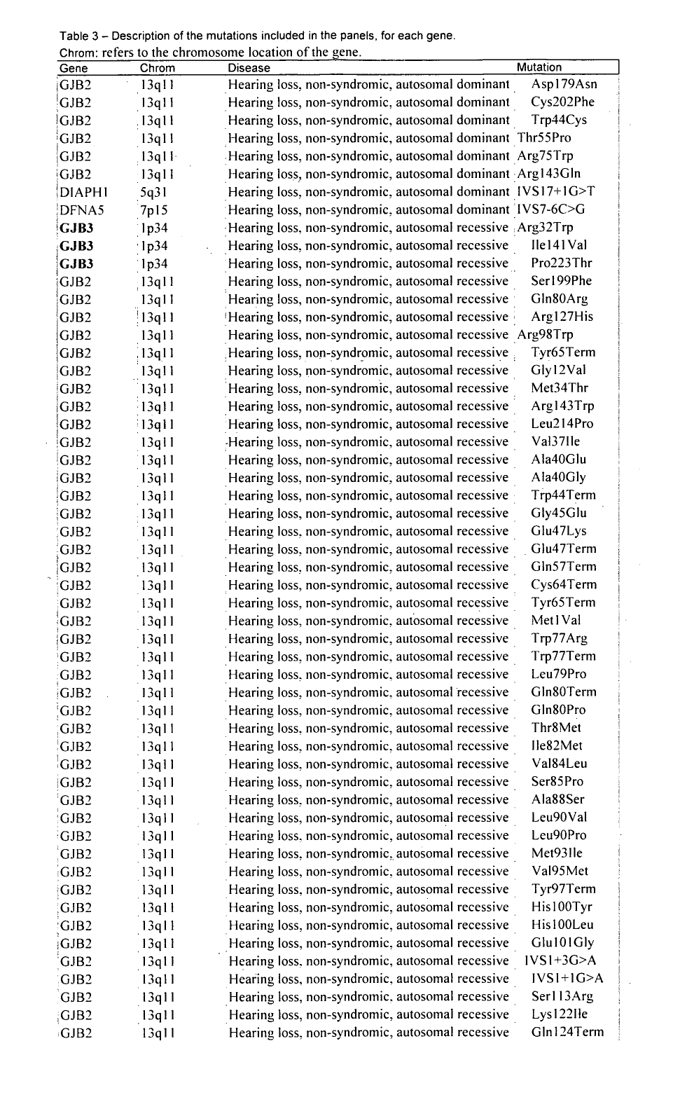

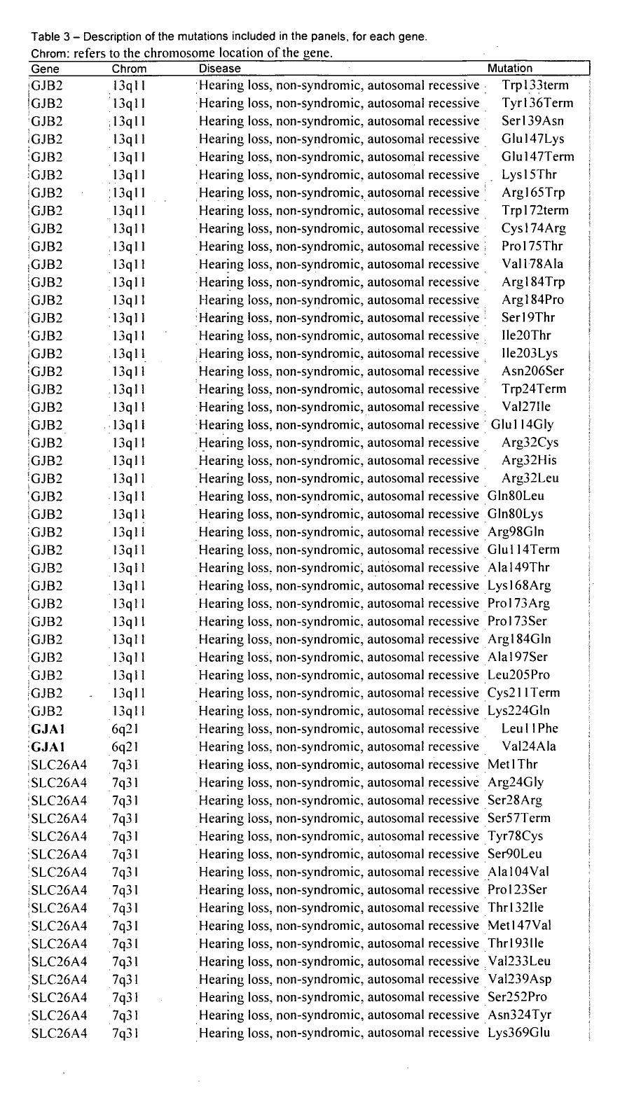

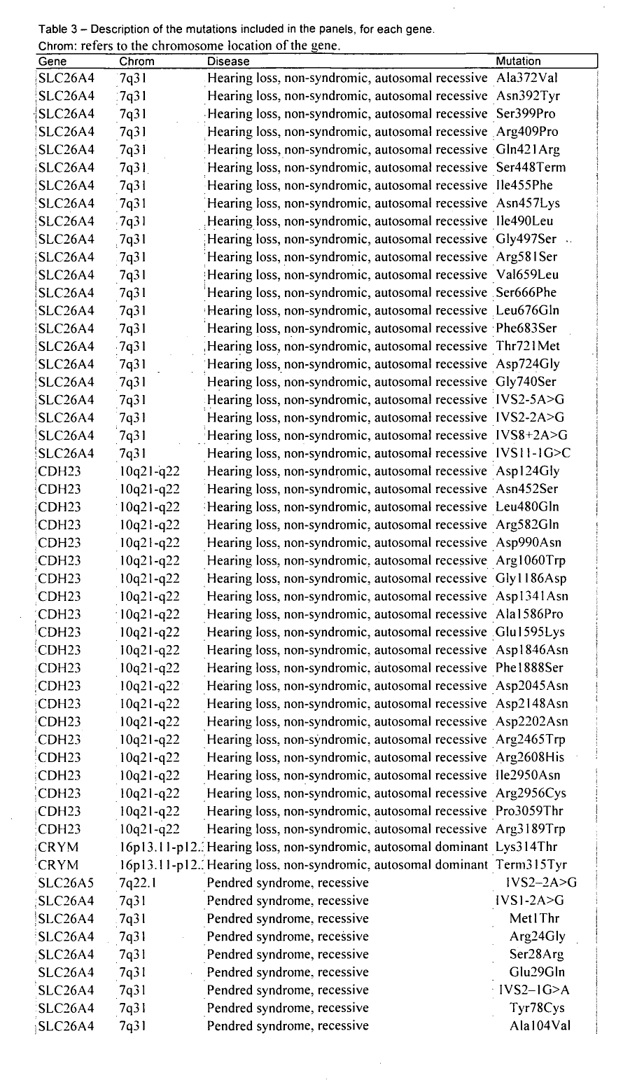

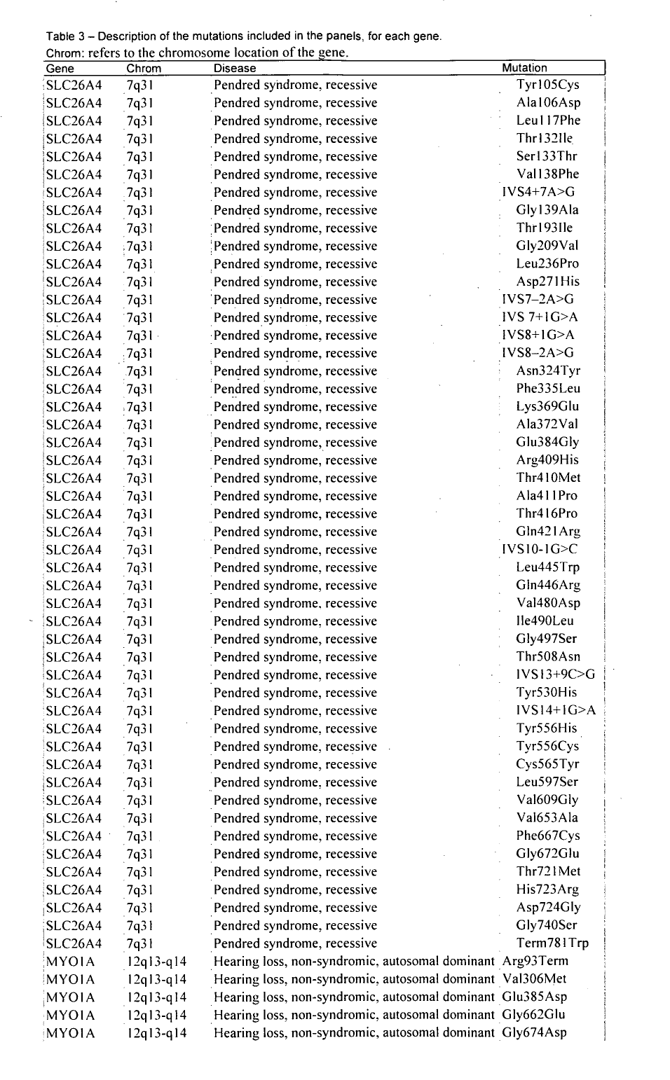

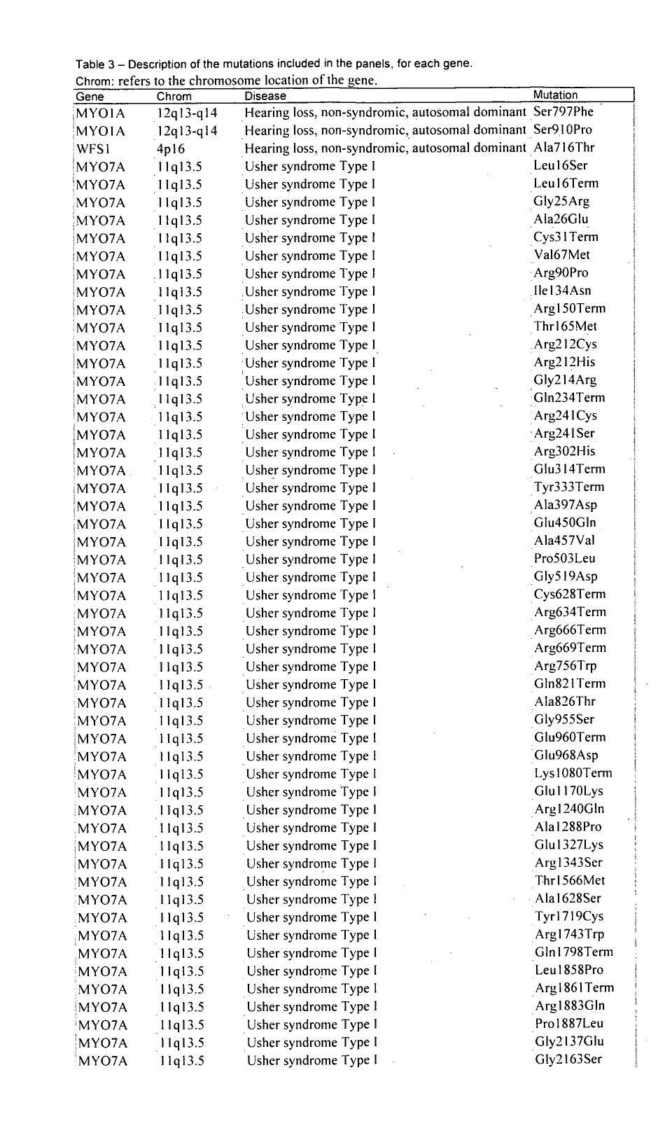

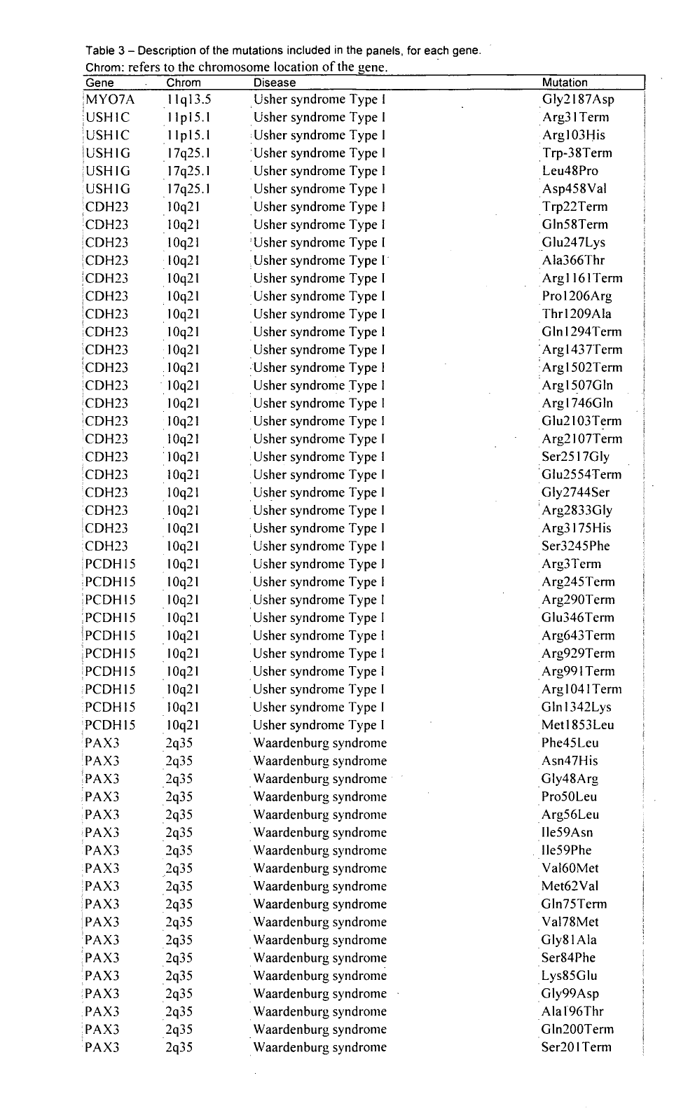

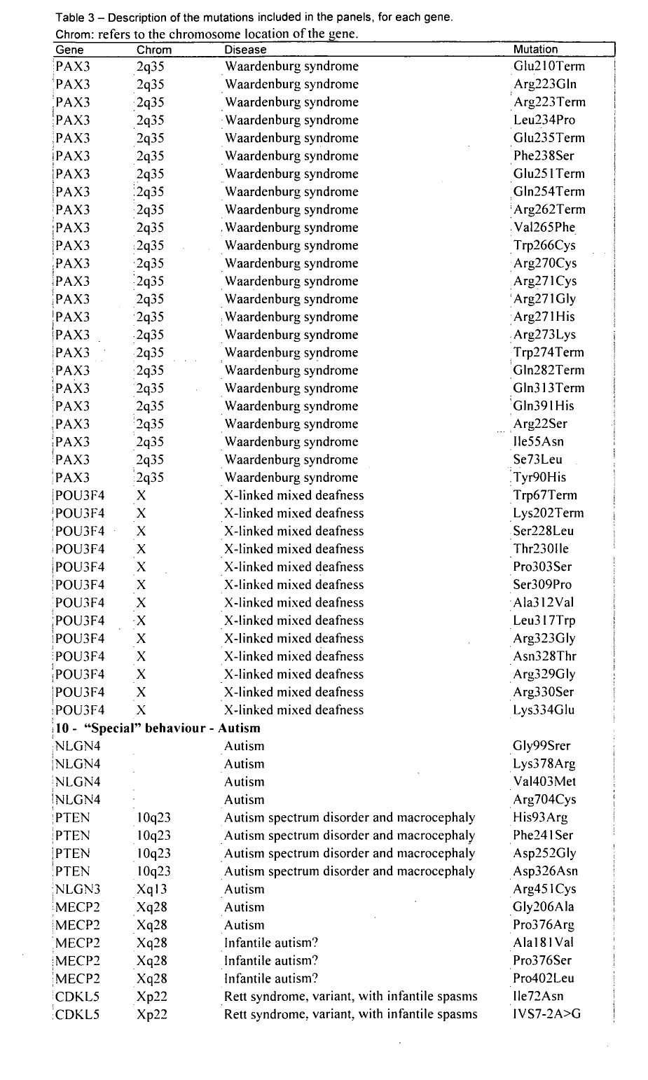

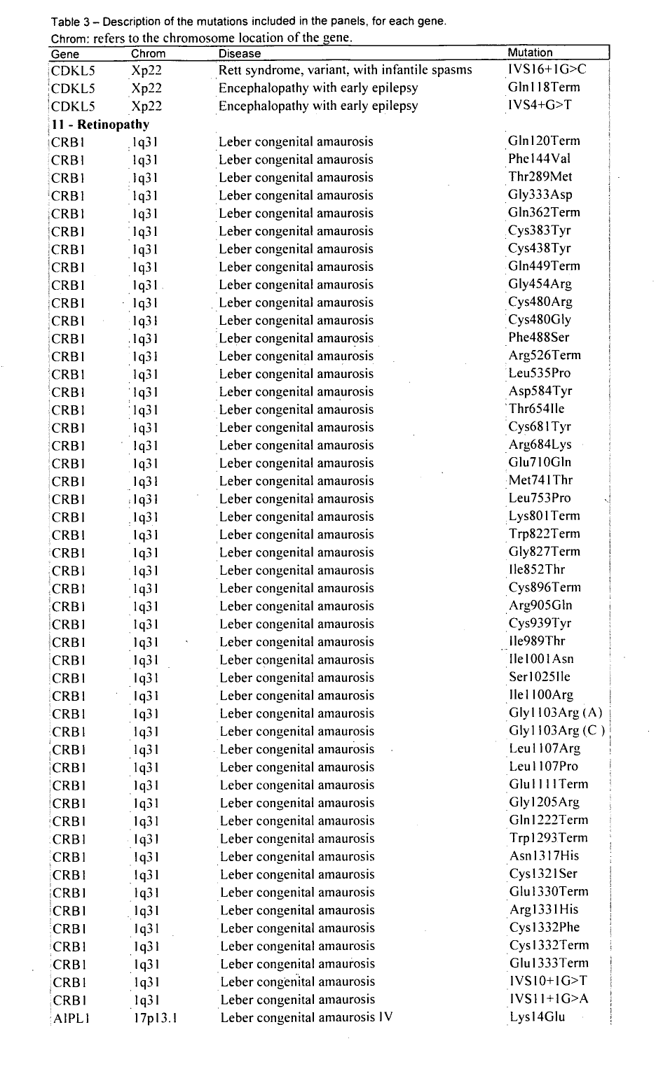

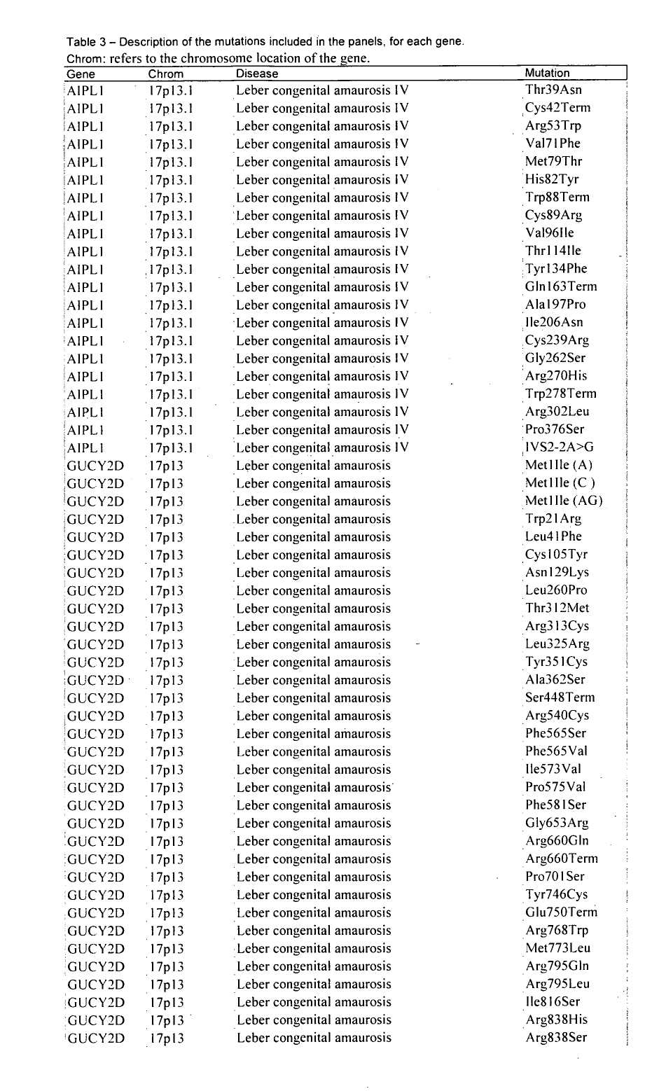

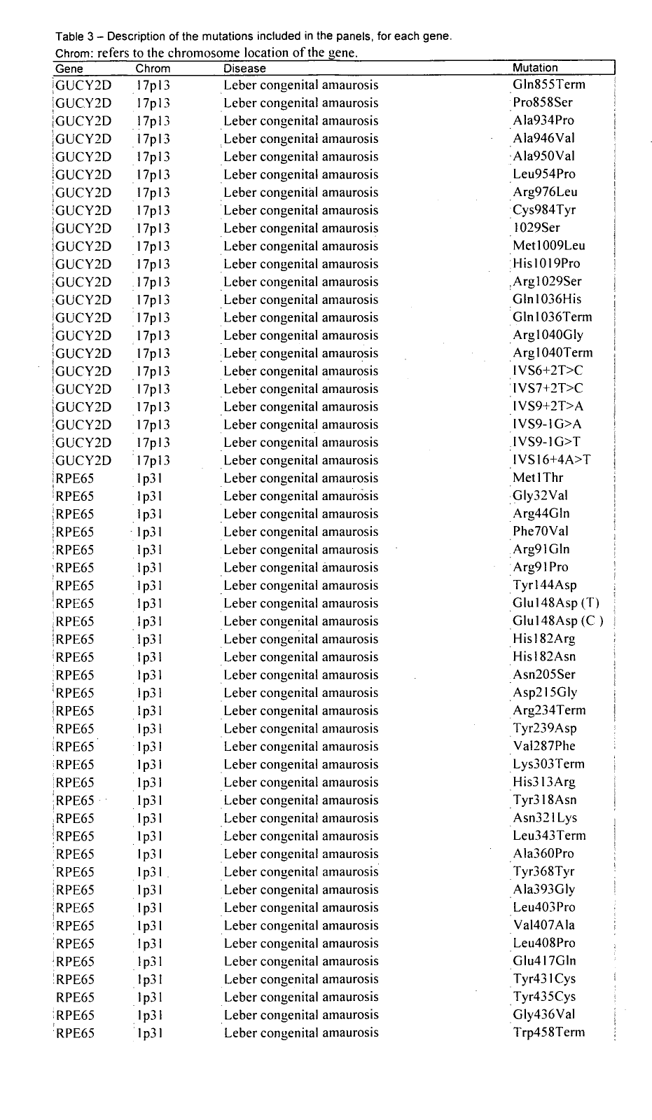

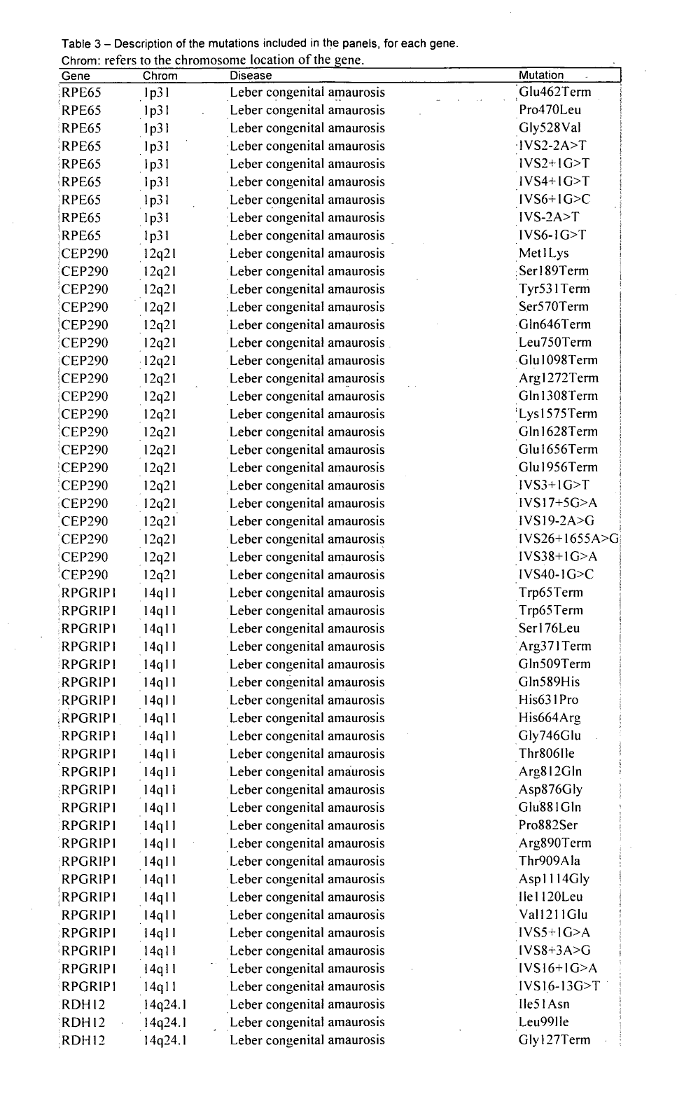

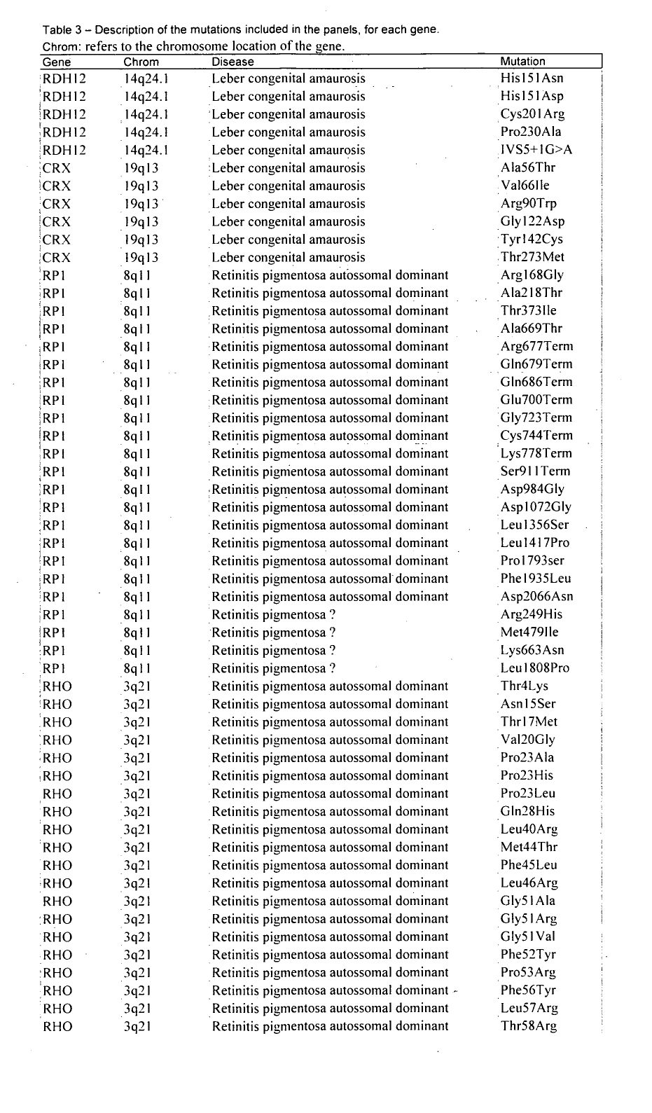

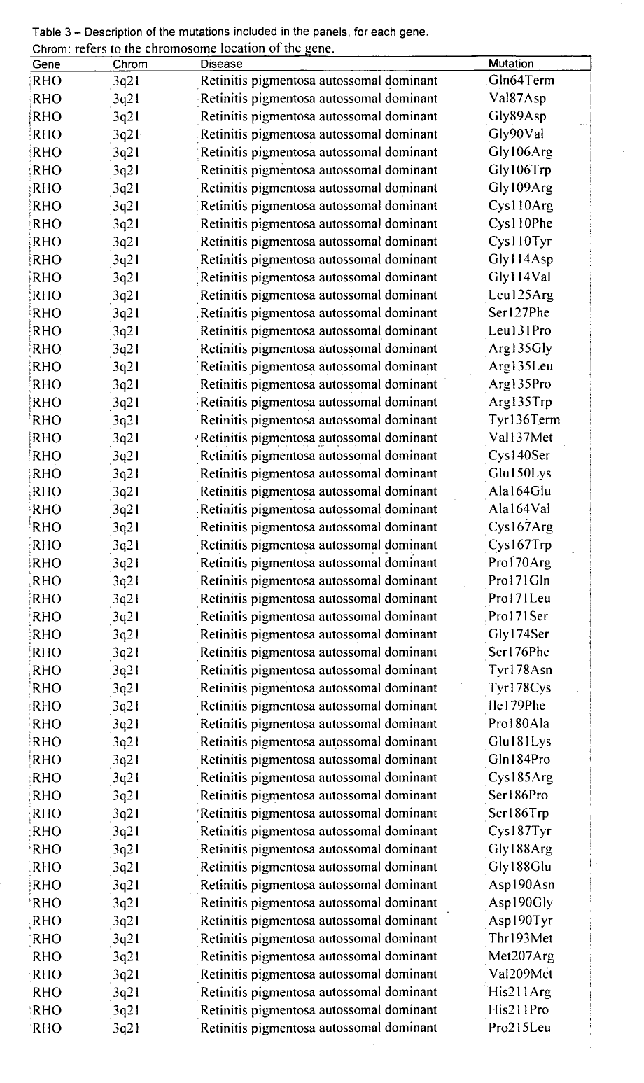

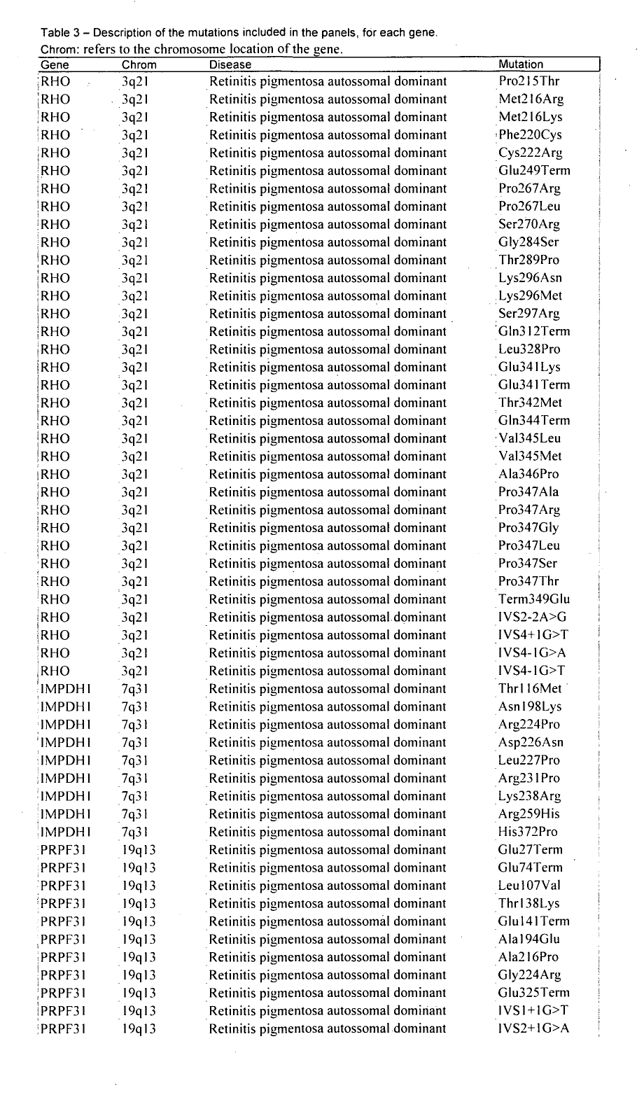

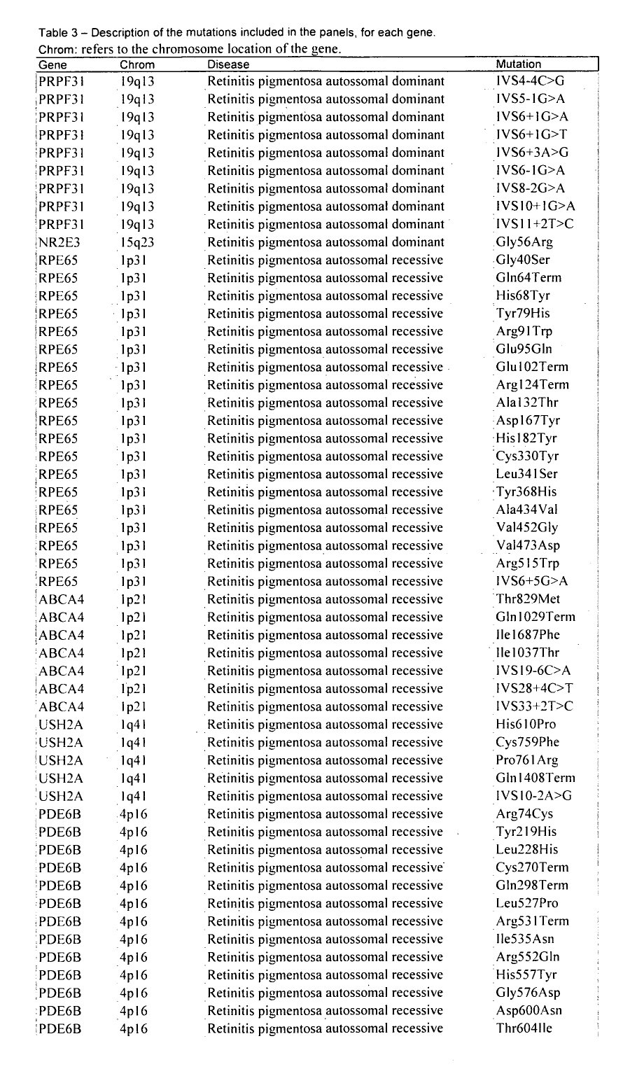

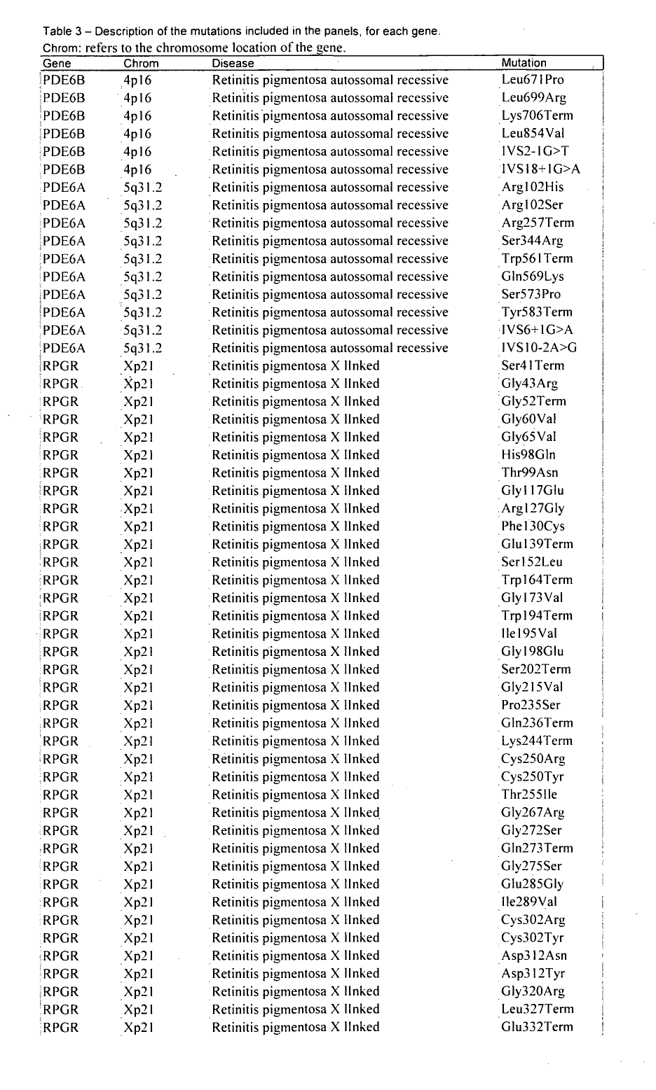

Referring to FIG. 1 there is shown a stylized overview of interconnected computer system networks. Each computer system network 102 contains a corresponding local computer processor unit 104, which is coupled to a corresponding local data storage unit 106, and local network users 108. The local computer processor units 104 are selectively coupled to a plurality of users 110 through the Internet 114. A user 110 locates and selects (such as by clicking with a mouse) a particular Web page, the content of which is located on the local data storage unit 106 of the computer system network 102, to access the content of the Web page. The Web page may contain links to other computer systems and other Web pages. Data can be downloaded from the Web pages or uploaded to the Web pages.

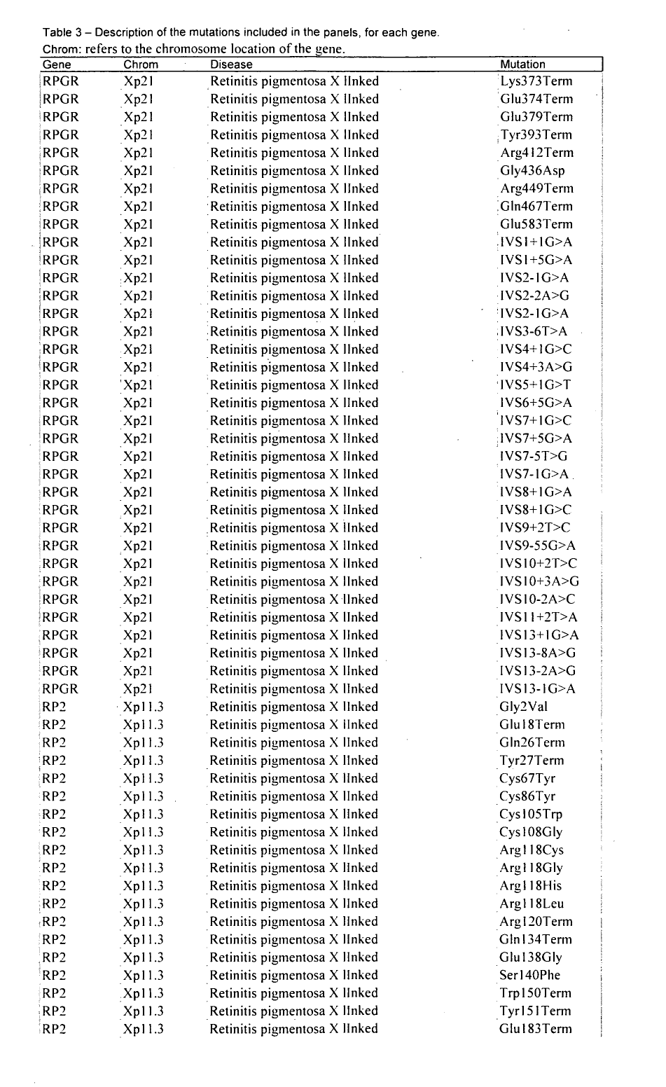

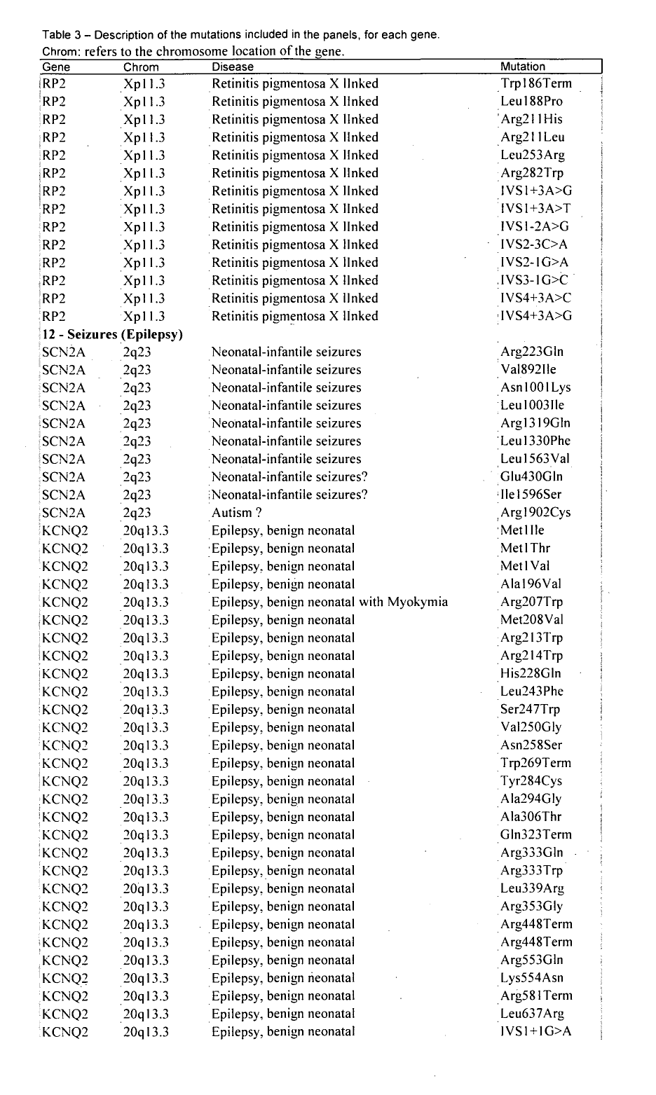

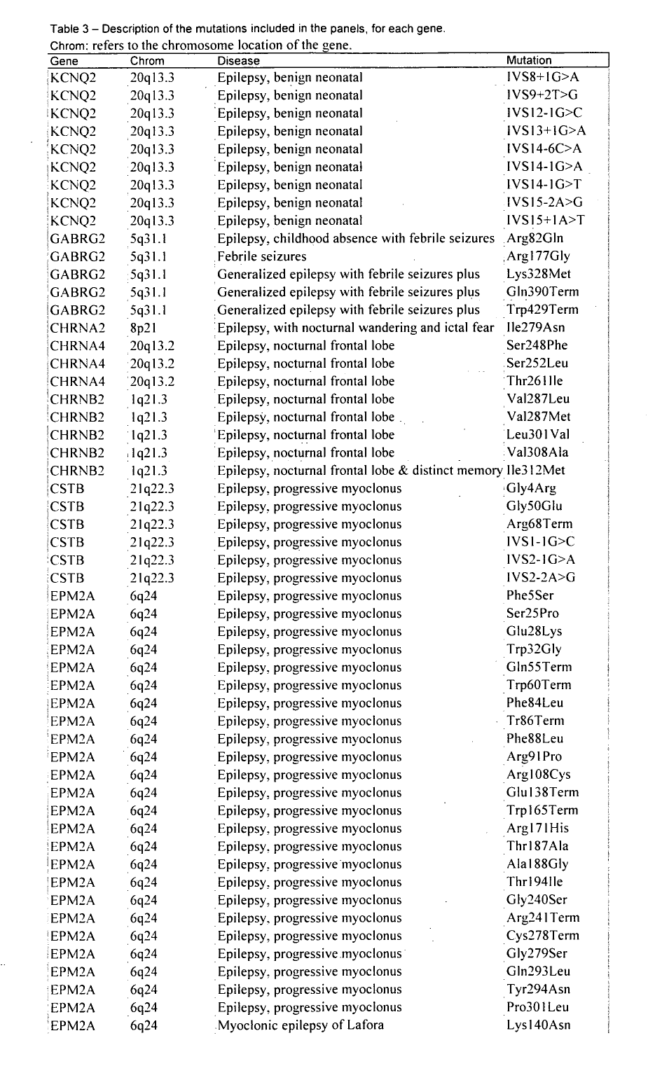

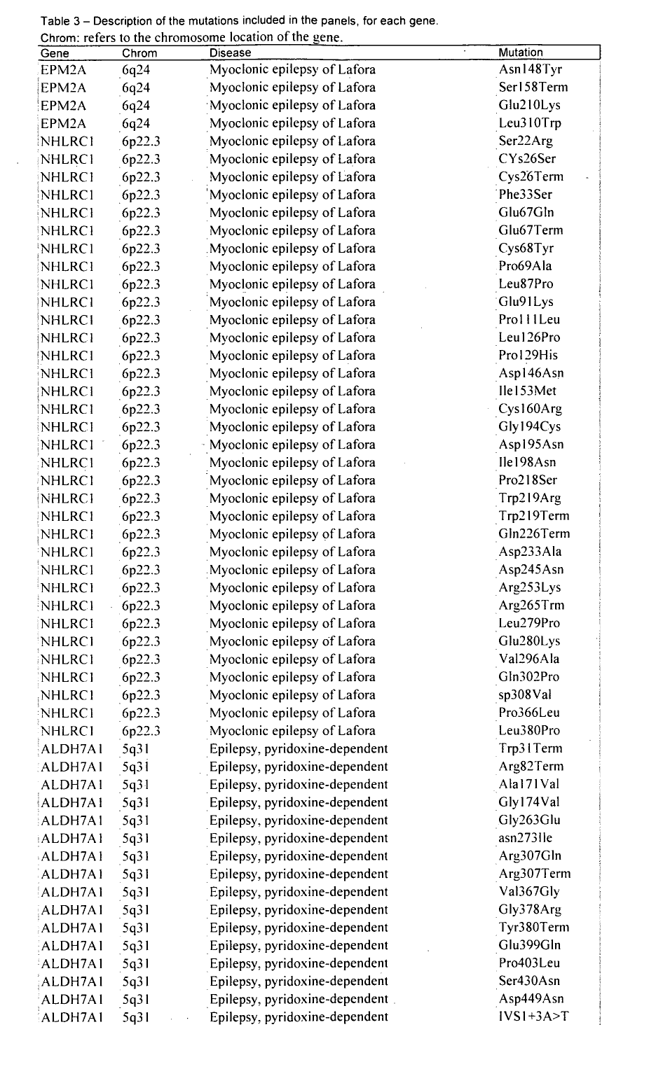

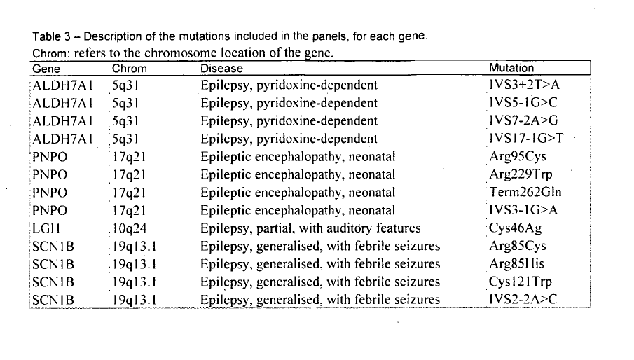

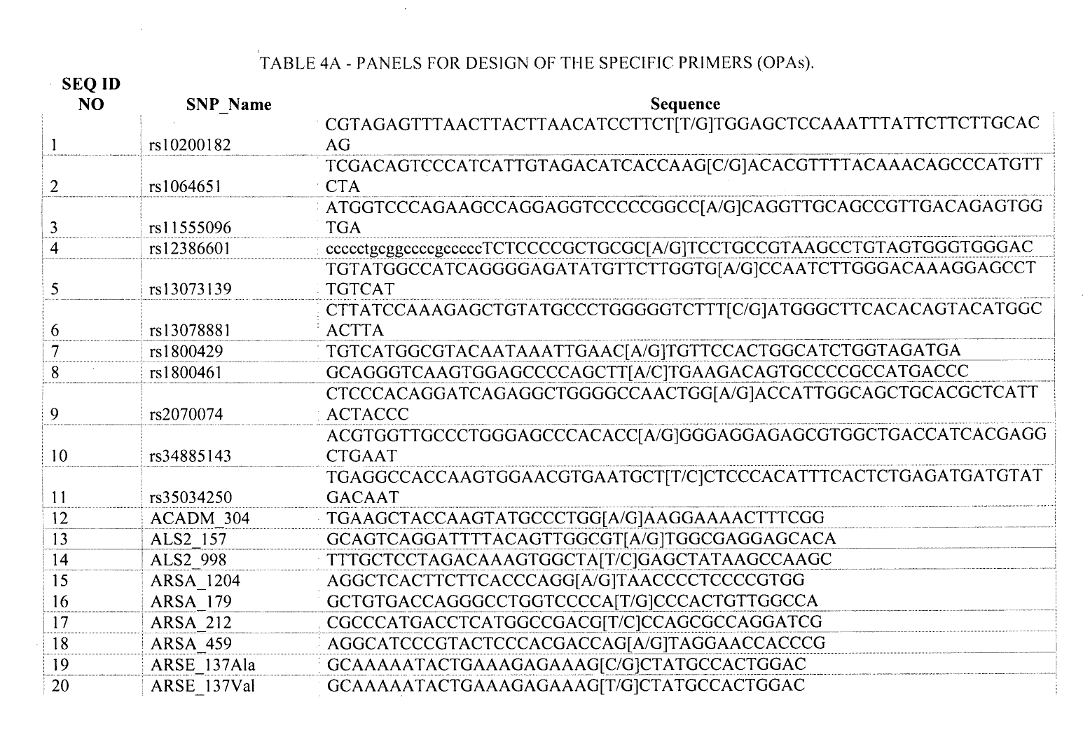

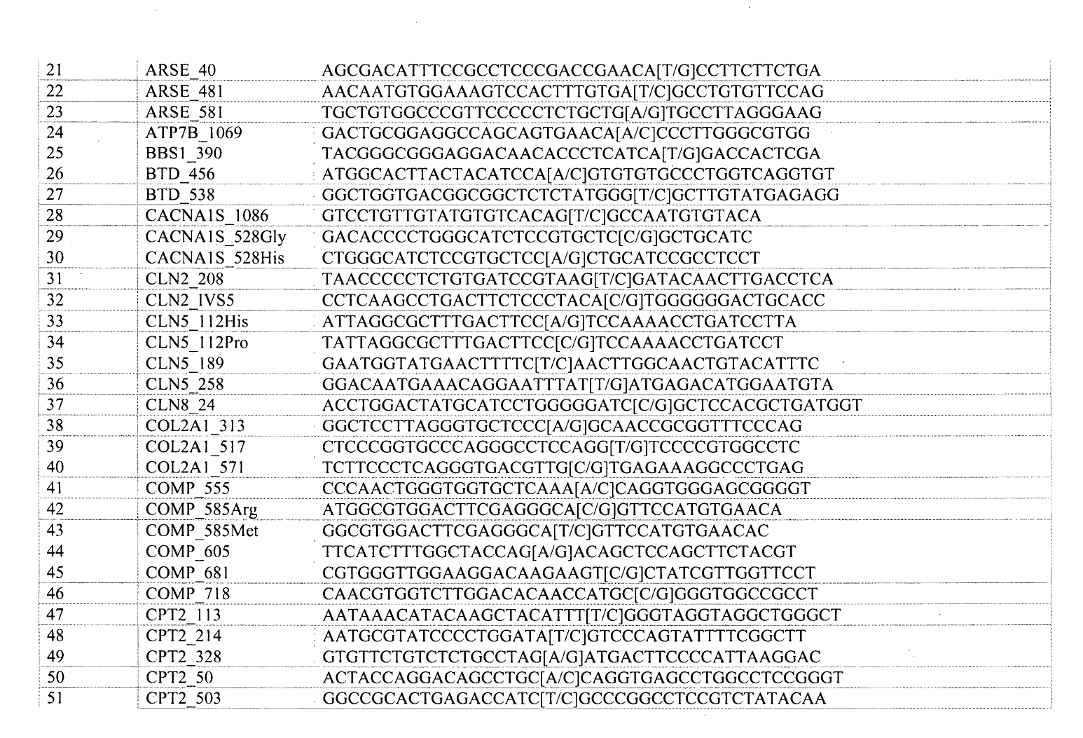

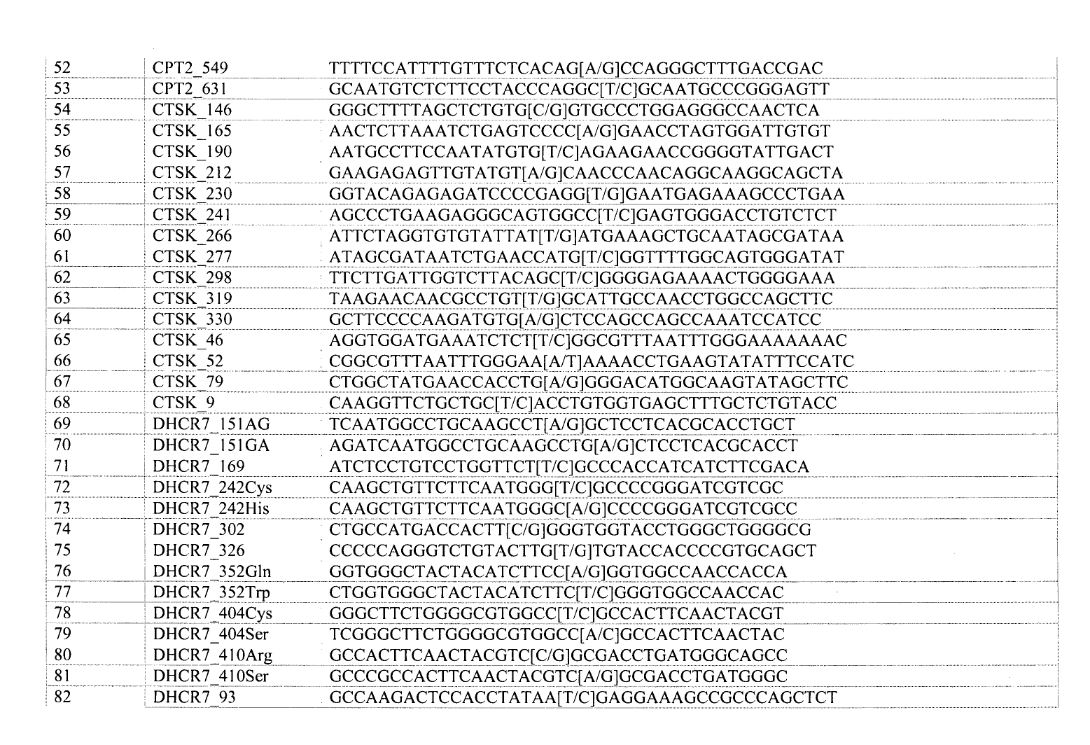

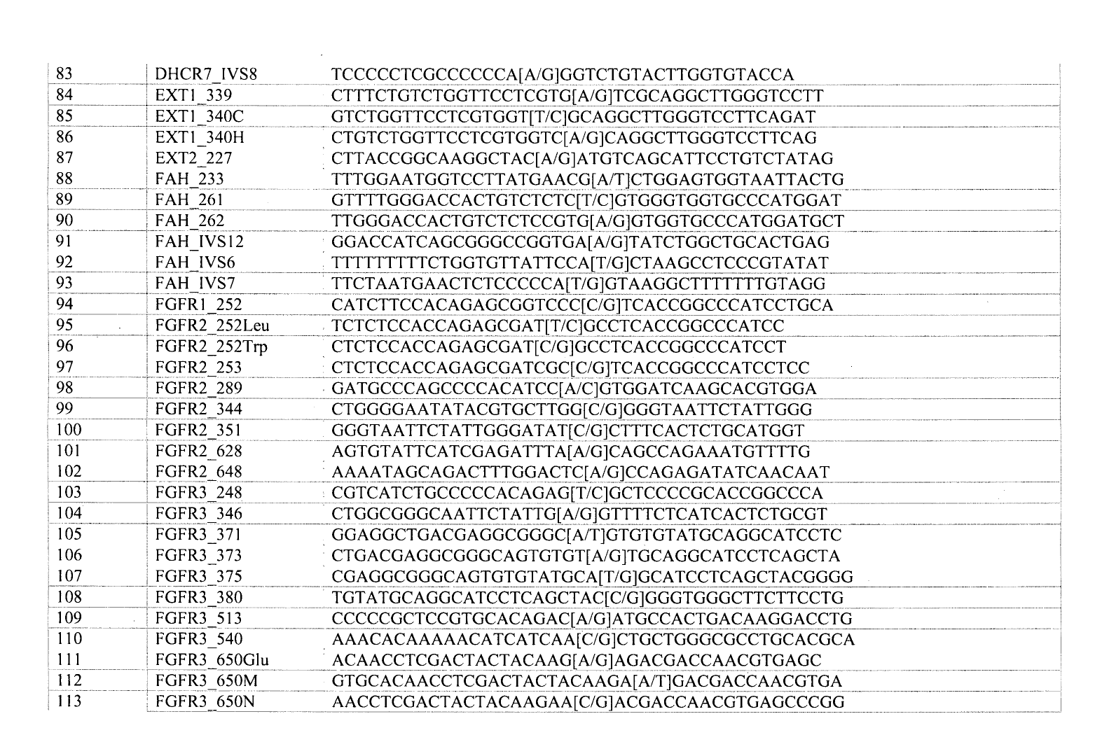

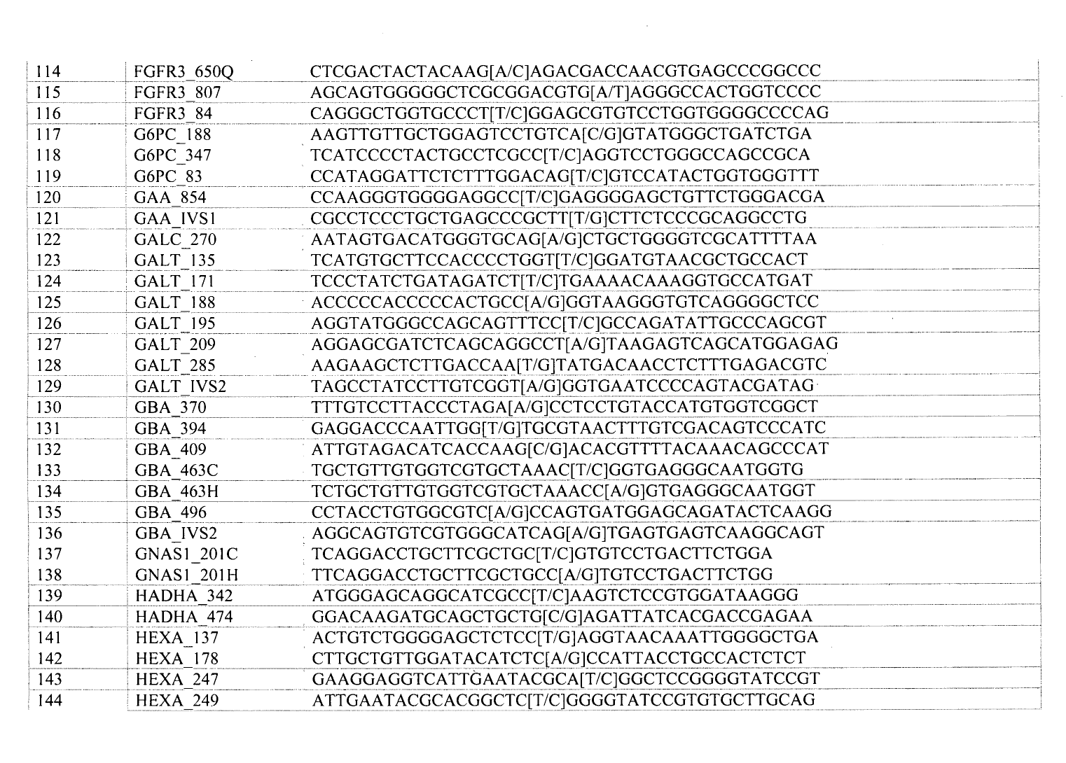

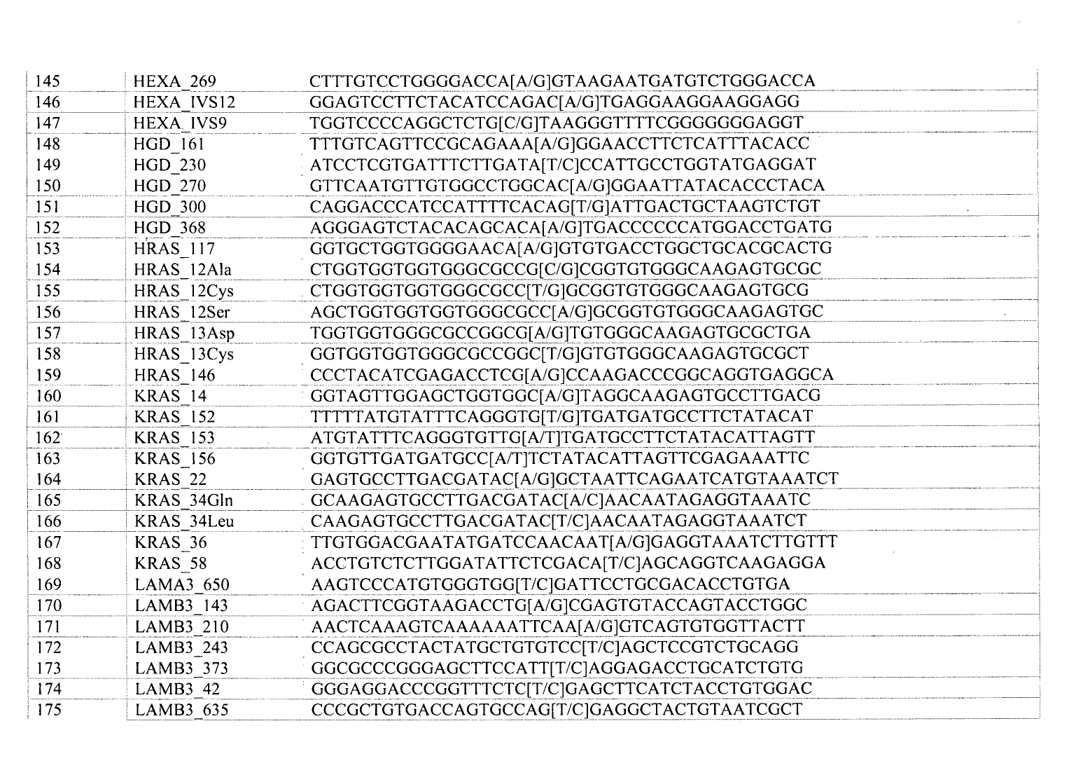

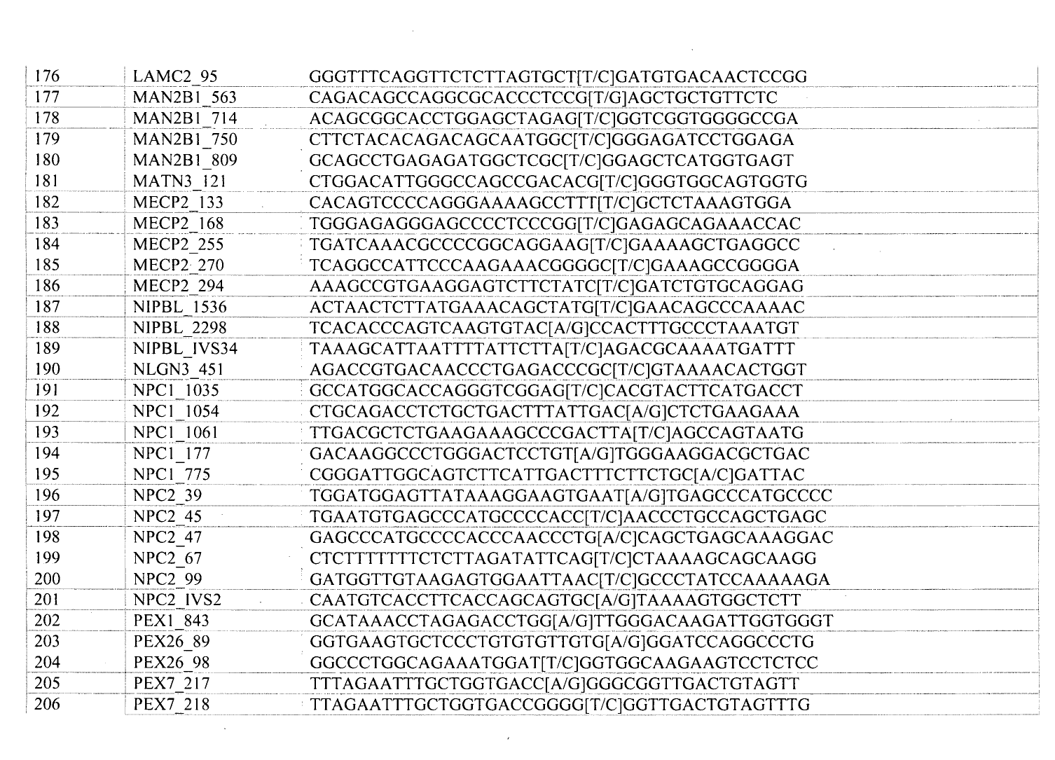

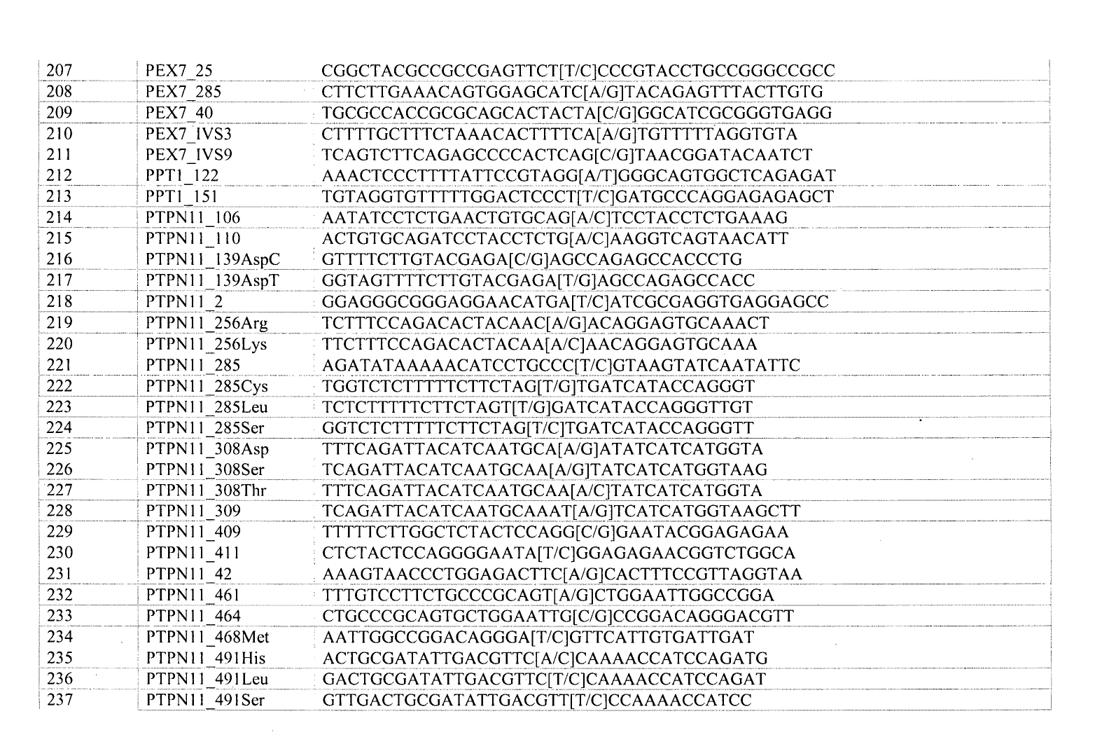

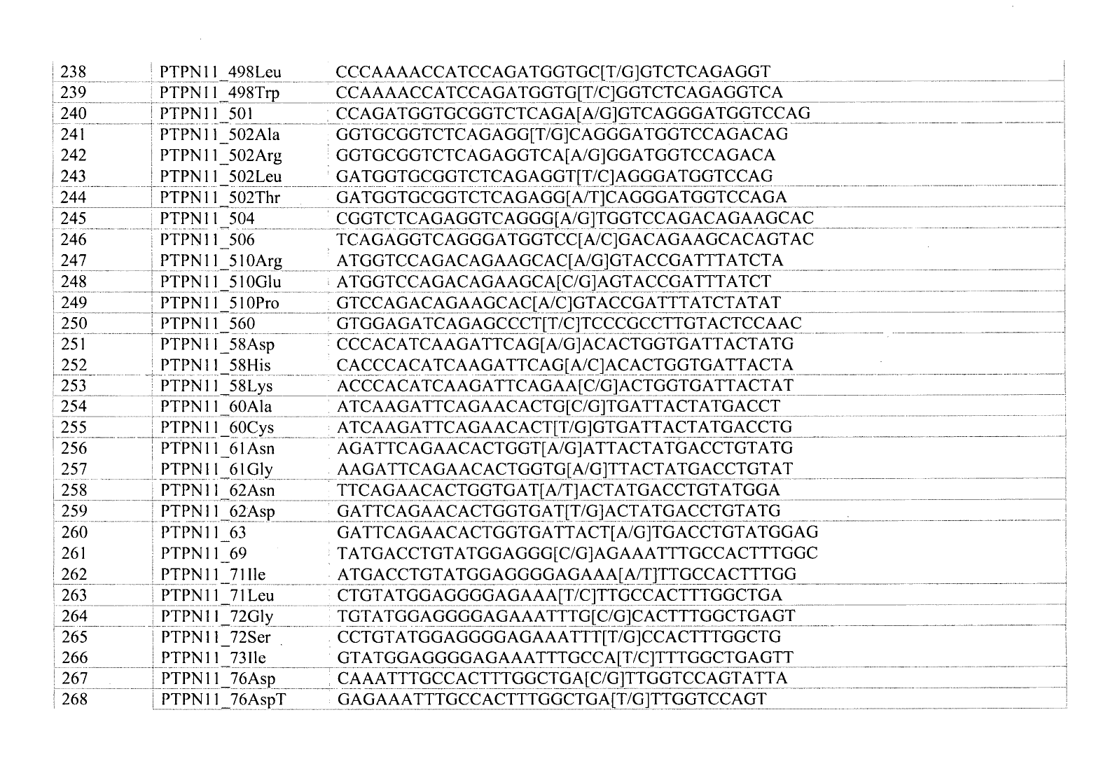

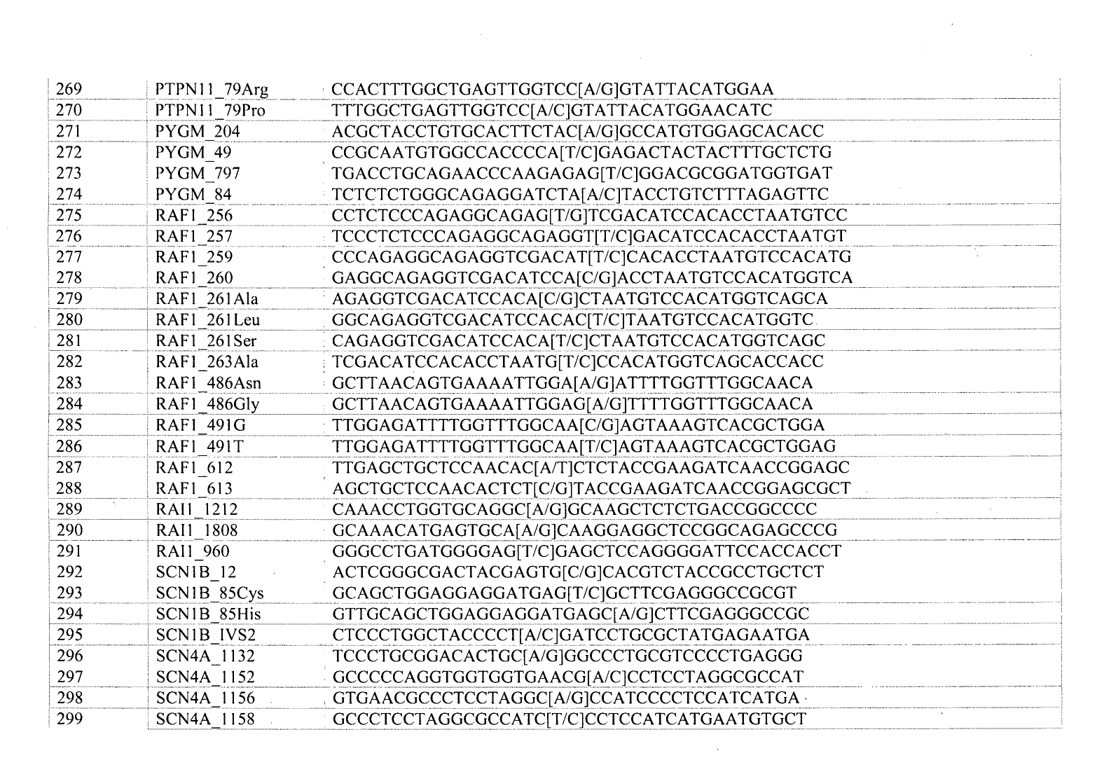

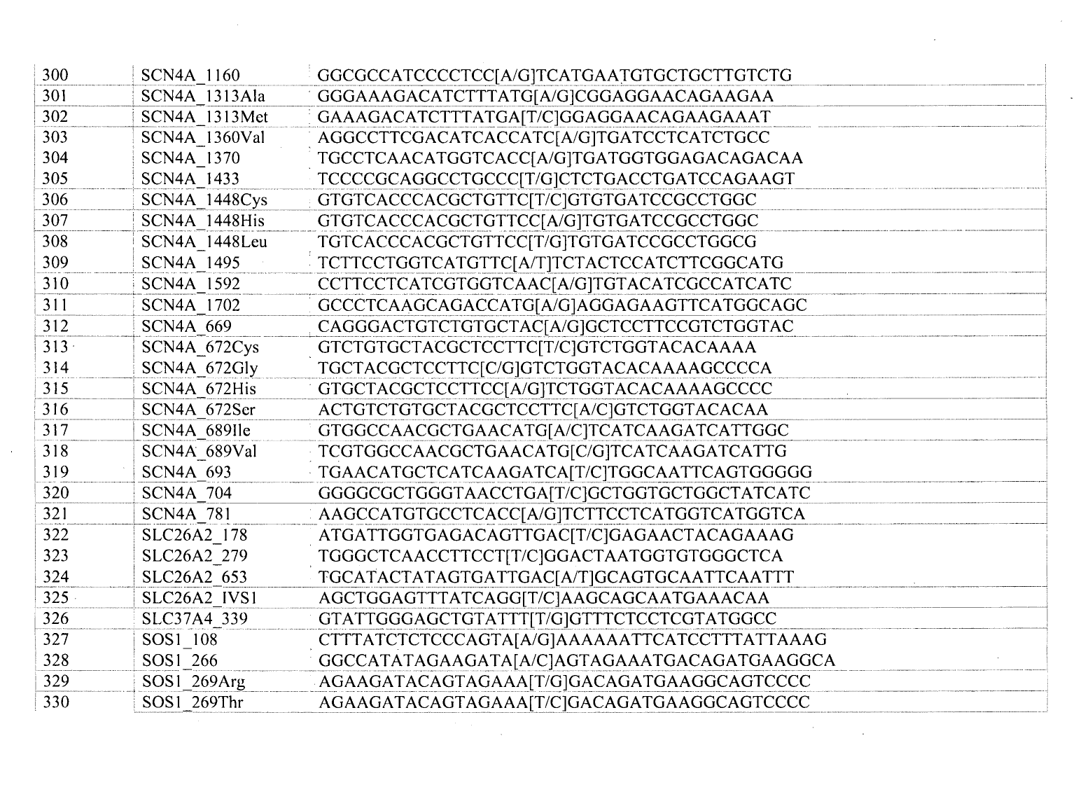

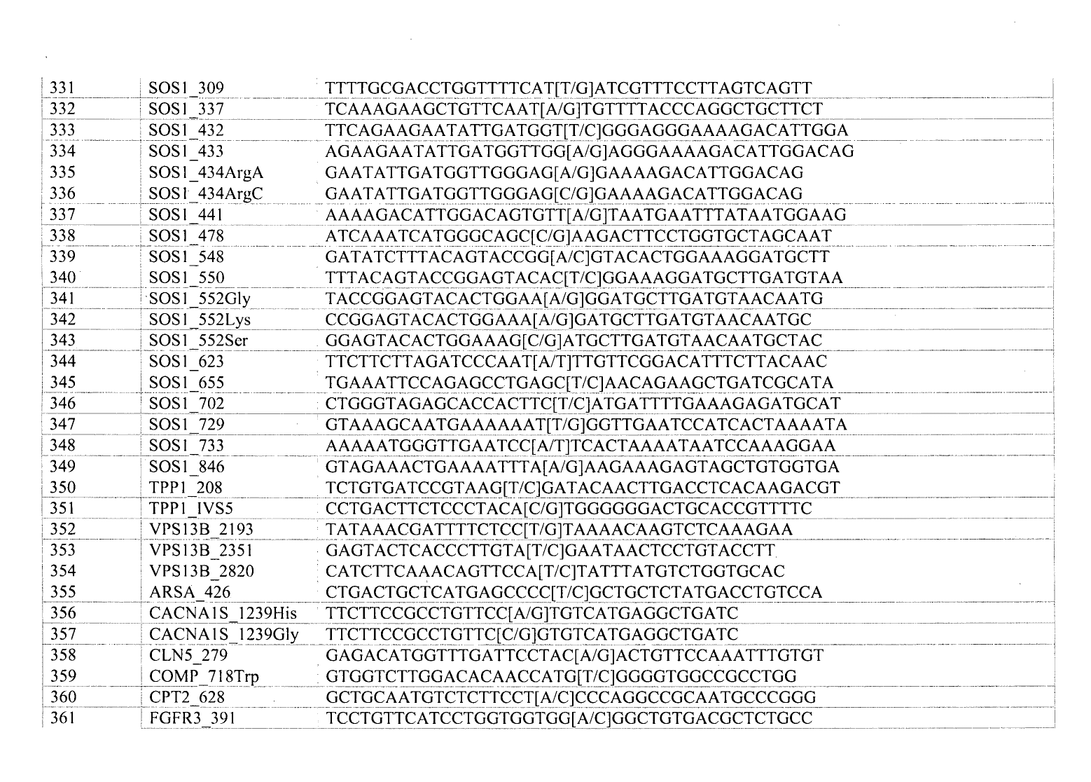

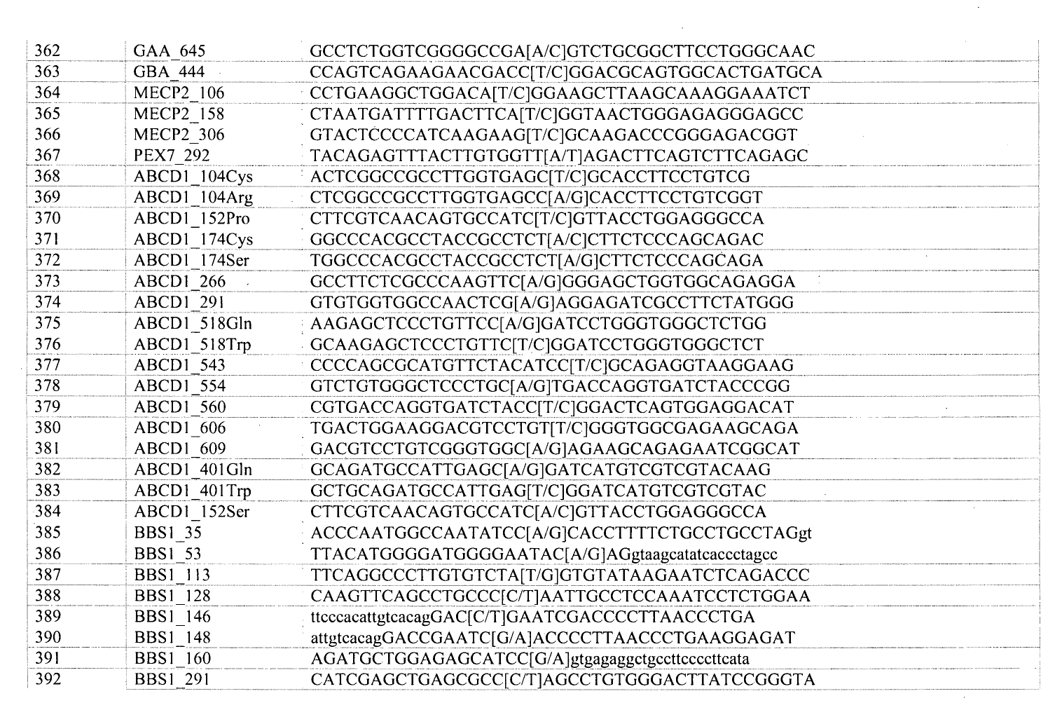

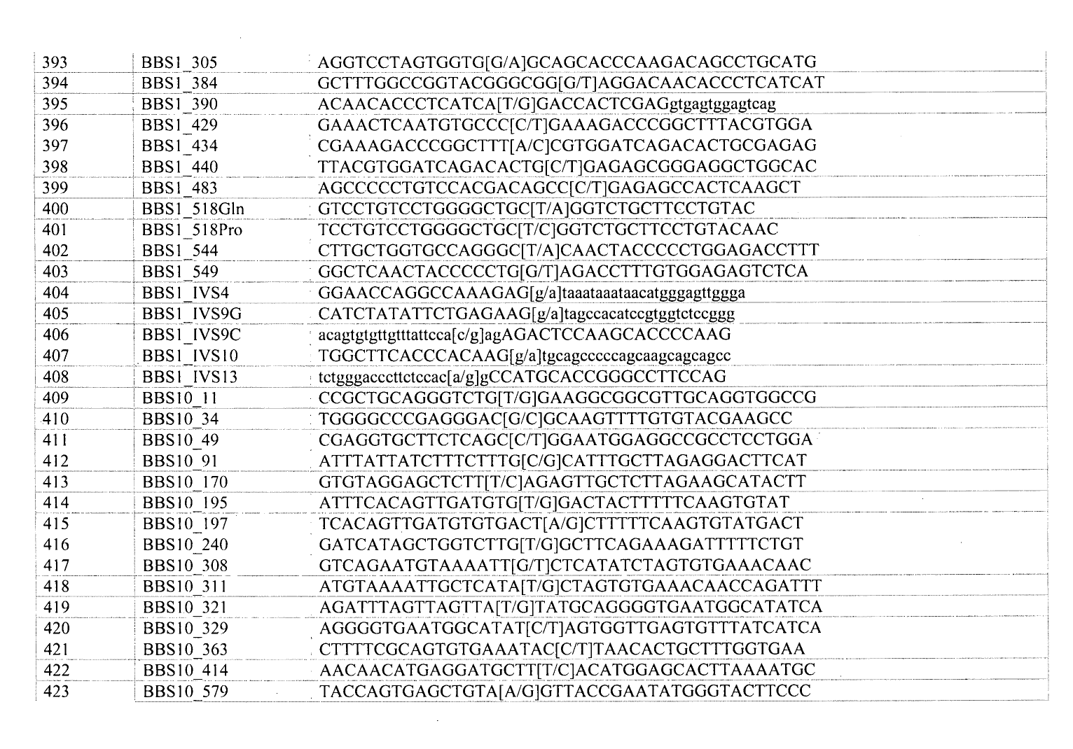

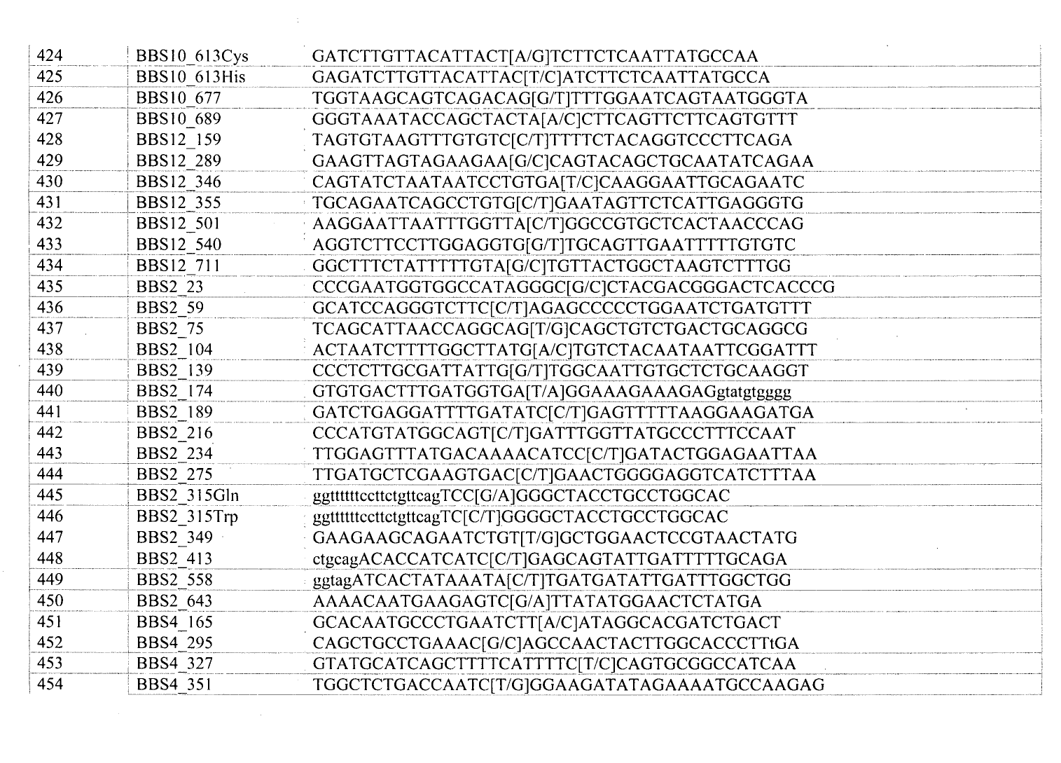

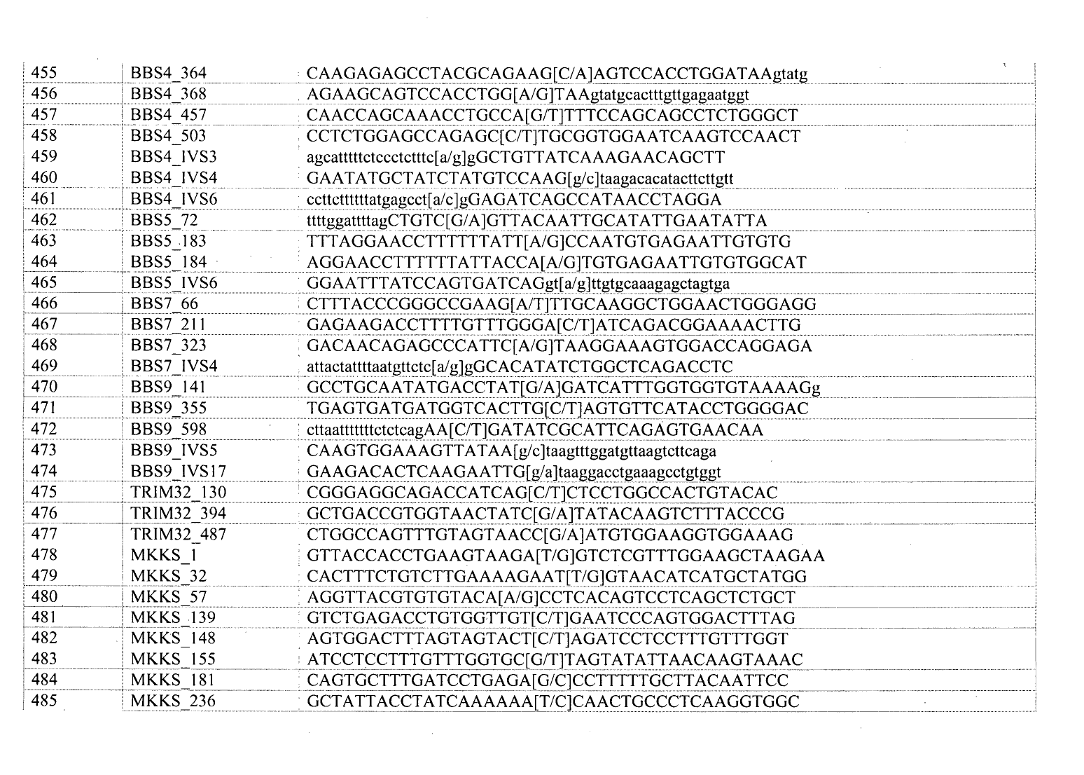

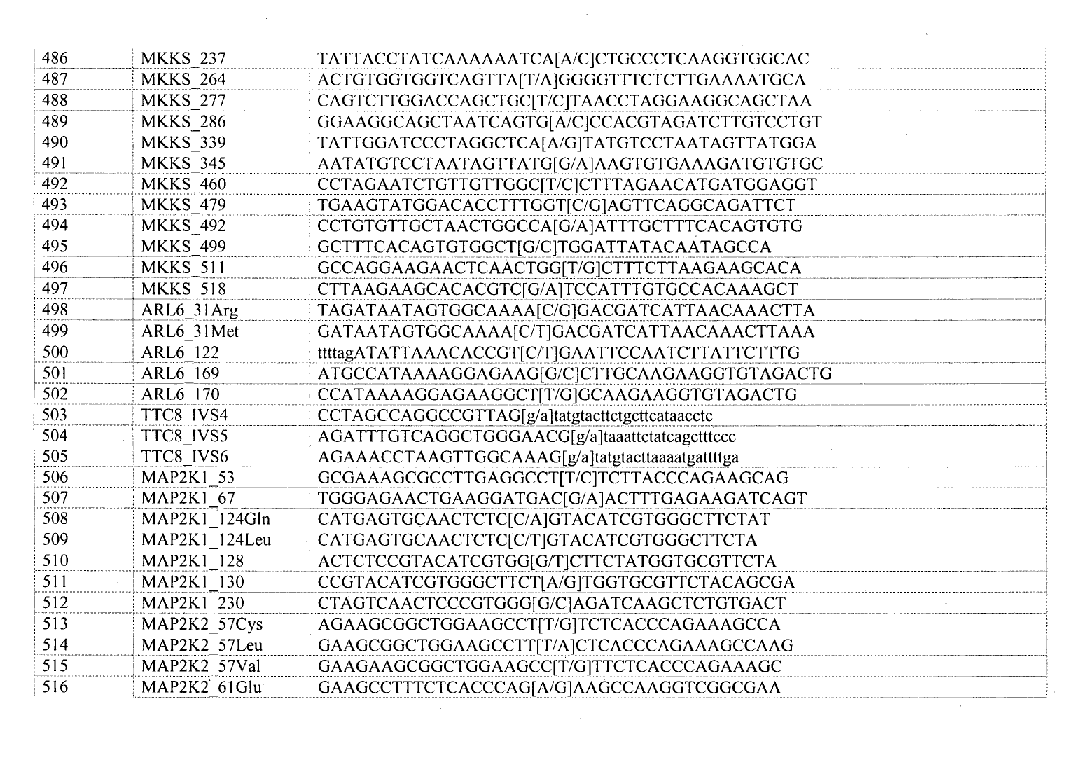

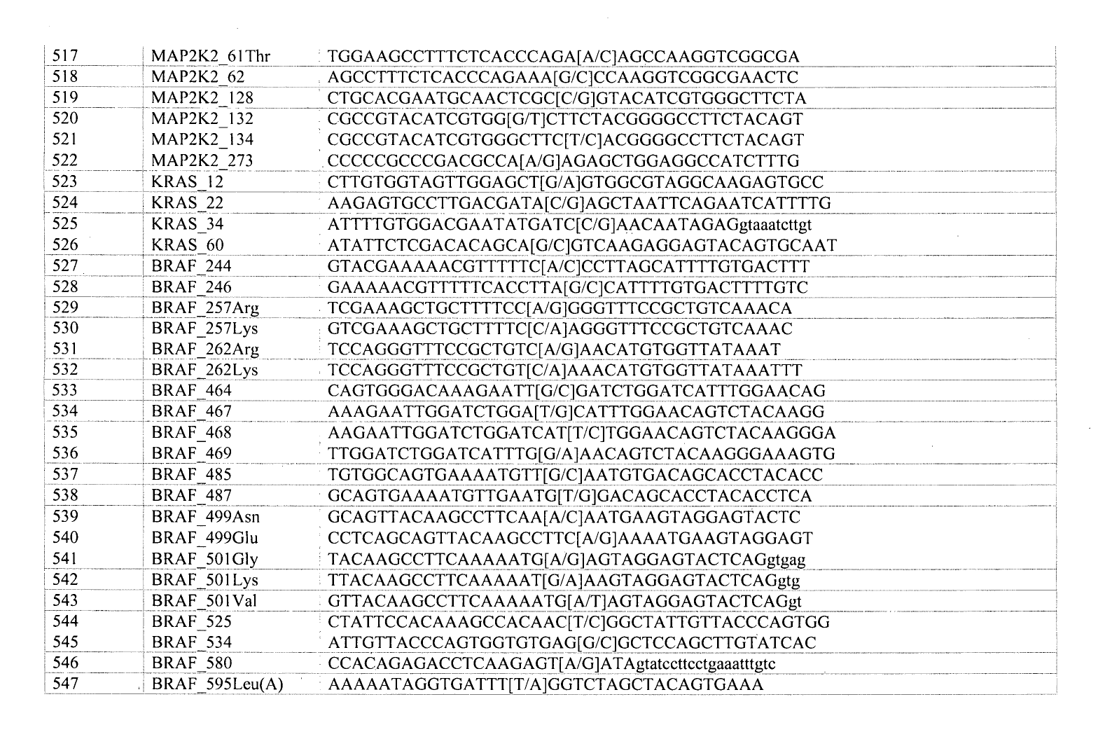

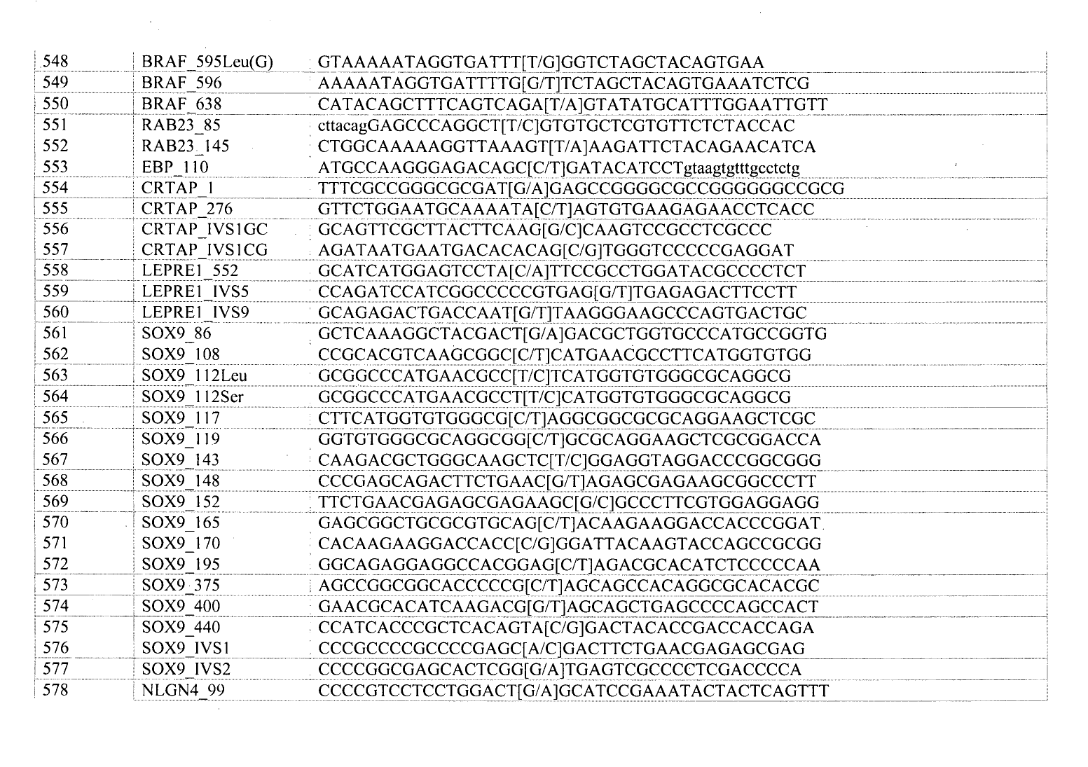

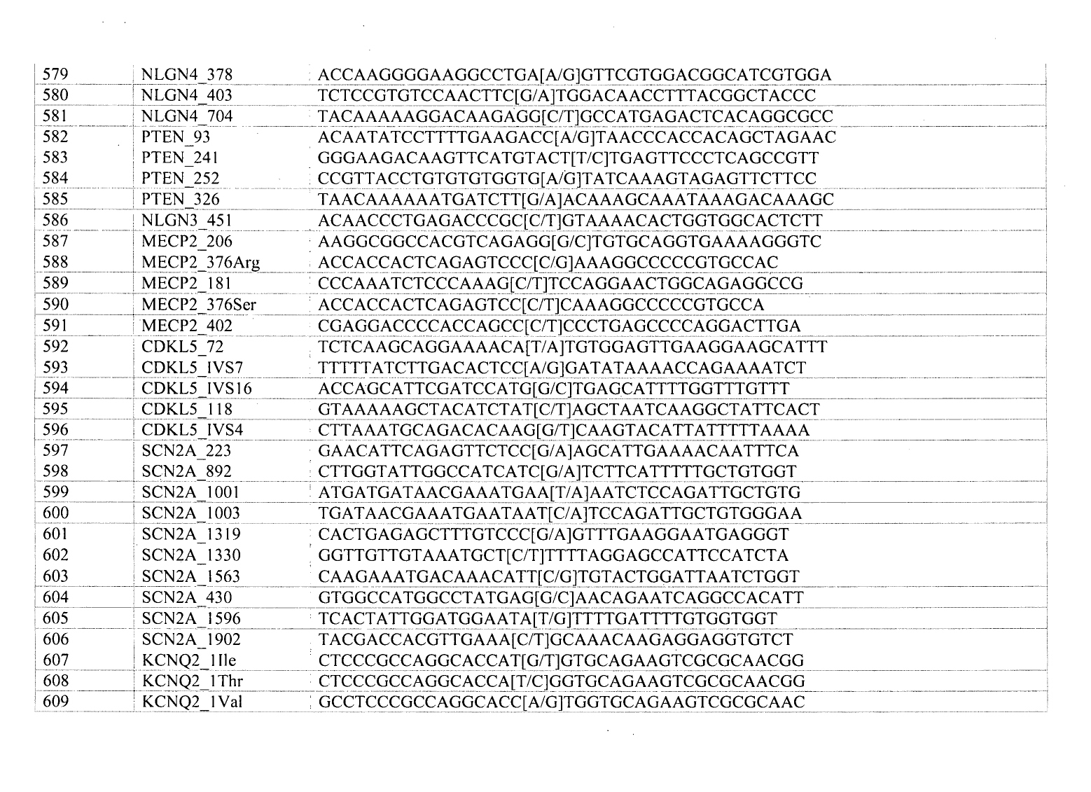

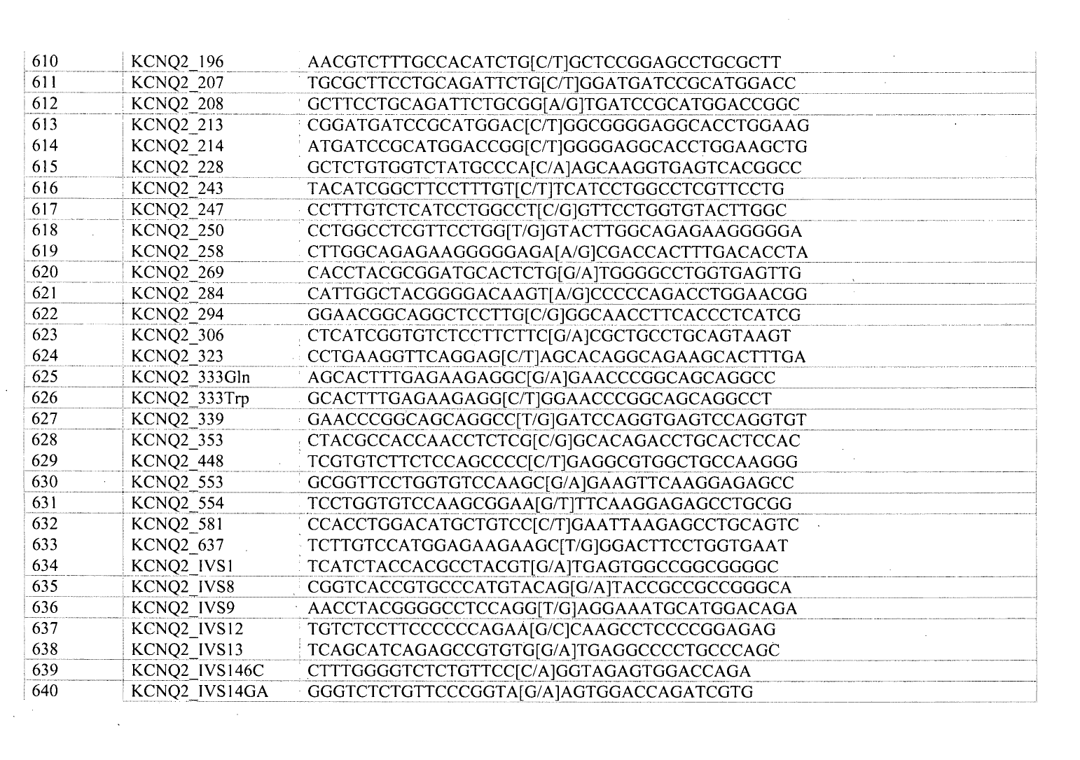

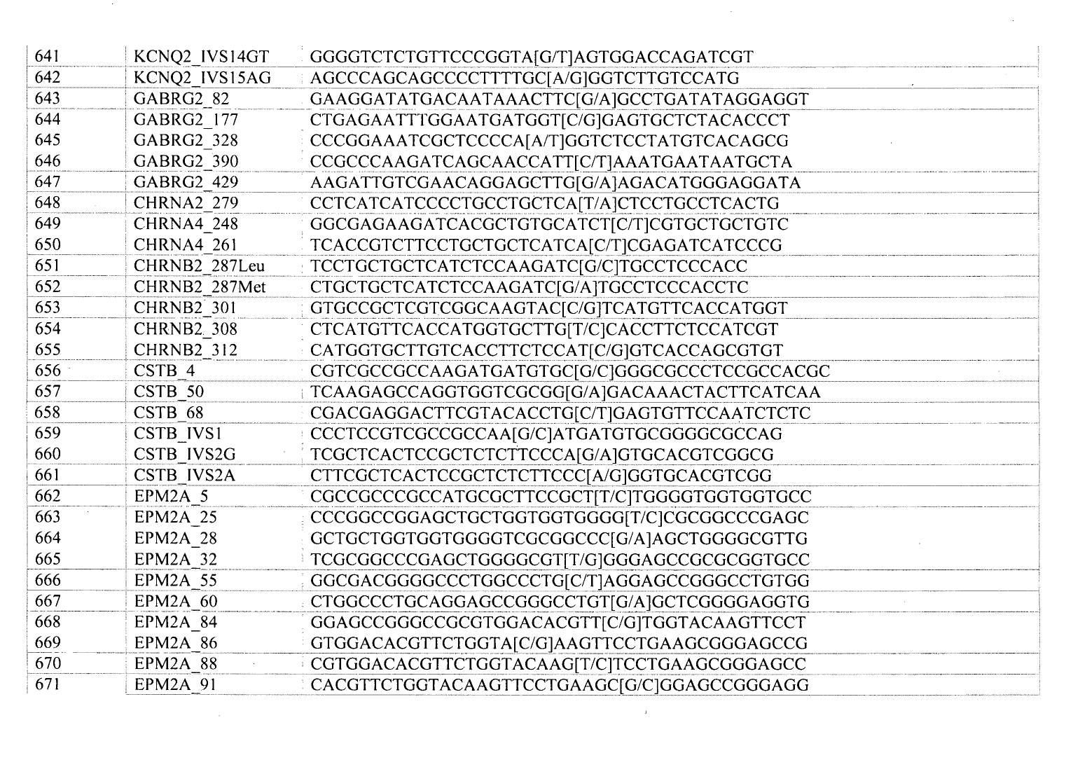

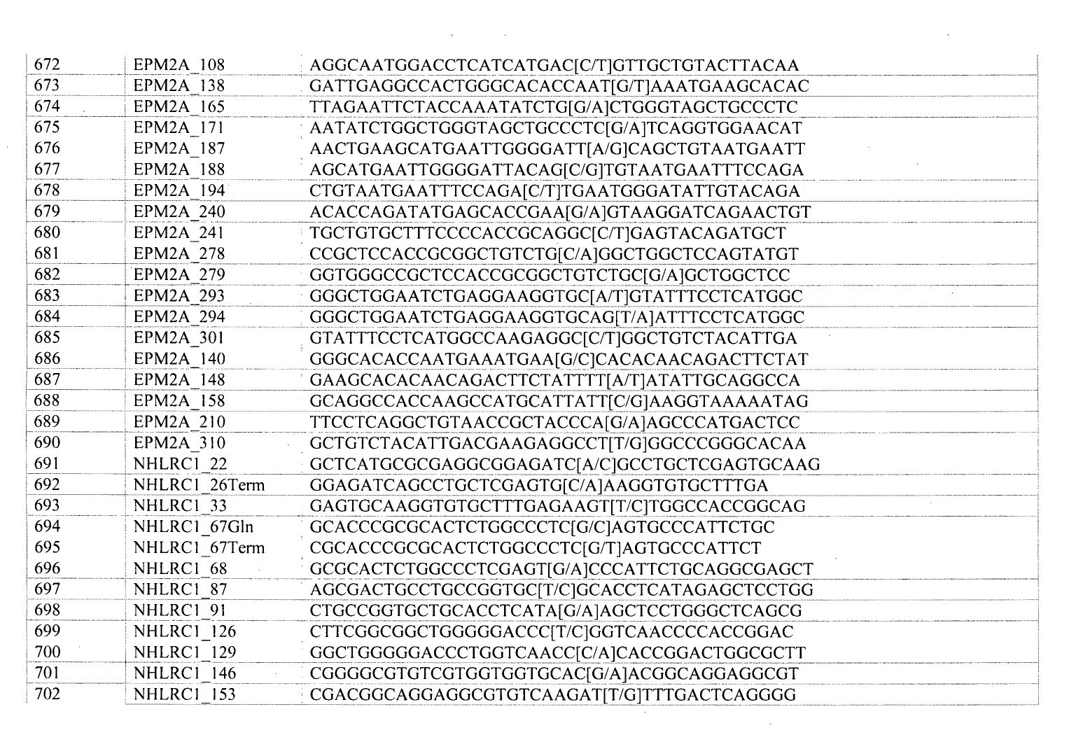

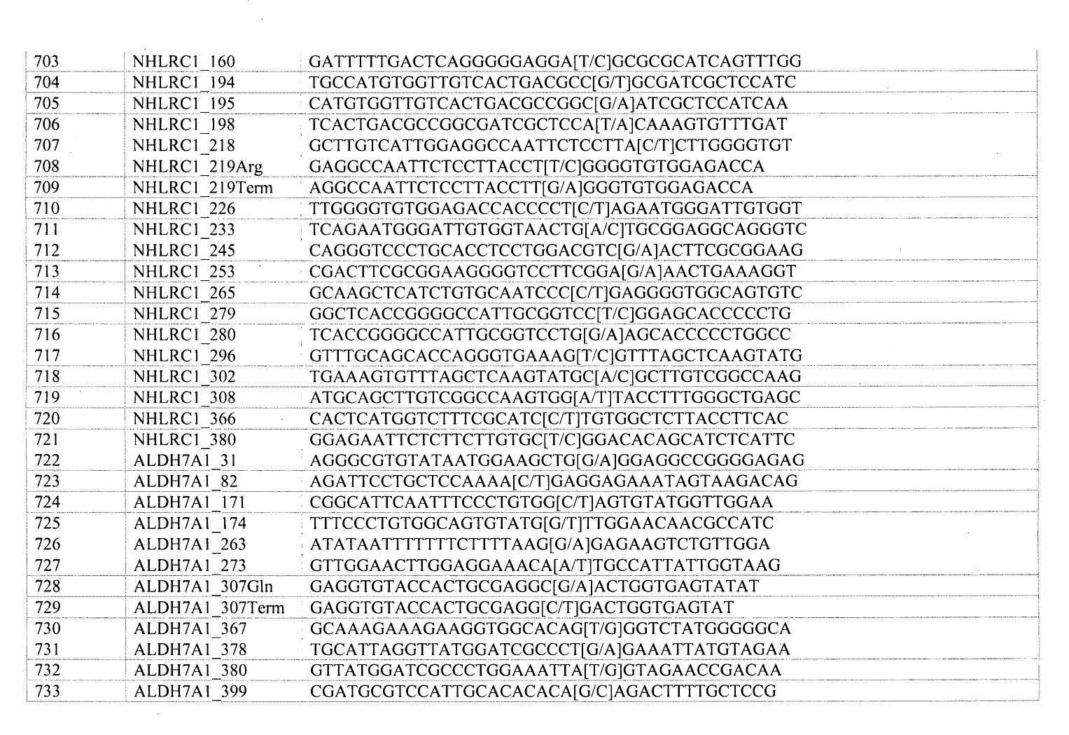

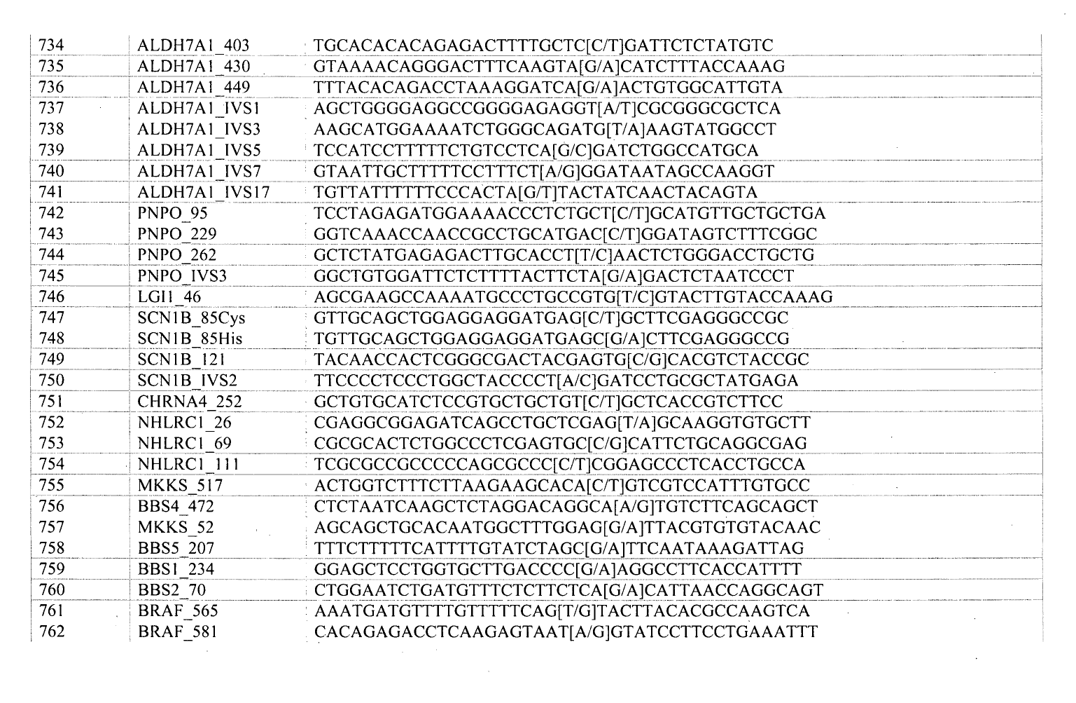

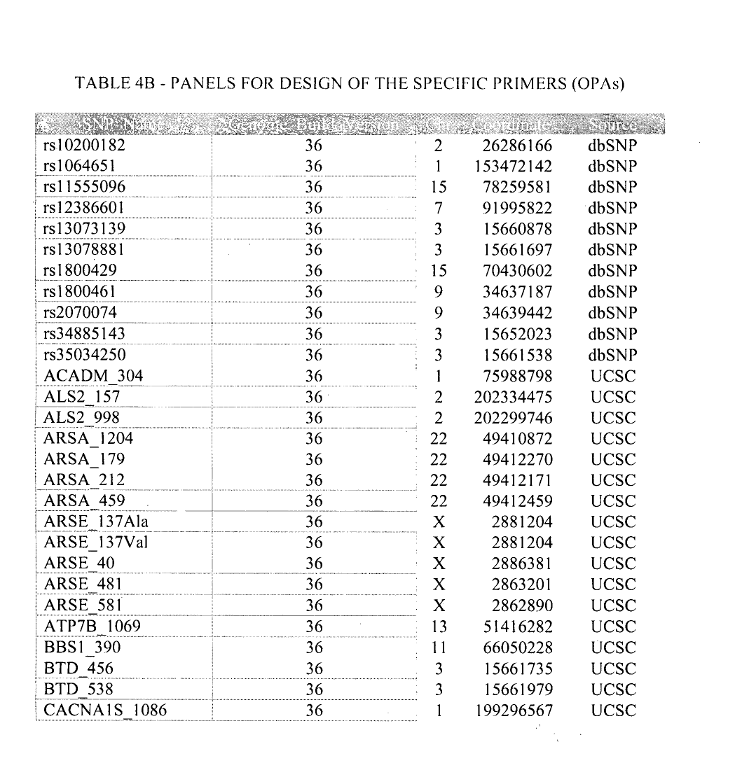

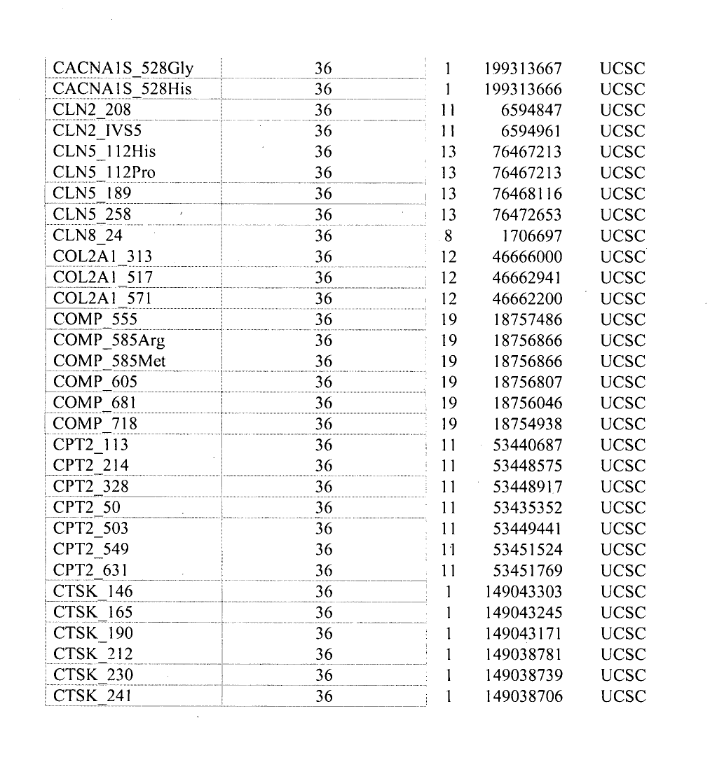

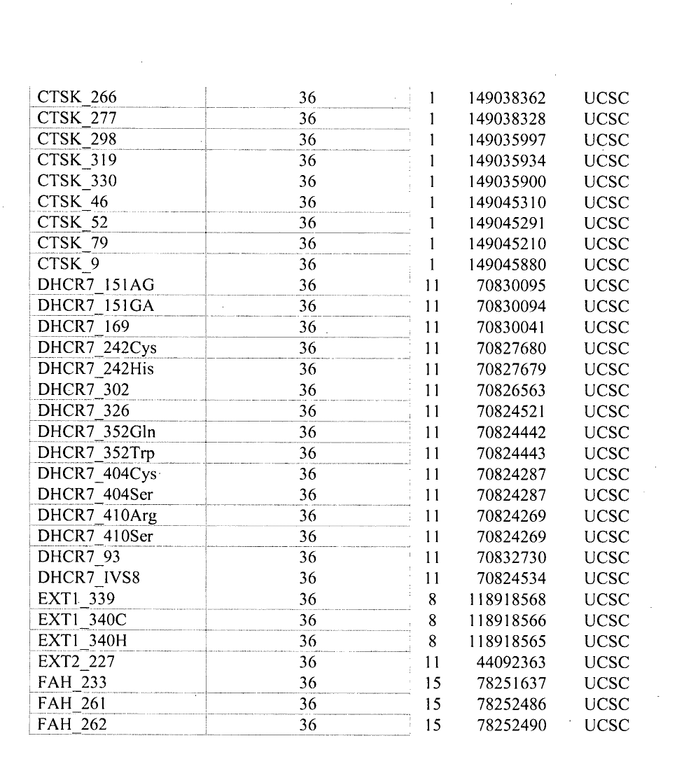

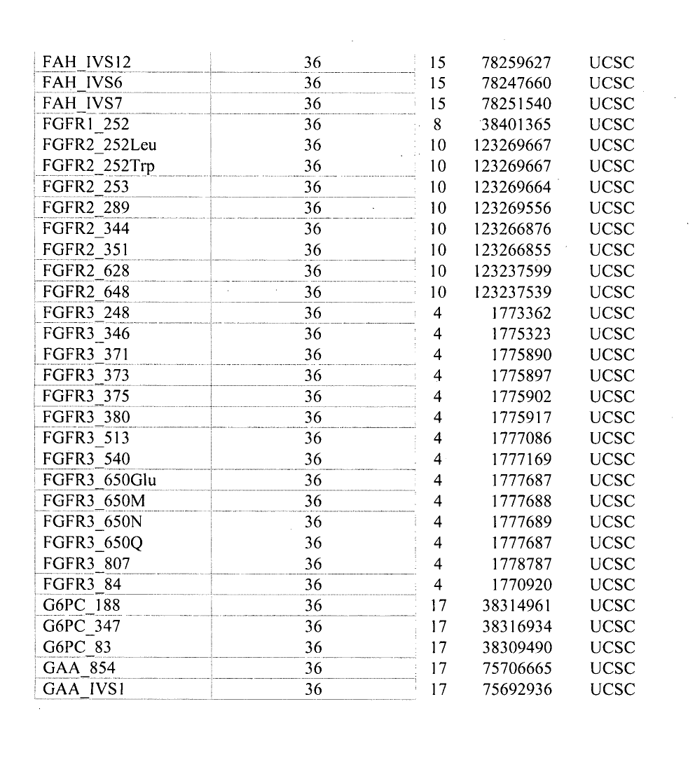

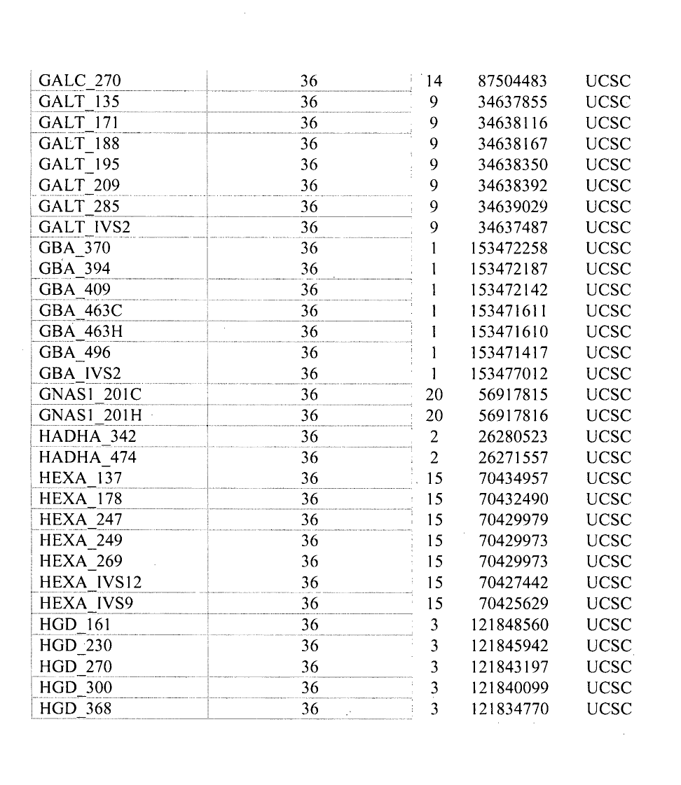

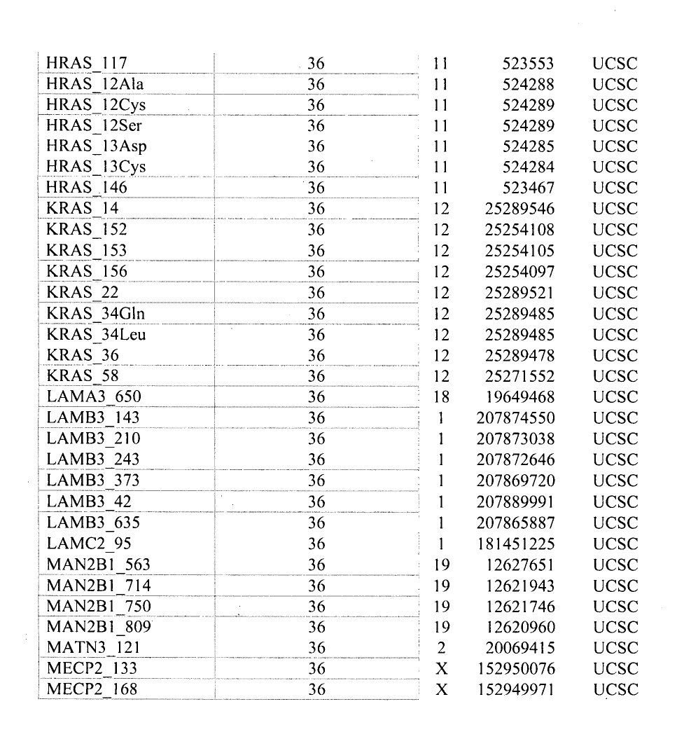

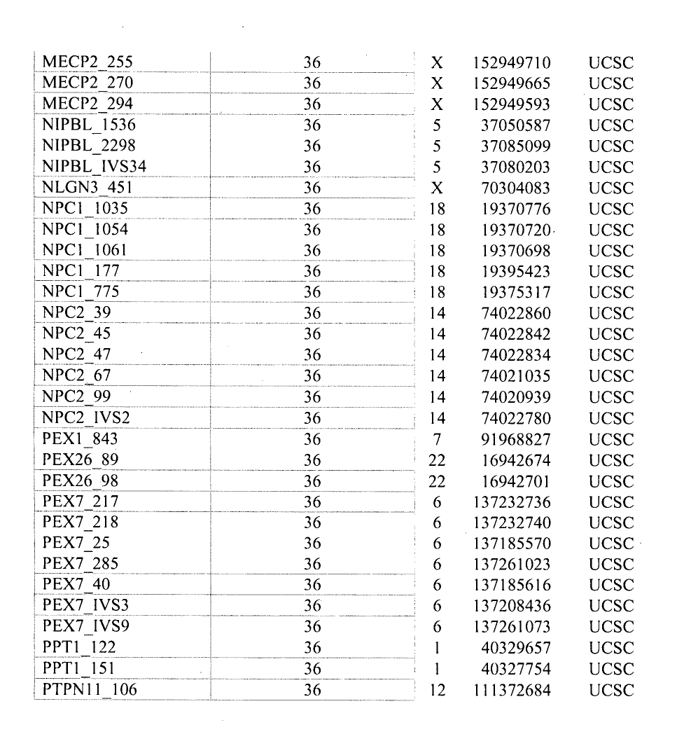

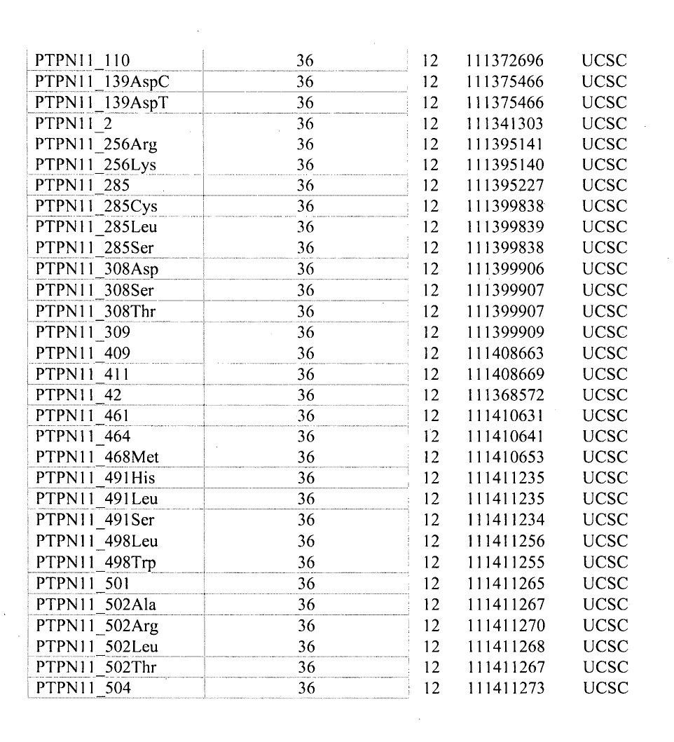

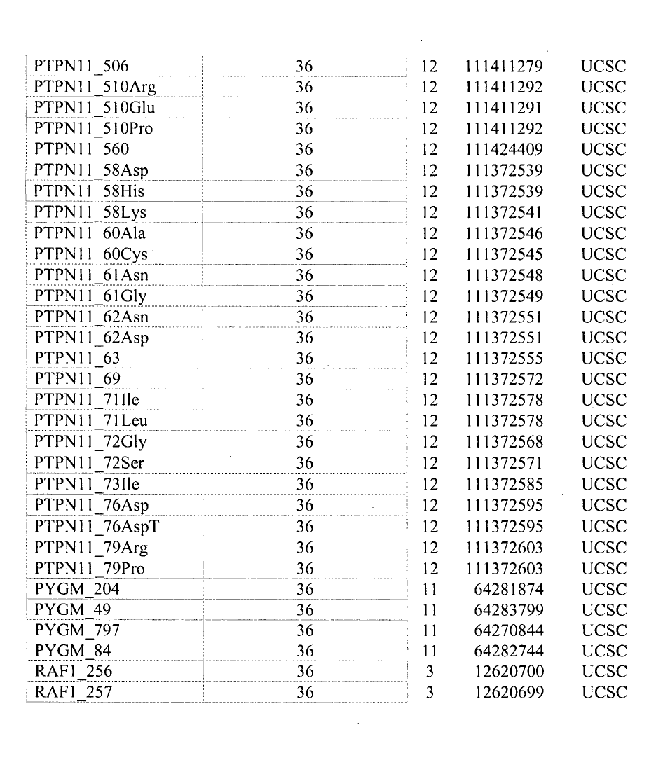

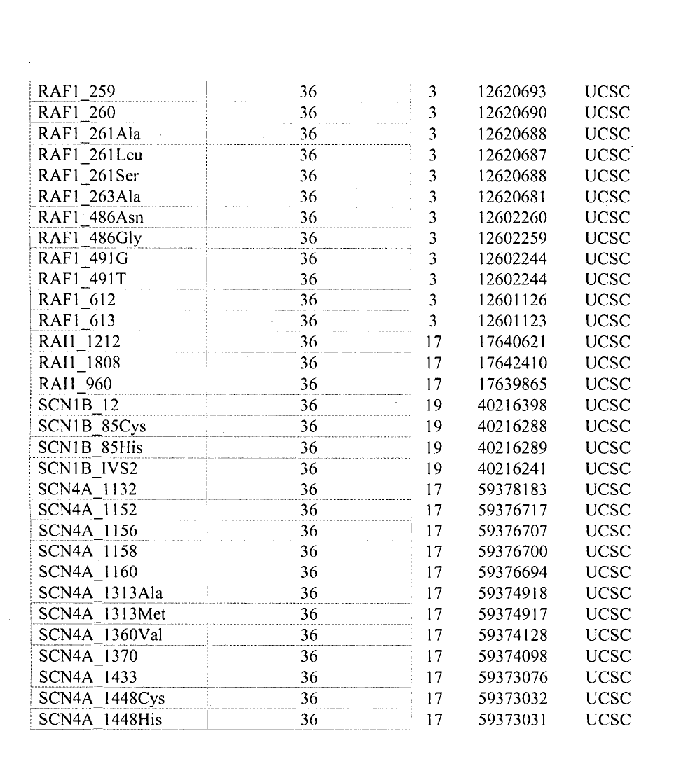

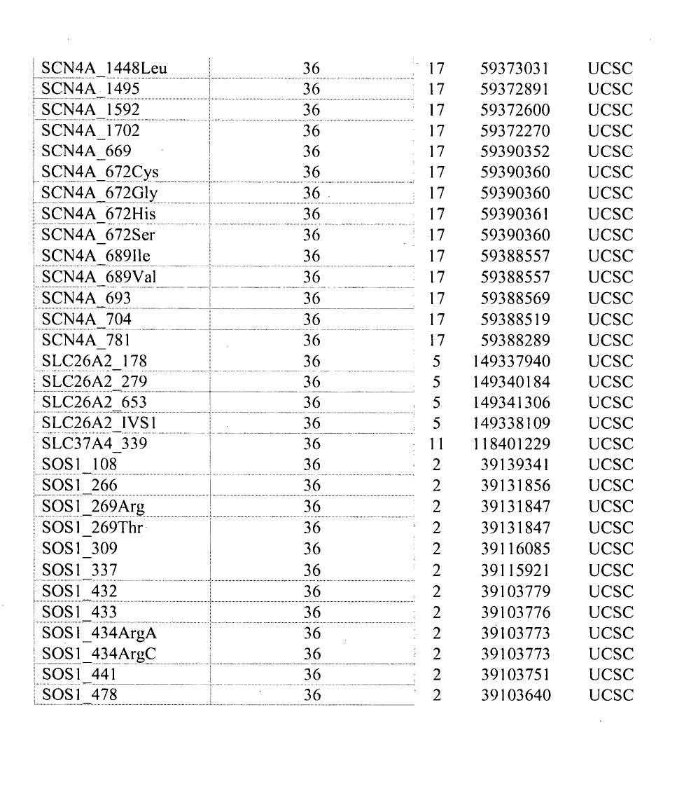

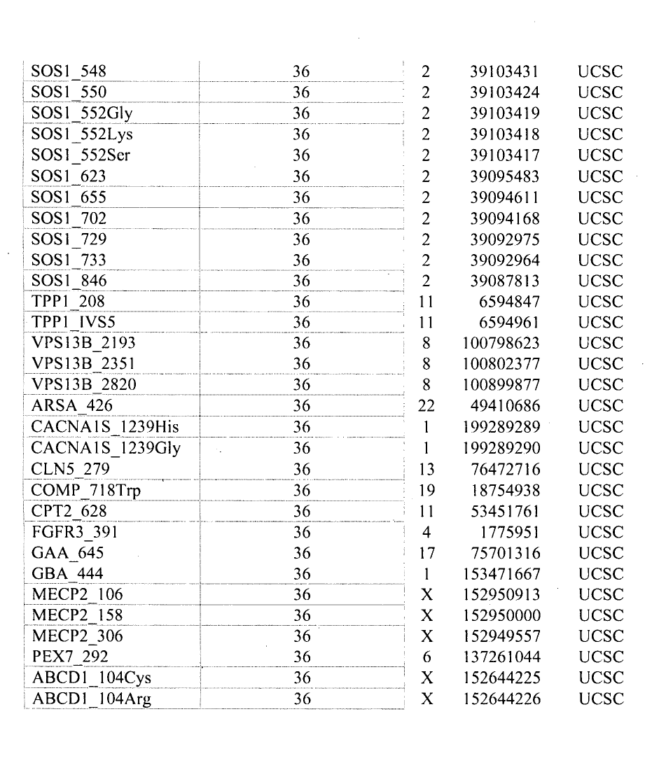

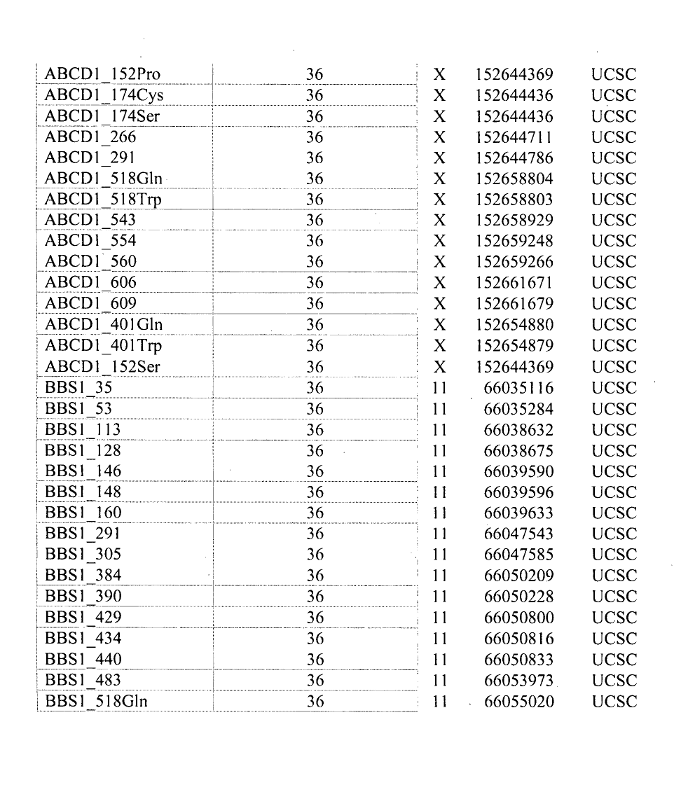

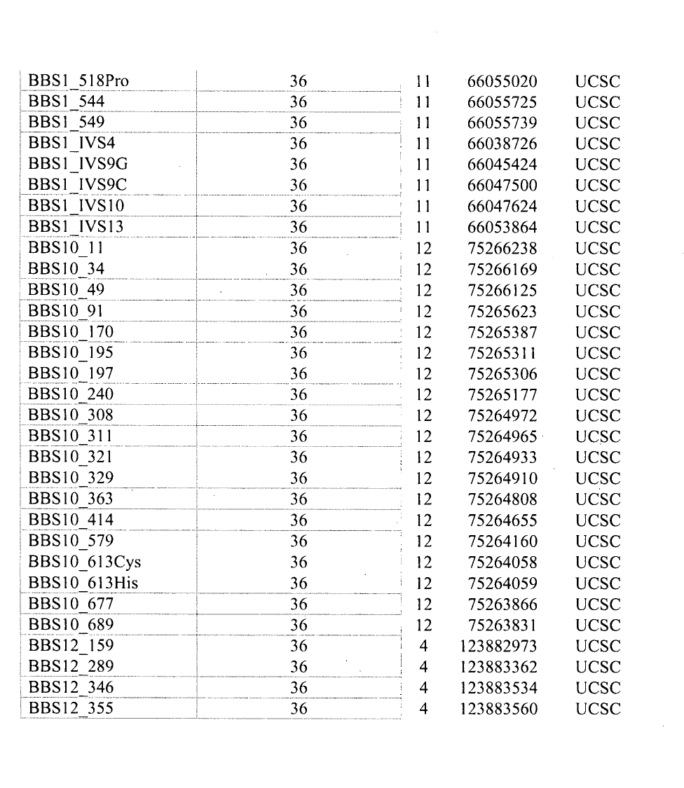

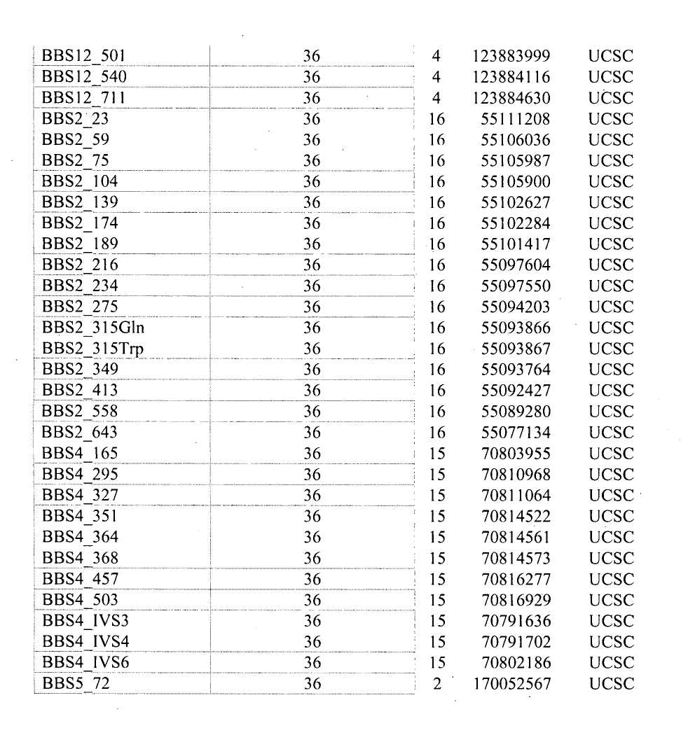

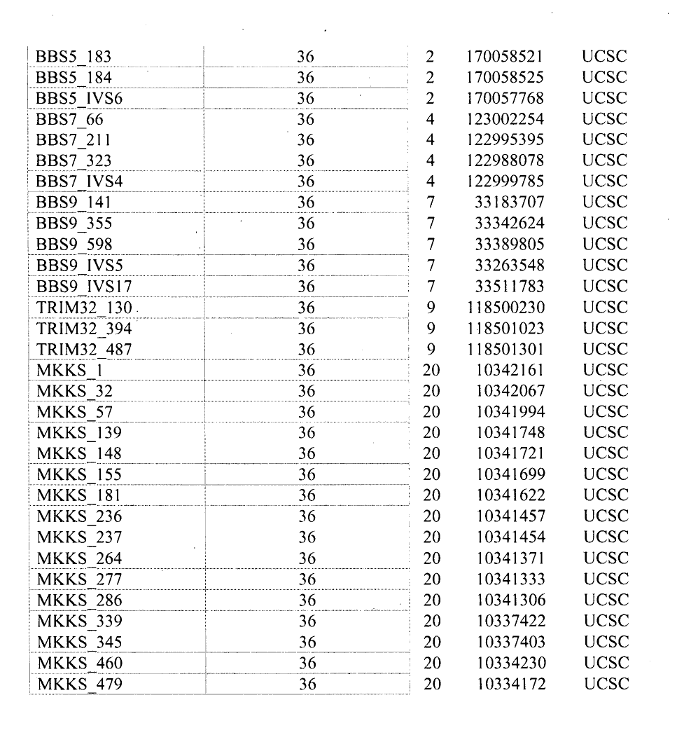

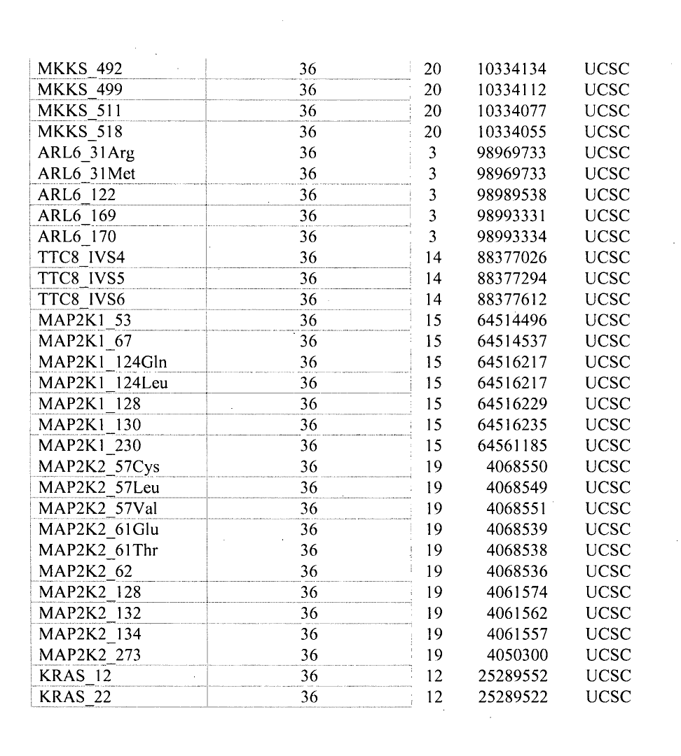

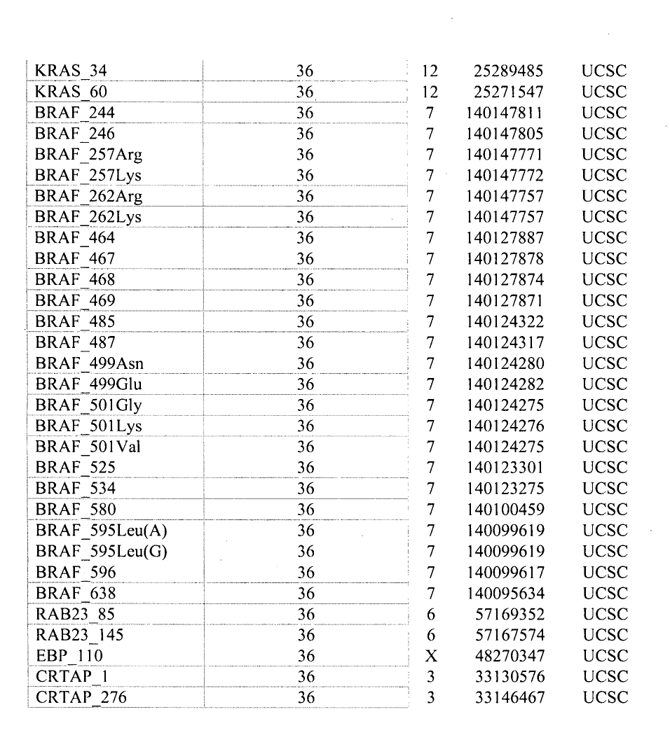

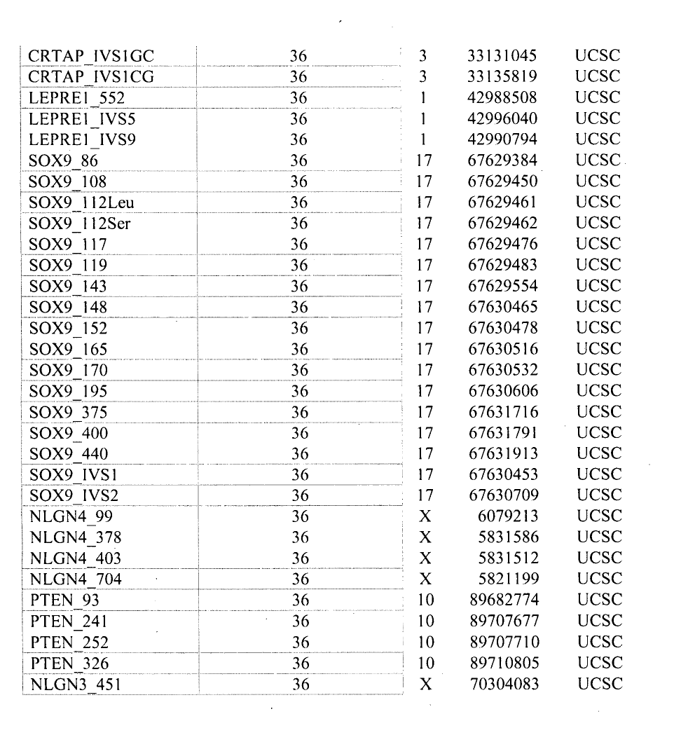

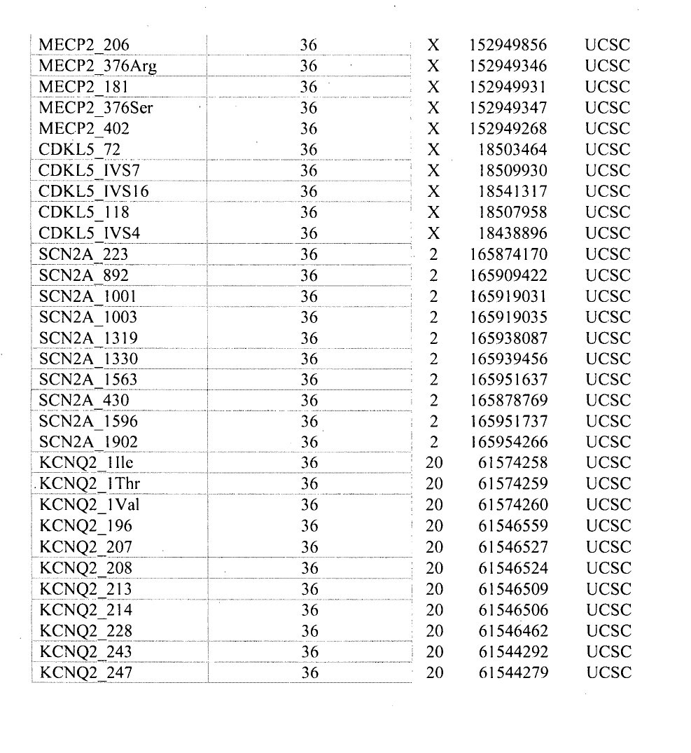

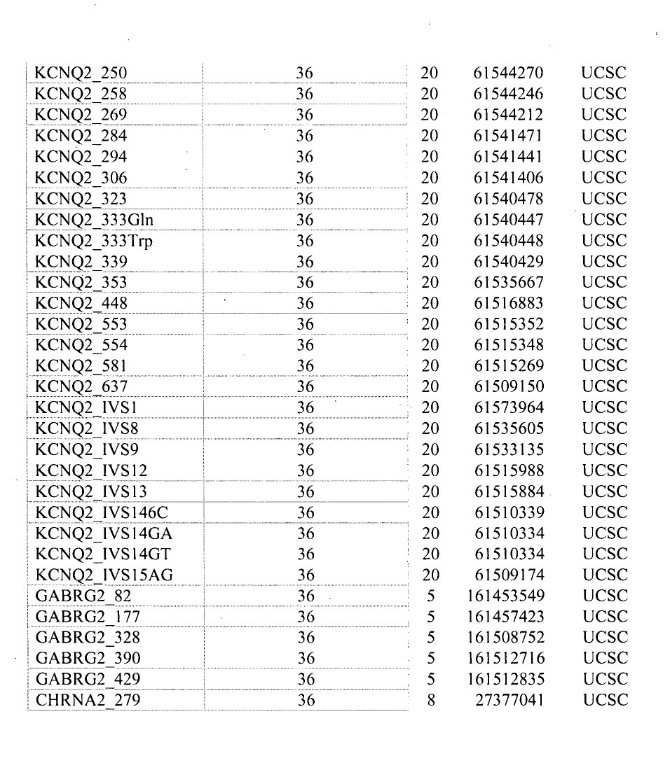

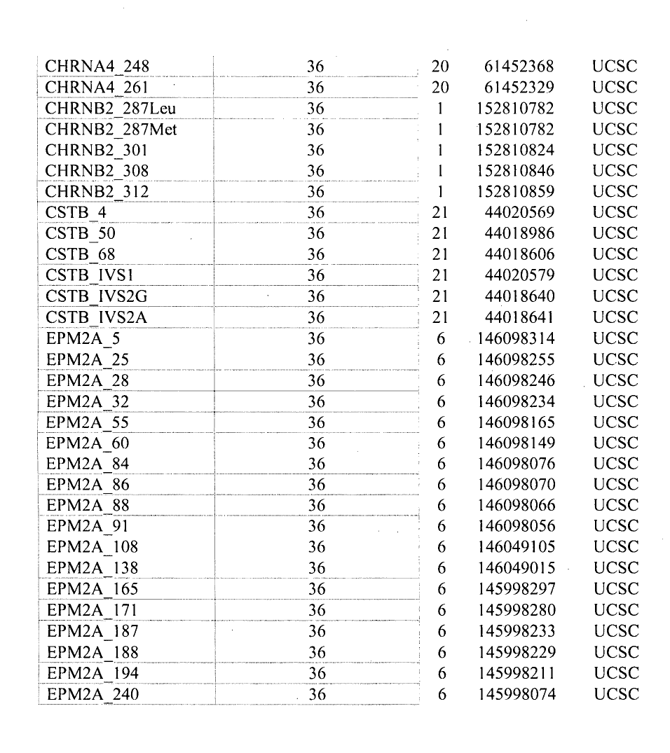

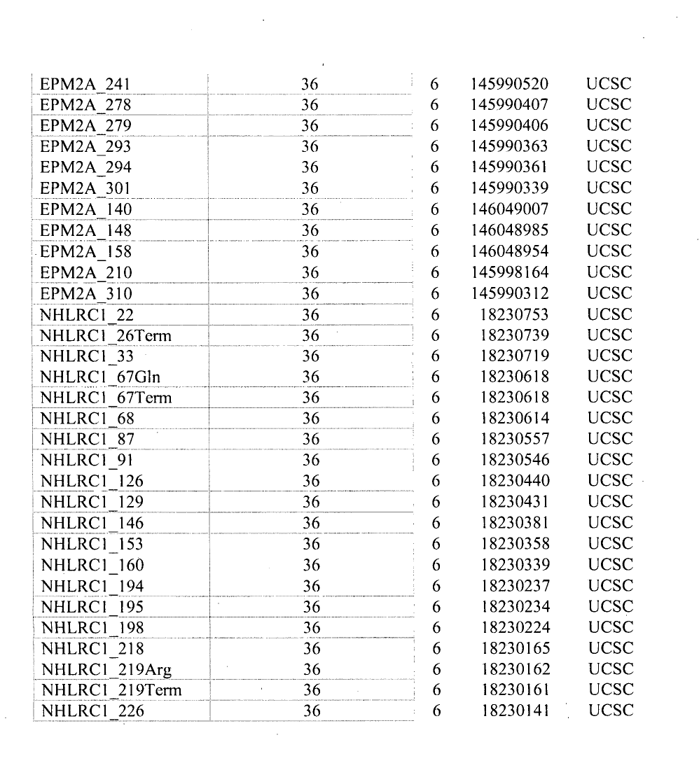

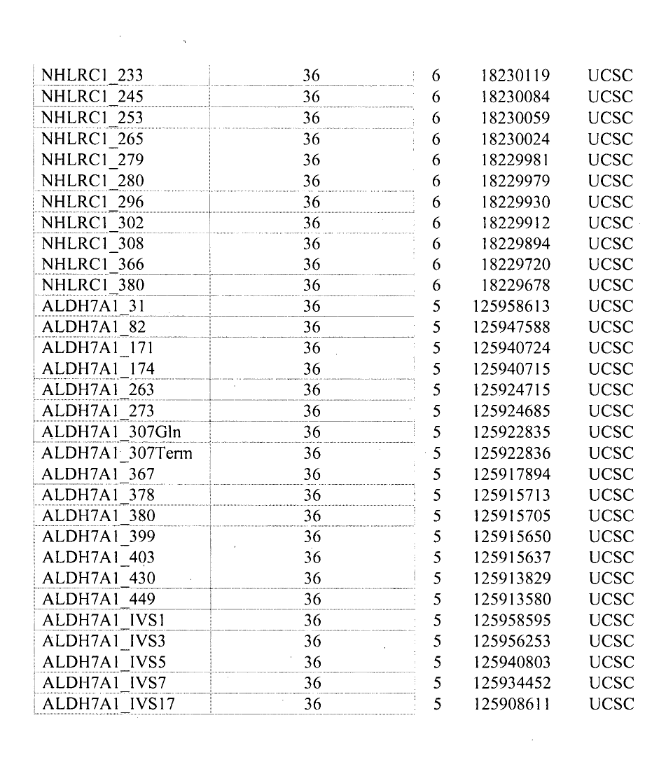

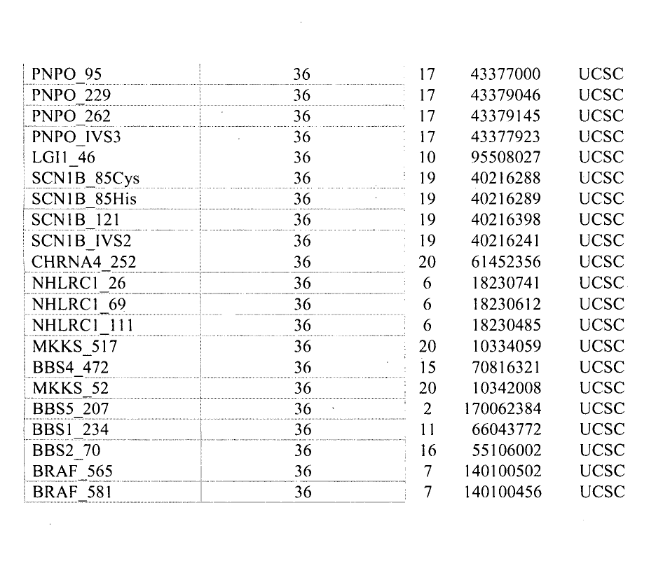

Referring to FIG. 2 there is shown a high-level functional flow diagram of the online medical data processing system. Step 202 involves the user accessing the program via the computer network. Step 204 involves authenticating the user attempting to access the remote system. Step 206 involves displaying a menu to the user. Step 208 involves providing access to the panels of diseases. Step 210 involves inputting the signs and symptoms of the patient. Step 212 involves displaying a match of the inputted signs and symptoms to the signs and symptoms of diseases displayed in the panels. The following steps optionally may be undertaken at a subsequent time, following genetic testing. Step 214 involves reentry into the program via steps 202 to 206. Step 216 involves inputting data obtained from genetic testing of a patient sample against genetic probes for the diseases of the chosen panel. Step 218 involves creating a secured file of the genetic match or non-match of the patient sample to the disease(s) of the panel that can be printed by the user.

### DEFINITIONS

Unless defined otherwise, technical and scientific terms used herein have the same meaning as commonly understood by one of ordinary skill in the art to which this invention belongs. One skilled in the art will recognize many methods and materials similar or equivalent to those described herein, which can be used in the practice of the present invention. Indeed, the present invention is in no way limited to the methods and materials described. For purposes of the present invention, the following terms are defined below.

“Array” or “microarray” means a predetermined spatial arrangement of capture nucleotide sequences present on a surface of a solid support. The capture nucleotide sequences can be directly attached to the surface, or can be attached to a solid support that is associated with the surface.

An array can include any number of addressable locations, e.g., 1 to about 100, 100 to about 1000, or 1000 or more. In addition, the density of the addressable locations on the array can be varied.

“Surface” when used herein refers to the underlying core material of the arrays of the invention. Typically the surface is a solid support and has a rigid or semi-rigid surface. In one embodiment the surface of the support is flat. In other embodiments the surface can include physical features, such as wells, trenches and raised, shaped, or sunken regions. The capture nucleotide sequences that form the array can be attached directly to the surface, or can be attached to a solid support that is itself associated with, such as attached to or contained by, the surface.

Depending upon the array used in the present invention, the methods of detecting hybridization between a capture nucleotide sequence and a target nucleic acid sequence can vary. For example, target nucleotide sequences can be labeled before application to the microarray. Through hybridization of the target sequence to the capture probe of complementary sequence on the array, the label is bound to the array at a specific location, revealing its identity.

An “OPA” is the acronym for Oligo Pool All, referring to, in this particular array technology, the solution containing all of the assay-specific primers.

“Assay-specific primers” refers to small DNA sequences (oligonuclotides) specific for hybridization with the region that flanks the mutation to be detected. Each set of allele specific primers includes two upstream primers, one for each possible allele (Allele-Specific Oligos—ASO) and one downstream primer that is locus specific (Locus-Specific Oligos—LSO)

“Signs or symptoms of a disease” refers to groups of objective (signs) or subjective (symptoms) characteristics that can point to a diagnosis of a disease. Signs are physical manifestations that can be felt, heard, measured and observed by the doctor. Symptoms are what the patient experiences about the illness, disease or injury.

An “allele” is defined in some embodiments as a sequence or a member of a pair or series of genes or sequences that occupy a specific position, or locus, on a specific chromosome or segment of nucleic acid found within a cell. The term commonly refers to any number of possible nucleotide sequences containing mutations that occur within a particular gene within the genome of an organism. An allele can contain, in comparison to the sequence of the same genetic locus from another chromosome of the same number, any type of mutation or sequence difference, including a deletion mutation, an insertion mutation, a transitional mutation, duplication or inversion mutation, or any combination of the above mutations. In some embodiments, an “allele” can refer to a particular variant of mitochondrial DNA or nucleic acid.

“Point mutations” or single base substitution refers to a genetic variation that causes the replacement of a single base nucleotide with another nucleotide of the genetic material.

“SNP” Single Nucleotide Polymorphism is a DNA sequence variation occurring when a single nucleotide—A, T, C, or G—in the genome differs between members of a species or between paired chromosomes in an individual.

“Umbilical cord blood” refers to the blood from a newborn baby that is returned to the neonatal circulation if the umbilical cord is not prematurely clamped.

“Amniotic fluid” is the nourishing and protecting liquid contained by the amnion of a pregnant woman. It is used to obtain DNA from the fetus to perform prenatal diagnosis tests, including genetic tests.

“Chorionic Villi” are villi that sprout from the chorion in order to give a maximum area of contact with the maternal blood. The genetic material in chorionic villus cells is the same as that in the fetus' cells. The collection of a sample of the chorionic villus cells is taken by a biopsy.

The term “sample”, as used herein, is defined as an amount of biological material which is obtained directly or indirectly from an individual. The biological material can be a fluid including, for example, amniotic fluid, an amount of blood or some portion of a blood sample; it can also be a sample of tissue, cells, or other.

The sample can be an amount of biological material in its original state as it was upon being obtained from the source individual or the biological source it originated from, or it can be processed, prepared or otherwise manipulated before being brought to the assay processes, methods, techniques or kits described herein.

When defining the source of a sample, for example a sample from a child or a sample from a fetus, the sample in question can be directly or indirectly obtained from the child or the fetus. A sample can be taken directly from an individual for the expressed purposes of analysis as set forth in embodiments of the present invention or it can be obtained from a source of biological material taken from an individual or isolated from a sample taken from an individual at another time. A sample can be a subset of biological material isolated from another sample.

In some particular embodiments, a “blood sample” refers to a sample of blood obtained from an individual for whom a diagnosis is sought, or some component or derivative of that sample. In other embodiments, “blood sample” can refer to cells contained in the blood that are not originating from the individual from whom the sample of blood was taken. These embodiments can include a sample having blood cells originating from a fetus that can be isolated from a blood sample taken from the individual carrying said fetus, either during or after pregnancy.

The term “genetic”, as used herein in association with a pathology, commonly refers to phenotypes that are inheritable. It can also be referring a ‘de novo’ case caused by a mutation new in the family.

The term “gDNA” (genomic DNA), as used herein, refers to the full complement of DNA contained in the genome of a cell or organism obtained from mammalian or other higher order species, which includes both intron and exon sequence (coding sequence), as well as non-coding regulatory sequences such as promoter and enhancer sequences.

### EXAMPLES

The following examples disclose various applications of the present invention and are not intended to be limiting. These examples can be used in conjunction with conventional pediatric diagnosis methods or as a primary testing tool.

### Example 1

### Selection of Groups for Diagnosis

Selection of groups based on shared signs and symptoms. The following panels represent genetic diseases that share at least the following signs and symptoms:

1. Genetic diseases with obesity with mental retardation;

2. Genetic diseases with post-natal short stature, broad or webbed neck, heart defects including cardiomiopathy, psychomotor developmental delay, macrocephaly;

3. Genetic diseases with “special” behaviour and microcephaly;

4. Genetic diseases with craniosynostosis;

5. Genetic diseases with chondrodysplasia;

6. Genetic diseases with bone dysplasias;

7. Genetic metabolic diseases;

8. Genetic diseases with neurological disorders;

9. Genetic diseases with syndromic and non-syndromic hearing loss;

10. Genetic diseases with “special” behaviour—Autism;

11. Genetic diseases with retinopathy;

12. Genetic diseases with seizures (epilepsy)

### Example 2

### Selection of Genes and Mutations

The genes contemplated in the array of the present invention are selected from reference sources, including mutation databases (i.e., National Center for Biotechnology Information (NCBI), Human Gene Mutation Database (HGMD), Online Mendelian Inheritance in Man (OMIM)). See Table 1: Genes and diseases, which provides a list of genes and diseases included in the different panels of signs and symptoms. For each gene is listed the disease and the most relevant genetic characteristics.

The criteria for selecting genes and mutations were based upon: 1) Technical requirements, only point mutations were included; 2) all the mutations directly causing the disease; 3) the most frequent and 4) those described at least in more than one case (private and familial mutations were excluded). Mutations with an ethnic distribution were also included, to be used only in the respective groups. See Tables 2 and 3. Table 2 —Genes and number of mutations selected. Table 3—Genes and description of the mutations selected.

### Example 3

### Creation of the Genotyping Panels

The micro array of the present invention is not limited to any particular branded array or to any particular methods of constructing the array. The examples provided herein are meant to illustrate considerations in the production and use of the array. As one example of a micro array and its use, the following describes the GoldenGate Genotyping Assay. The creation and ordering of high-quality custom genotyping panels for GoldenGate Genotyping assays used guidelines from Illumina, Inc. See Table 4—Panels for design of the specific primers (OPAs).

The information about each exact point mutation is provided by one of two models.

Model 1—If the mutation has an RS code from the SNP database (dbSNP), that code is inscribed in a file list provided for that purpose (RSList file type).

RSList file example (See Table 4)

| | |
|---|---|
| RS list | rs10200182, diploid, Homo sapiens |
| RS list | rs1064651, diploid, Homo sapiens |
| RS list | rs12386601, diploid, Homo sapiens |

Model 2—If there is no RS code, as is the case for the majority of the point mutations included in this approach, the DNA sequences must be obtained from a reference database (e.g., the UCSC (University of California Santa Cruz) genome browser) and inserted in a file with the Sequencelist format, with some specific conditions: “The SNP_Name field is used to name sequences for easy identification. SNP_Name entries contained in this file must not begin with “rs” because that prefix designates rs ID names in the Illumina database and will trigger a database search. To specify a SNP, brackets are placed around a polymorphic locus in the submitted sequence. The two alleles are separated with a forward slash (e.g., . . . [A/C] . . . ). A minimum of 50 bp of sequence on either side of the SNP is required, but 60 bp flanking sequence is preferred.

The fields to include are SNPname, Sequence, Genome_Build_Version, Chr, Coordinate, Source, dbSNP_Version, Ploidy, Species, Custumer_Strand and are sent in a comma-separated values (*.csv) format. (See Table 4).

To improve the efficiency of the design, all the sequences should than be screened with the Assay Design Tool (ADT) from Illumina, Inc. This system evaluates the sequences submitted and produces a SNP score that indicates the likelihood of success for each sequence.

This SNP score file is used to create a final order file or as an input file format for subsequent ADT submission. SNPScore files provide an important set of informative metrics for each scored SNP requested in the preliminary input file. These metrics should be used to preferentially select the assays that are most likely to be successfully designed for the final product.

After ADT analysis and custom selection of SNPs that meet the research criteria, a final SNPScore file must be created to place an order for production of the customized OPA.

### Example 4

### Detection of Genetic Alterations

Samples from different biological sources (i.e., peripheral venous blood, umbilical cord blood, amniotic fluid) are extracted according to an adequate method, for example, the automatic procedure made by Roche Applied Science: the Magna Pure Compact Nucleic Acid Isolation Kit I. Briefly, for venous peripheral and umbilical cord blood the initial volume of the sample is 400 ul, and the elution volume is 200 ul. All the other steps are done in the automatic system according to the suppliers's instructions.

After verifying the integrity and the concentration of the DNA extracted, the protocol for the detection of the DNA point mutations involves a sequence of steps, according to the supplier's instructions.

Instructions for Assays according to the Illumina Assay:

1) Single-Use DNA (SUD) Plate—This process activates sufficient DNA of each individual sample to be used once in the GoldenGate Genotyping Assay: 1. Normalize DNA samples to 50 ng/μl with 10 mM Tris-HCl pH 8.0, 1 mM EDTA. 2. Add 5 μl MS 1 reagent to each well of the SUD plate. 3. Transfer 5 μl normalized DNA sample to each well of the SUD plate. 4. Seal the SUD plate. 5. Pulse centrifuge the SUD plate to 250 xg. 6. Vortex at 2300 rpm for 20 seconds. 7. Pulse centrifuge to 250 xg. 8. Incubate the SUD plate at 95° C. for exactly 30 minutes. 9. Pulse centrifuge the plate to 250 xg. 10. Precipitate SUD Plate.

2) Precipitate SUD Plate—In this process, PS 1 and 2-propanol are added to the SUD plate to precipitate the DNA and remove excess DNA activation reagent MS 1. Steps: 1. Remove the heat seal from the heated SUD plate. 2. Add 5 μl PS 1 reagent to each well of the SUD plate. 3. Seal the SUD plate. 4. Pulse centrifuge the plate to 250 xg. 5. Vortex at 2300 rpm for 20 seconds or until the solution is uniformly blue. 6. Remove the film and add 15 μl 2-propanol to each well of the SUD plate. 7. Seal the SUD plate. 8. Vortex at 1600 rpm for 20 seconds or until the solution is uniformly blue. 9. Centrifuge the sealed SUD plate to 3000 xg for 20 minutes. 10. Perform the next step immediately to avoid dislodging the activated DNA pellets. 11. Decant the supernatant. 12. Invert the SUD plate on an absorbent pad and centrifuge to 8 xg for 1 minute. 13. Dry at room temperature for 15 minutes.

3) Resuspend SUD Plate—In this process, RS1 is added to the SUD plate to resuspend the DNA. Steps: 1. Add 10 μl RS1 reagent to each well of the SUD plate. 2. Seal the SUD plate. 3. Pulse centrifuge to 250 xg. 4. Vortex at 2300 rpm for 1 minute or until the blue pellet is completely dissolved. SUD sample plate activation is complete.

4) Allele-Specific Extension (ASE) Plate. This process combines the biotinylated gDNAs from the SUD plate with query oligos, hybridization reagents, and paramagnetic particles in an Allele Specific Extension (ASE) plate. The ASE plate is placed in a heat block and the query oligos for each target sequence of interest are allowed to anneal to the biotinylated gDNA samples. The gDNA is simultaneously captured by paramagnetic particles. The resulting ASE plate is ready for the extension and ligation of the hybridized oligos on the bound gDNAs. Extension and Ligation. This process is designed for one plate, using the SUD plate as input. Steps: 1. Pulse centrifuge the SUD plate to 250 xg. 2. Add 10 μl OPA reagent to each well of the ASE plate. 3. Add 30 μl OB1 reagent to each well of the ASE plate. 4. Transfer 10 μl of biotinylated sample from each well of the SUD plate (where 10 μl is the entire volume) to the corresponding well of the ASE plate. 5. Heat-seal the ASE plate. 6. Pulse centrifuge the ASE plate to 250 xg. 7. Vortex the ASE plate at 1600 rpm for 1 minute or until all beads are completely resuspended. 8. Allow the ASE plate to cool from 70° C. to 30° C. for about 2 hours. 10.

5) Add Master Mix for Extension & Ligation (MEL). In this process, AM1 and UB1 reagents are added to the ASE plate to wash away non-specifically hybridized and excess oligos. An enzymatic extension and ligation master mix (MEL) is added to each DNA sample. The extension and ligation reaction occurs at 45° C. Steps: 1. Centrifuge the ASE plate to 250 xg. 2. Place the ASE plate on a raised-bar magnetic plate for approximately 2 minutes, or until the beads are completely captured. 3. Remove and discard all the liquid (50 μl) from the wells, leaving the beads. 4. Add 50 μl AM1 to each well of the ASE plate. 5. Seal the ASE plate. 6. Vortex the ASE plate at 1600 rpm for 20 seconds or until all beads are resuspended. 7. Place the ASE plate on a raised-bar magnetic plate for approximately 2 minutes, or until the beads are completely captured. 8. Remove all AM 1 reagent from each well, leaving the beads. 9. Repeat steps 4 through 8 once. 10. Add 50 μl UB1 to each well of the ASE plate. 11. Place the ASE plate onto a raised-bar magnetic plate for approximately 2 minutes, or until the beads are completely captured. 12. Remove all UB1 reagent from each well, leaving the beads. 13. Repeat steps 10 through 12 once. 14. Add 37 μl MEL to each well of the ASE plate. 15. Seal the plate. 16. Vortex the plate at 1600-1700 rpm for 1 minute or until the beads are resuspended. 17. Incubate the ASE plate at 45° C. for exactly 15 minutes.

6) Make PCR Plate—This process adds DNA Polymerase and optional Uracil DNA Glycosylase (UDG) to the master mix for PCR (MMP reagent) and creates a 96-well plate for PCR. Steps: 1. Add 64 μl DNA Polymerase to the MMP tube. 2. [Optional] Add 50 μl Uracil DNA Glycosylase to the MMP tube. 3. Mix and then pour the contents into a reagent reservoir. 4. Add 30 μl of the mixture into each well of a PCR plate. 5. Seal the PCR plate. 6. Pulse centrifuge to 250 xg, and then protect the PCR plate from light.

7) Inoculate PCR Plate—This process uses the template formed in the extension and ligation process in a PCR reaction. This PCR reaction uses three universal primers (MMP reagent): two are labeled with fluorescent dyes and the third is biotinylated. The biotinylated primer allows capture of the PCR product and elution of the strand containing the fluorescent signal. The eluted samples are transferred from the ASE plate to the PCR plate. Steps: 1. Place the ASE plate on a raised-bar magnetic plate for approximately 2 minutes, or until the beads are completely captured. 2. Remove and discard the supernatant (˜50 μl) from all wells of the ASE plate. Leave the beads in the wells. 3. Add 50 μl UB1 to each well of the ASE plate. 4. Leave the ASE plate on the raised-bar magnetic plate for approximately 2 minutes until the beads are completely captured. 5. Remove and discard the supernatant (˜50 μl) from all wells of the ASE plate, leaving the beads. 6. Remove the plate from the magnet. 7. Add 35 μl IP1 to each column of the ASE plate. 8. Seal the plate. 9. Vortex at 1800 rpm for 1 minute until all the beads are resuspended. 10. Heat at 95° C. for 1 minute. 11. Place the ASE plate onto a raised-bar magnetic plate for 2 minutes until the beads have been completely captured. 12. Transfer 30 μl supernatant from each well in the first column of the ASE plate to the first column of the PCR plate and repeat for each column of the ASE plate. 13. Seal the PCR plate. 14. Transfer the PCR plate to a thermocycler.

8) Thermal Cycle PCR Plate—This process thermal cycles the PCR plate to fluorescently label and amplify the templates generated in the pre-PCR process. Steps: 1. Place the sealed plate into a thermocycler and run the thermocycler program.

### Thermocycler Program

| Temperature | Time | | |
|---|---|---|---|
| 37° C. | 10 | minutes | |
| 95° C. | 3 | minutes | |
| 95° C. | 35 | seconds | 34X |
| 56° C. | 35 | seconds | |
| 72° C. | 2 | minutes | |
| 72° C. | 10 | minutes | |
| 4° C. | 5 | minutes | |

9) Bind PCR Products. In this process, MPB reagent is added to the PCR plate and the solution is transferred to a filter plate. The filter plate is incubated at room temperature to bind the biotinylated strand to paramagnetic particles, thus immobilizing the double-stranded PCR products. Steps: 1. Pulse centrifuge the PCR plate to 250 xg. 2. Add 20 μl resuspended MPB into each well of the PCR plate. 3. Mix the beads with the PCR product. 4. Transfer the mixed solution into the first column of the filter plate and repeat step 4 for each column of the PCR plate. 5. Cover the filter plate and store at room temperature, protected from light, for 60 minutes.

10) Make Intermediate Plate for Bead Plate—In this process, the PCR product is washed in the filter plate with UB2 and NaOH. The single-stranded, fluor-labeled material is then eluted into an INT plate containing MH2 reagent. Steps: 1. Use a 96-well plate as a waste plate. 2. Centrifuge the filter plate containing the bound PCR products at 1000 xg for 5 minutes at 25° C. 3. Add 50 μl UB2 to each well of the filter plate. 4. Replace the lid. 5. Centrifuge to 1000 xg for 5 minutes at 25° C. 6. Add 30 μl MH2 to each well of the INT plate. 7. Orient the INT plate so that well A1 of the filter plate matches well A1 of the INT plate and dispense 30 μl 0.1 N NaOH to all wells of the filter plate. 8. Replace the filter plate lid. 9. Centrifuge immediately at 1000 xg for 5 minutes at 25° C. 10. Gently mix the contents of the INT plate and cover the INT plate.

11) Hybridizing Bead Plate—In this process the single-stranded, fluor-labeled material is hybridized with the beads contained in the Bead Plate (BP) and are ready for hybridization at 45° C.

a) Add Neutralized MH2 to INT BP—Steps: 1. Transfer 3 ml MH2 into a 15 ml conical tube. 2. Transfer 3 ml 0.1 N NaOH to the 15 ml tube. 3. Vortex to mix. 4. Pour the mixture into a sterile reservoir. 5. Add 50 μl of neutralized MH2 to each of the INT plate wells that contain sample.

b) Hybridize. Steps: 1. Take a BP stored at 4° C. and pulse centrifuge to 250 xg. 2. Remove the cap mat from the Bead Plate. 3. Resuspend each column of sample in the INT plate and transfer 100 μl of each assay product from the INT plate into the corresponding well of the Bead Plate. 4. Place the cap mat back on the Bead Plate and place the Bead Plate, containing samples, into a vortex incubator. 5. Incubate for 3 hours at 45° C. vortexing at 850 rpm.

12) Wash Bead Plate—In this process, the Bead Plate is removed from the vortex incubator and washed two times with the VW 1 reagent. 1. Stop the vortex incubator and remove the bead plate. 2. Pulse centrifuge the plate to 250 xg. 3. Remove the cap mat. 4. Add 200 μl VW1 buffer to each well. Make sure to agitate the bead pellet. 5. Wait 2 minutes for the beads to collect in the bottom of the well. 6. Aspirate the supernatant. 7. Repeat steps 4 through 6 once.

13) Scan Bead Plate—A Reader that uses lasers to excite the Cy3 and Cy5 fluors of the single-stranded PCR products bound to the beads was used. Light emissions from these fluors were recorded in a data file. Fluorescence data were analyzed to derive genotyping results.

### Example 5

### Validation Study

DNAs of patients with different mutations previously identified by sequencing were retested in order to confirm the accuracy of the method. Samples were also included in duplicates to evaluate its reproducibility.

The validation procedures were done according to the usual guidelines and intended to determine the analytic validity (sensitivity, specificity, reproducibility) of the technique.

Assays of 96 experiments were organized, and included samples with normal results and samples with known mutations, which were previously detected and characterized by sequencing; the samples were in duplicate. These samples were assayed with the custom OPA for the specific sequences to detect the mutations included in each panel.

Another assay with an Illumina's DNA test panel—a SNP-based tool for pre-screening DNA samples, with 360 optimized sequences already screened and validated, was done for assay performance.

The results were evaluated for the indicators included in the software that give information for accuracy, reproducibility and data quality, quantified by different parameters such as—call rate, sample success rate and locus success rate. The controls for the different steps of the assay—allele-specific extension, to the PCR uniformity, to the extension gap, to the first hybridization, to the second hybridization and to contamination detection—were also evaluated in each run.

With these tools it was verified that the method is robust and consistent, appropriate to the inventive method, and responding to the clinical need.

All patients studied signed an informed consent.

### Example 6

### Clinical Application

The panels of study contemplated in the present invention are for use by medical specialists in several areas, as well as medical geneticists, in the course of the determination of the genetic cause of a specific clinical profile. The orientation of the adequate panel to be applied is determined by the specific set of signs or symptoms, as organized in the panels described herein. For example, for a newborn presenting post-natal short stature, heart defect and development delay, the doctor would request panel #2 Post-natal short stature, broad or webbed neck, heart defects defects including cardiomyopathy, psychomotor developmental delay, macrocephaly. The microarray that is used for testing is designed with capture sequences that will assay for the point mutations known for the diseases designated in this panel. With this test it is possible to confirm or exclude the existence of 157 different mutations associated with 4 different diseases, in one single-test, in 3 days.

Using the example mentioned above, and testing the newborn with the methods available in the prior art, which include the analysis of the 8 genes involved, done by sequential analysis (one at time), and by gene sequencing, in a total of 106 exons or 108 sequencing reactions, would take about 18-24 months in a large capacity laboratory.

The possibility of studying a group or panel of multiple genes associated with a specific clinical profile (not a syndrome alone but a group of features common to several syndromes), represents a unique step in pediatric and prenatal care, by reducing not only the costs of sequential genetic testing, but also reducing the time needed to complete genetic evaluation, and therefore making this process of crucial clinical utility.

The present inventive method of organizing by signs and symptoms overcomes the consequences of long and expensive testing currently available, and will benefit the routine healthcare of these patients by reducing the risk of inappropriate therapeutic decisions, allowing a faster decision-make process in important clinical issues, and making possible prenatal diagnosis for the disease for pregnant relatives.

The organization by signs and symptoms makes it possible for physicians, not skilled in genetic differential diagnosis, to request a test and obtain valuable and consistent information about their patients in one single-test, in a fast and cost-effective way.

### Example 7

### Reporting the Results

The results are reported to the doctor, in the form of a letter, following the most relevant international guidelines (ACMG, EMQN). The mandatory fields on this letter are: sample identification (laboratory code or reference number), referral doctors' identification, type of sample, date of collection, patient's identification, test requested, reason for testing, method, limitations of the assay, result, interpretation, date of report and medical geneticist signature.

The method description enumerates the panel's name, list of diseases, genes and mutations analysed and respective detection rates.

Limitations of the assay are referred as the number or rate of cases of affected individuals, for the studied diseases, detected by the mentioned method.

Results are listed as “negative”, if no mutation is identified, or “positive”, if a mutation is found. Description of the mutation, and reference of the gene mutated, are included in the result (e.g., Positive for mutation Lys117Arg on gene HRAS).

Interpretation of result consists of a statement interpreting the data (interpretation should be understandable to a non-geneticist professional, e.g., The mutation detected is associated with Costello Syndrome) and also clinical implications, follow-up test recommendations, and genetic counseling indications.

Positive results are referred to genetic counseling in order to explain to the patient and family the results, risks for future gestations and for relatives, and to discuss prognosis and/or therapeutic interventions.

Negative results are interpreted taking into account the documented limitations of the method, and are referred, whenever applicable, for testing with conventional methods (as DNA sequencing) to search for familial, private, or very rare mutations.

All the reports ensure the confidentiality and privacy of the contained clinical information. Except in the case of minors and their parents or legal guardians, a patient's test results or other medical information are not disclosed to the patient's family members without appropriate written authorization from the patient.

The examples described are intended to assist in the understanding of the invention. Thus, those skilled in the art will appreciate that the present invention can provide a set of multiple genetic disease diagnostic panels based on shared signs and symptoms, using one single-test sampling, using micro-array technology. The genes, capture nucleotide sequences and arrays described herein are representative of certain embodiments and are exemplary. They are not intended as limitations on the scope of the invention.

1. A method of collecting data for use in determining a cause of diseases or disorders with genetic background, comprising:
a. organizing diseases or disorders with genetic background into panels of diseases or disorders, wherein a panel is a group of diseases or disorders having shared signs or symptoms;
b. matching a patient's signs and symptoms to the signs and symptoms of a first panel; and
c. testing a sample derived from said patient's genetic material by conducting hybridization to a micro array that comprises nucleotide capture sequences capable of hybridizing to complementary nucleic acid target sequences from one or more genes associated with the diseases of said first panel, wherein said complementary nucleic acid target sequences each contain a known point mutation associated with the diseases of said first panel; and
d. detecting hybridizations or the absence of hybridization of the sample to the nucleotide capture sequences of the microarray, wherein detection of a hybridization to a particular capture sequence provides data indicating that the patient has the genetic point mutation capturable by the particular capture sequence and the absence of hybridization provides data indicating that the patient does not have a genetic point mutation associated with one or more diseases of said panel.

2. The method of claim 1, wherein the panels comprise:
a. genetic diseases with obesity with mental retardation;
b. genetic diseases with post-natal short stature, broad or webbed neck, heart defects including cardiomyopathy, psychomotor developmental delay, macrocephaly;
c. genetic diseases with “special” behaviour and microcephaly;
d. genetic diseases with craniosynostosis;
e. genetic diseases with chondrodysplasia;
f. genetic diseases with bone dysplasias;
g. genetic metabolic diseases;
h. genetic diseases with neurological disorders;
i. genetic diseases with syndromic and non-syndromic hearing loss;
j. genetic diseases with “special” behaviour—autism;
k. genetic diseases with retinopathy; and
l. genetic diseases with seizures (epilepsy).

3. The method of claim 2, wherein for each of the panels (a) through (l) the diseases associated with the panels comprise:
a. Bardet-Biedl syndrome (BBS) and Cohen syndrome;
b. Costello syndrome, LEOPARD syndrome, Noonan syndrome, and cardiofaciocutaneous syndrome;
c. Rett syndrome, Cornelia de Lange syndrome, and Smith-Magenis syndrome;
d. Muenke syndrome, Apert syndrome, Crouzon syndrome, Jackson-Weiss syndrome, Pfeiffer syndrome, Saethre-Chotzen syndrome, craniosynostosis with elbow joint contracture, and Carpenter syndrome;
e. Zellweger syndrome, rhizomelic chondrodysplasia punctata type 1, recessive chondrodysplasia punctata 1 X-linked, CHILD syndrome, Conradi-Hünermann syndrome X-linked dominant, and autosomal dominant multiple epiphyseal dysplasia;
f. achondrogenesis II-hypochondrogenesis, achondrogenesis type 1B, achondroplasia, thanatophoric dysplasia, osteogenesis imperfecta autosomal recessive and campomelic dysplasia;
g. Alkaptonuria, Alpha-mannosidosis, Biotinidase deficiency, Carnitine palmitoyltransferase II deficiency, Medium-chain acyl-coenzyme A dehydrogenase, LCHAD, Tyrosinemia, Galactosemia (including Duarte variant), Gaucher disease, Glycogen storage disease type I, Glycogen storage Type II (Pompe disease), Glycogen storage Type V (McArdle disease), Hexosaminidase A deficiency (Tay-Sachs disease), Krabbe disease (late onset), Wilson disease, Metachromatic leukodystrophy, Jansky-Bielschovsky Disease, Neuronal ceroid lipofuscinoses, and Niemann-Pick disease type C;
h. hyperkalaemic periodic paralysis, paramyotonia congenita, and spastic paralysis infantile-onset;
i. hearing loss non-syndromic autosomal dominant, hearing loss non-syndromic autosomal recessive, branchiootorenal syndrome, Pendred syndrome recessive nonsyndromic and syndromic, Usher syndrome Type I, Waardenburg syndrome, and X-linked mixed deafness associated with gene POU3F4;
j. autism;
k. Leber congenital amaurosis, retinitis pigmentosa autosomal dominant, retinitis pigmentosa autosomal recessive, and retinitis pigmentosa X linked; and
l. neonatal-infantile seizures, benign neonatal included with myokymia epilepsy, different degrees of febrile seizures, epilepsy with nocturnal wandering and ictal fear, nocturnal frontal lobe epilepsy, progressive myoclonus epilepsy, myoclonic epilepsy of Lafora, pyridoxine-dependent epilepsy, neonatal epileptic encephalopathy, partial epilepsy with auditory features, generalised epilepsy with febrile seizures, Rett syndrome variant with infantile spasms, and encephalopathy with early epilepsy.

4. The method of claim 3, wherein the genetic diseases that are organized into each of the groups (a) through (l) are associated with genes comprising:
a. Bardet-Biedl syndrome (BBS) associated with genes BBS1, BBS10, BBS12, BBS2, BBS4, BBS5, BBS9, TRIM32, MKKS/BBS6, ARL6/BBS3 and TTC8/BBS8 and Cohen syndrome, associated with gene VPS13B;
b. Costello syndrome associated with gene HRAS, LEOPARD syndrome associated with gene PTPN11, Noonan syndrome associated with genes KRAS, PTPN11, RAF1, and SOS1, and Cardiofaciocutaneous syndrome associated with genes MAP2K1, MAP2K2, KRAS and BRAF;
c. Rett syndrome associated with gene MECP2, Cornelia de Lange associated with gene NIPBL, and Smith-Magenis syndrome associated with gene RAI1;
d. Muenke syndrome associated with gene FGFR3, Apert syndrome associated with gene FGFR2, Crouzon syndrome associated with gene FGFR2; Jackson-Weiss syndrome associated with gene FGFR2, Pfeiffer syndrome associated with gene FGFR1, Saethre-Chotzen syndrome associated with gene FGFR2, Craniosynostosis with elbow joint contracture associated with gene FGFR2, and Carpenter syndrome associated with gene RAB23;
e. Zellweger syndrome associated with genes PEX1 and PEX26, Rhizomelic Chondrodysplasia Punctata Type 1 associated with gene PEX7, Recessive Chondrodysplasia Punctata 1, X-Linked associated with gene ARSE, CHILD syndrome associated with gene EPB, Conradi-Hünermann syndrome, X-linked dominant, associated with gene EPB, Autosomal dominant multiple epiphyseal dysplasia, associated with genes COMP and MATN3;
f. Achondrogenesis II-hypochondrogenesis associated with gene COL2A1, Achondrogenesis type 1B associated with gene SLC26A2, Achondroplasia associated with gene FGFR3, Thanatophoric dysplasia, associated with gene FGFR3, Osteogenesis imperfecta, autosomal recessive associated with genes CRTAP and LEPRE1, and Campomelic dysplasia associated with gene SOX9;
g. Alkaptonuria associated with gene HGD, Alpha-mannosidosis associated with gene MAN2B1, Biotinidase deficiency associated with gene BTD, Carnitine palmitoyltransferase II deficiency associated with gene CPT2, Medium-chain acyl-coenzyme A dehydrogenase associated with gene ACADM, LCHAD associated with gene HADHA, Tyrosinemia associated with gene FAH, Galactosemia (including Duarte variant) associated with gene GALT, Gaucher disease associated with gene GBA, Glycogen storage disease type I associated with genes G6PC and SLC37A4, Glycogen storage Type II (Pompe disease) associated with gene GAA, Glycogen storage Type V (McArdle disease) associated with gene PYGM, Hexosaminidase A deficiency (Tay-Sachs disease) associated with gene HEXA, Krabbe disease (late onset) associated with gene GALC, Wilson disease associated with gene ATP7B, Metachromatic leukodystrophy associated with gene ARSA, Jansky-Bielschovsky Disease associated with gene CLN2, Neuronal ceroid lipofuscinoses associated with genes CLN5, CLN8 and NPC1, Niemann-Pick disease type C associated with genes NPC1 and NPC2;
h. Hyperkalaemic periodic paralysis associated with genes SCN4A and CACNA1 S, Paramyotonia congenita associated with gene SCN4A, Spastic paralysis, infantile-onset associated with ALS2;
i. Hearing loss, non-syndromic, autosomal dominant associated with genes ACTG1, COCH, CRYM, DFNA5, DIAPH1, GJB2, GJB3, GJB6, KCNQ4, MYH14, MYO1A, MYO7A, TECTA and WFS1, Hearing loss, non-syndromic, autosomal recessive associated with genes GJB2, SLC26A4, OTOF, CDH23, GJB3, GJA1, MYO7A, OTOA, TECTA and TMC1, Branchiootorenal syndrome associated with genes EYA1, SIX1 and SIX5, Pendred syndrome, recessive, nonsyndromic associated with gene SLC26A5 and syndromic associated with gene SLC26A4, Usher syndrome Type I associated with genes MYO7A, USH1C, USH1G, CDH23 and PCHD15, Waardenburg syndrome associated with gene PAX3, and X-linked mixed deafness associated with gene POU3F4;
j. Autism associated with genes NLGN4, PTEN, NLG3, MECP2 and SCN2A;
k. Leber congenital amaurosis associated with genes CRB1, AIPL1, GUCY2D, RPE65, CEP290, RPGRIP1, RDH12 and CRX, Retinitis pigmentosa autosomal dominant associated with genes RP1, ROH, IMPDH1, PRPF31 and NR2E3, Retinitis pigmentosa autossomal recessive associated with genes RPE65, ABCA4, USH2A, PDE6B and PDE6A, and Retinitis pigmentosa X linked associated with genes RPGR and RP2;
l. Neonatal-infantile seizures associated with gene SCN2A, Benign neonatal included with myokymia epilepsy associated with gene KCNQ2, Different degrees of febrile seizures associated with gene GABRG2, Epilepsy with nocturnal wandering and ictal fear associated with gene CHRNA2, Nocturnal frontal lobe epilepsy associated with genes CHRNA4 and CHRNB2, Progressive myoclonus epilepsy associated with genes CSTB and EPM2A, Myoclonic epilepsy of Lafora associated with gene NHLRC1, Pyridoxine-dependent epilepsy associated with gene ALDH7A1, Neonatal epileptic encephalopathy associated with gene PNPO, Partial epilepsy with auditory features associated with gene LGI1, Generalised epilepsy with febrile seizures associated with gene SCN1B, Rett syndrome variant with infantile spasms associated with gene CDKL5, and Encephalopathy with early epilepsy associated with gene CDKL5.

5. A method of organizing data for use in determining a cause of genetic diseases or disorders comprising: identifying genes associated with genetic diseases or disorders, identifying point mutations within said genes, and programming a computer to categorize for each genetic disease:
a. the mutations known to directly cause the disease,
b. the most frequent mutations of the disease, and
c. the mutations described in more than one patient history.

6. The method of claim 5, further categorizing:
d. mutations with an ethnic distribution for consideration when a patient is a member of an ethnic group associated with such mutation.

7. The method of claim 5 wherein private and familial mutations are excluded from consideration.

8. The method of claim 5, further comprising organizing the diseases or disorders into groups according to shared phenotypic signs or symptoms.

9. The method of claim 8 wherein the phenotypic signs or symptoms are organized into panels comprising:
a. genetic diseases with obesity with mental retardation;
b. genetic diseases with post-natal short stature, broad or webbed neck, heart defects including cardiomyopathy, psychomotor developmental delay, macrocephaly;
c. genetic diseases with “special” behaviour and microcephaly;
d. genetic diseases with craniosynostosis;
e. genetic diseases with chondrodysplasia;
f. genetic diseases with bone dysplasias;
g. genetic metabolic diseases;
h. genetic diseases with neurological disorders;
i. genetic diseases with syndromic and non-syndromic hearing loss;
j. genetic diseases with “special” behaviour—autism;
k. genetic diseases with retinopathy; and
l. genetic diseases with seizures (epilepsy).

10. The method of claim 9, wherein for each of the panels (a) through (l) the diseases associated with the panels comprise:
a. Bardet-Biedl syndrome (BBS) and Cohen syndrome;
b. Costello syndrome, LEOPARD syndrome, Noonan syndrome, and cardiofaciocutaneous syndrome;
c. Rett syndrome, Cornelia de Lange syndrome, and Smith-Magenis syndrome;
d. Muenke syndrome, Apert syndrome, Crouzon syndrome, Jackson-Weiss syndrome, Pfeiffer syndrome, Saethre-Chotzen syndrome, craniosynostosis with elbow joint contracture, and Carpenter syndrome;
e. Zellweger syndrome, rhizomelic chondrodysplasia punctata type 1, recessive chondrodysplasia punctata 1 X-linked, CHILD syndrome, Conradi-Hünermann syndrome X-linked dominant, and autosomal dominant multiple epiphyseal dysplasia;
f. achondrogenesis II-hypochondrogenesis, achondrogenesis type 1B, achondroplasia, thanatophoric dysplasia, osteogenesis imperfecta autosomal recessive and campomelic dysplasia;
g. Alkaptonuria, Alpha-mannosidosis, Biotinidase deficiency, Carnitine palmitoyltransferase II deficiency, Medium-chain acyl-coenzyme A dehydrogenase, LCHAD, Tyrosinemia, Galactosemia (including Duarte variant), Gaucher disease, Glycogen storage disease type I, Glycogen storage Type II (Pompe disease), Glycogen storage Type V (McArdle disease), Hexosaminidase A deficiency (Tay-Sachs disease), Krabbe disease (late onset), Wilson disease, Metachromatic leukodystrophy, Jansky-Bielschovsky Disease, Neuronal ceroid lipofuscinoses, and Niemann-Pick disease type C;
h. hyperkalaemic periodic paralysis, paramyotonia congenita, and spastic paralysis infantile-onset;
i. hearing loss non-syndromic autosomal dominant, hearing loss non-syndromic autosomal recessive, branchiootorenal syndrome, Pendred syndrome recessive nonsyndromic and syndromic, Usher syndrome Type I, Waardenburg syndrome, and X-linked mixed deafness associated with gene POU3F4;
j. autism;
k. Leber congenital amaurosis, retinitis pigmentosa autosomal dominant, retinitis pigmentosa autosomal recessive, and retinitis pigmentosa X linked; and
l. neonatal-infantile seizures, benign neonatal included with myokymia epilepsy, different degrees of febrile seizures, epilepsy with nocturnal wandering and ictal fear, nocturnal frontal lobe epilepsy, progressive myoclonus epilepsy, myoclonic epilepsy of Lafora, pyridoxine-dependent epilepsy, neonatal epileptic encephalopathy, partial epilepsy with auditory features, generalised epilepsy with febrile seizures, Rett syndrome variant with infantile spasms, and encephalopathy with early epilepsy

11. The method of claim 10 wherein the genes associated with the diseases are as recited in claim 4.

12. A method for organizing genetic causes of disease, the method comprising:
a. grouping genetic diseases with similar symptoms and physical signs into panels;
b. identifying the genes associated with each of said diseases;
c. identifying point mutations within each of said genes, the mutations being associated with the disease state; and
d. creating one or more micro array(s) containing capture nucleotide sequences, each of said capture nucleotide sequences being capable of hybridizing to a nucleotide sequence containing a point mutation identified in step (c).

13. The method of claim 12 further comprising:
e. hybridizing said micro array(s) with nucleotide sequences obtained by processing a sample of patient tissue; and
f. detecting hybridized sequence(s).

14. A method for collecting data for use in diagnosing a disease, comprising:
a. testing a tissue sample from a patient for the presence or absence of one or more alleles associated with a disease, wherein the testing comprises processing the sample to obtain nucleotide sequences consistent with sequences in the patient's genome and hybridizing one or more of the patient's genomic nucleotide sequences to one or more probe nucleotide sequences, wherein each of said probe nucleotide sequences hybridizes to at least part of an allele associated with a known disease or disorder, and
b. detecting whether the patient has the allele associated with the known disease or disorder.

15. (canceled)

16. A micro array for a panel of diseases or disorders with genetic background wherein the micro array comprises nucleotide sequences capable of detecting point mutations of genes related to each of the diseases or disorders.

17. The micro array of claim 16 wherein the panel is chosen from the selection of panels consisting of:
a. Genetic diseases with obesity with mental retardation;
b. Genetic diseases with post-natal short stature, broad or webbed neck, heart defects including cardiomyopathy, psychomotor developmental delay, macrocephaly;
c. Genetic diseases with “special” behaviour and microcephaly;
d. Genetic diseases with craniosynostosis;
e. Genetic diseases with chondrodysplasia;
f. Genetic diseases with bone dysplasias;
g. Genetic metabolic diseases;
h. Genetic diseases with neurological disorders;
i. Genetic diseases with syndromic and non-syndromic hearing loss;
j. Genetic diseases with “special” behaviour—autism;
k. Genetic diseases with retinopathy;
l. Genetic diseases with seizures (epilepsy)

18. The micro array of claim 16 or 17 wherein the genetic diseases and the genes associated with each of the genetic diseases that are organized into each of the groups (a) through (l) are:
a. Bardet-Biedl syndrome (BBS) associated with genes BBS1, BBS10, BBS12, BBS2, BBS4, BBS5, BBS9, TRIM32, MKKS/BBS6, ARL6/BBS3 and TTC8/BBS8 and Cohen syndrome, associated with gene VPS13B;
b. Costello syndrome associated with gene HRAS, LEOPARD syndrome associated with gene PTPN11, Noonan syndrome associated with genes KRAS, PTPN11, RAF1, and SOS1, and Cardiofaciocutaneous syndrome associated with genes MAP2K1, MAP2K2, KRAS and BRAF;
c. Rett syndrome associated with gene MECP2, Cornelia de Lange associated with gene NIPBL, and Smith-Magenis syndrome associated with gene RAI1;
d. Muenke syndrome associated with gene FGFR3, Apert syndrome associated with gene FGFR2, Crouzon syndrome associated with gene FGFR2; Jackson-Weiss syndrome associated with gene FGFR2, Pfeiffer syndrome associated with gene FGFR1, Saethre-Chotzen syndrome associated with gene FGFR2, Craniosynostosis with elbow joint contracture associated with gene FGFR2, and Carpenter syndrome associated with gene RAB23;
e. Zellweger syndrome associated with genes PEX1 and PEX26, Rhizomelic Chondrodysplasia Punctata Type 1 associated with gene PEX7, Recessive Chondrodysplasia Punctata 1, X-Linked associated with gene ARSE, CHILD syndrome associated with gene EPB, Conradi-Hünermann syndrome, X-linked dominant, associated with gene EPB, Autosomal dominant multiple epiphyseal dysplasia, associated with genes COMP and MATN3;
f. Achondrogenesis II-hypochondrogenesis associated with gene COL2A1, Achondrogenesis type 1B associated with gene SLC26A2, Achondroplasia associated with gene FGFR3, Thanatophoric dysplasia, associated with gene FGFR3, Osteogenesis imperfecta, autosomal recessive associated with genes CRTAP and LEPRE1, and Campomelic dysplasia associated with gene SOX9;
g. Alkaptonuria associated with gene HGD, Alpha-mannosidosis associated with gene MAN2B1, Biotinidase deficiency associated with gene BTD, Carnitine palmitoyltransferase II deficiency associated with gene CPT2, Medium-chain acyl-coenzyme A dehydrogenase associated with gene ACADM, LCHAD associated with gene HADHA, Tyrosinemia associated with gene FAH, Galactosemia (including Duarte variant) associated with gene GALT, Gaucher disease associated with gene GBA, Glycogen storage disease type I associated with genes G6PC and SLC37A4, Glycogen storage Type II (Pompe disease) associated with gene GAA, Glycogen storage Type V (McArdle disease) associated with gene PYGM, Hexosaminidase A deficiency (Tay-Sachs disease) associated with gene HEXA, Krabbe disease (late onset) associated with gene GALC, Wilson disease associated with gene ATP7B, Metachromatic leukodystrophy associated with gene ARSA, Jansky-Bielschovsky Disease associated with gene CLN2, Neuronal ceroid lipofuscinoses associated with genes CLN5, CLN8 and NPC1, Niemann-Pick disease type C associated with genes NPC1 and NPC2;
h. Hyperkalaemic periodic paralysis associated with genes SCN4A and CACNA1 S, Paramyotonia congenita associated with gene SCN4A, Spastic paralysis, infantile-onset associated with ALS2;
i. Hearing loss, non-syndromic, autosomal dominant associated with genes ACTG1, COCH, CRYM, DFNA5, DIAPH1, GJB2, GJB3, GJB6, KCNQ4, MYH14, MYO1A, MYO7A, TECTA and WFS1, Hearing loss, non-syndromic, autosomal recessive associated with genes GJB2, SLC26A4, OTOF, CDH23, GJB3, GJA1, MYO7A, OTOA, TECTA and TMC1, Branchiootorenal syndrome associated with genes EYA1, SIX1 and SIX 5, Pendred syndrome, recessive, nonsyndromic associated with gene SLC26A5 and syndromic associated with gene SLC26A4, Usher syndrome Type I associated with genes MYO7A, USH1C, USH1G, CDH23 and PCHD15, Waardenburg syndrome associated with gene PAX3, and X-linked mixed deafness associated with gene POU3F4;
j. Autism associated with genes NLGN4, PTEN, NLG3, MECP2 and SCN2A;
k. Leber congenital amaurosis associated with genes CRB1, AIPL1, GUCY2D, RPE65, CEP290, RPGRIP1, RDH12 and CRX, Retinitis pigmentosa autosomal dominant associated with genes RP1, ROH, IMPDH1, PRPF31 and NR2E3, Retinitis pigmentosa autossomal recessive associated with genes RPE65, ABCA4, USH2A, PDE6B and PDE6A, and Retinitis pigmentosa X linked associated with genes RPGR and RP2;
l. Neonatal-infantile seizures associated with gene SCN2A, Benign neonatal included with myokymia epilepsy associated with gene KCNQ2, Different degrees of febrile seizures associated with gene GABRG2, Epilepsy with nocturnal wandering and ictal fear associated with gene CHRNA2, Nocturnal frontal lobe epilepsy associated with genes CHRNA4 and CHRNB2, Progressive myoclonus epilepsy associated with genes CSTB and EPM2A, Myoclonic epilepsy of Lafora associated with gene NHLRC1, Pyridoxine-dependent epilepsy associated with gene ALDH7A1, Neonatal epileptic encephalopathy associated with gene PNPO, Partial epilepsy with auditory features associated with gene LGI1, Generalised epilepsy with febrile seizures associated with gene SCN1B, Rett syndrome variant with infantile spasms associated with gene CDKL5, and Encephalopathy with early epilepsy associated with gene CDKL5.

19. A micro array as described in claim 16, 17 or 18 for use in diagnosing a disease or disorder with genetic background.

20. (canceled)


SEQUENCE LISTING (762 sequences)

SEQ ID NO: 1 - DNA, 61 bp, Homo sapiens
cgtagagtttaacttacttaacatccttctktggagctccaaatttattcttcttgcacag

SEQ ID NO: 2 - DNA, 61 bp, Homo sapiens
tcgacagtcccatcattgtagacatcaccaagsacacgttttacaaacagcccatgttcta

SEQ ID NO: 3 - DNA, 60 bp, Homo sapiens
atggtcccagaagccaggaggtcccccggccrcaggttgcagccgttgacagagtggtga

SEQ ID NO: 4 - DNA, 64 bp, Homo sapiens
ccccctgcggccccgccccctctccccgctgcgcrtcctgccgtaagcctgtagtgggtgggac

SEQ ID NO: 5 - DNA, 63 bp, Homo sapiens
tgtatggccatcaggggagatatgttcttggtgrccaatcttgggacaaaggagccttgtcat

SEQ ID NO: 6 - DNA, 63 bp, Homo sapiens
cttatccaaagagctgtatgccctgggggtctttsatgggcttcacacagtacatggcactta

SEQ ID NO: 7 - DNA, 51 bp, Homo sapiens
tgtcatggcgtacaataaattgaacrtgttccactggcatctggtagatga

SEQ ID NO: 8 - DNA, 51 bp, Homo sapiens
gcagggtcaagtggagccccagcttmtgaagacagtgccccgccatgaccc

SEQ ID NO: 9 - DNA, 64 bp, Homo sapiens
ctcccacaggatcagaggctggggccaactggraccattggcagctgcacgctcattactaccc

SEQ ID NO: 10 - DNA, 63 bp, Homo sapiens
acgtggttgccctgggagcccacaccrgggaggagagcgtggctgaccatcacgaggctgaat

SEQ ID NO: 11 - DNA, 64 bp, Homo sapiens
tgaggccaccaagtggaacgtgaatgctyctcccacatttcactctgagatgatgtatgacaat

SEQ ID NO: 12 - DNA, 39 bp, Homo sapiens
tgaagctaccaagtatgccctggraaggaaaactttcgg

SEQ ID NO: 13 - DNA, 40 bp, Homo sapiens
gcagtcaggattttacagttggcgtrtggcgaggagcaca

SEQ ID NO: 14 - DNA, 40 bp, Homo sapiens
tttgctcctagacaaagtggctaygagctataagccaagc

SEQ ID NO: 15 - DNA, 38 bp, Homo sapiens
aggctcacttcttcacccaggrtaacccctccccgtgg

SEQ ID NO: 16 - DNA, 39 bp, Homo sapiens
gctgtgaccagggcctggtccccakcccactgttggcca

SEQ ID NO: 17 - DNA, 39 bp, Homo sapiens
cgcccatgacctcatggccgacgyccagcgccaggatcg

SEQ ID NO: 18 - DNA, 39 bp, Homo sapiens
aggcatcccgtactcccacgaccagrtaggaaccacccg

SEQ ID NO: 19 - DNA, 37 bp, Homo sapiens
gcaaaaatactgaaagagaaagsctatgccactggac

SEQ ID NO: 20 - DNA, 37 bp, Homo sapiens
gcaaaaatactgaaagagaaagkctatgccactggac

SEQ ID NO: 21 - DNA, 40 bp, Homo sapiens
agcgacatttccgcctcccgaccgaacakccttcttctga

SEQ ID NO: 22 - DNA, 40 bp, Homo sapiens
aacaatgtggaaagtccactttgtgaygcctgtgttccag

SEQ ID NO: 23 - DNA, 40 bp, Homo sapiens
tgctgtggcccgttccccctctgctgrtgccttagggaag

SEQ ID NO: 24 - DNA, 38 bp, Homo sapiens
gactgcggaggccagcagtgaacamcccttgggcgtgg

SEQ ID NO: 25 - DNA, 39 bp, Homo sapiens
tacgggcgggaggacaacaccctcatcakgaccactcga

SEQ ID NO: 26 - DNA, 41 bp, Homo sapiens
atggcacttactacatccamgtgtgtgccctggtcaggtgt

SEQ ID NO: 27 - DNA, 41 bp, Homo sapiens
ggctggtgacggcggctctctatgggygcttgtatgagagg

SEQ ID NO: 28 - DNA, 35 bp, Homo sapiens
gtcctgttgtatgtgtcacagygccaatgtgtaca

SEQ ID NO: 29 - DNA, 34 bp, Homo sapiens
gacacccctgggcatctccgtgctcsgctgcatc

SEQ ID NO: 30 - DNA, 35 bp, Homo sapiens
ctgggcatctccgtgctccrctgcatccgcctcct

SEQ ID NO: 31 - DNA, 41 bp, Homo sapiens
taaccccctctgtgatccgtaagygatacaacttgacctca

SEQ ID NO: 32 - DNA, 40 bp, Homo sapiens
cctcaagcctgacttctccctacastggggggactgcacc

SEQ ID NO: 33 - DNA, 38 bp, Homo sapiens
attaggcgctttgacttccrtccaaaacctgatcctta

SEQ ID NO: 34 - DNA, 37 bp, Homo sapiens
tattaggcgctttgacttccstccaaaacctgatcct

SEQ ID NO: 35 - DNA, 40 bp, Homo sapiens
gaatggtatgaacttttcyaacttggcaactgtacatttc

SEQ ID NO: 36 - DNA, 40 bp, Homo sapiens
ggacaatgaaacaggaatttatkatgagacatggaatgta

SEQ ID NO: 37 - DNA, 43 bp, Homo sapiens
acctggactatgcatcctgggggatcsgctccacgctgatggt

SEQ ID NO: 38 - DNA, 38 bp, Homo sapiens
ggctccttagggtgctcccrgcaaccgcggtttcccag

SEQ ID NO: 39 - DNA, 38 bp, Homo sapiens
ctcccggtgcccagggcctccaggktccccgtggcctc

SEQ ID NO: 40 - DNA, 38 bp, Homo sapiens
tcttccctcagggtgacgttgstgagaaaggccctgag

SEQ ID NO: 41 - DNA, 38 bp, Homo sapiens
cccaactgggtggtgctcaaamcaggtgggagcggggt

SEQ ID NO: 42 - DNA, 36 bp, Homo sapiens
atggcgtggacttcgagggcasgttccatgtgaaca

SEQ ID NO: 43 - DNA, 35 bp, Homo sapiens
ggcgtggacttcgagggcaygttccatgtgaacac

SEQ ID NO: 44 - DNA, 38 bp, Homo sapiens
ttcatctttggctaccagracagctccagcttctacgt

SEQ ID NO: 45 - DNA, 39 bp, Homo sapiens
cgtgggttggaaggacaagaagtsctatcgttggttcct

SEQ ID NO: 46 - DNA, 39 bp, Homo sapiens
caacgtggtcttggacacaaccatgcsgggtggccgcct

SEQ ID NO: 47 - DNA, 41 bp, Homo sapiens
aataaacatacaagctacatttygggtaggtaggctgggct

SEQ ID NO: 48 - DNA, 39 bp, Homo sapiens
aatgcgtatcccctggataygtcccagtattttcggctt

SEQ ID NO: 49 - DNA, 40 bp, Homo sapiens
gtgttctgtctctgcctagratgacttccccattaaggac

SEQ ID NO: 50 - DNA, 41 bp, Homo sapiens
actaccaggacagcctgcmcaggtgagcctggcctccgggt

SEQ ID NO: 51 - DNA, 40 bp, Homo sapiens
ggccgcactgagaccatcygcccggcctccgtctatacaa

SEQ ID NO: 52 - DNA, 40 bp, Homo sapiens
ttttccattttgtttctcacagrccagggctttgaccgac

SEQ ID NO: 53 - DNA, 40 bp, Homo sapiens
gcaatgtctcttcctacccaggcygcaatgcccgggagtt

SEQ ID NO: 54 - DNA, 39 bp, Homo sapiens
gggcttttagctctgtgsgtgccctggagggccaactca

SEQ ID NO: 55 - DNA, 40 bp, Homo sapiens
aactcttaaatctgagtccccrgaacctagtggattgtgt

SEQ ID NO: 56 - DNA, 40 bp, Homo sapiens
aatgccttccaatatgtgyagaagaaccggggtattgact

SEQ ID NO: 57 - DNA, 40 bp, Homo sapiens
gaagagagttgtatgtrcaacccaacaggcaaggcagcta

SEQ ID NO: 58 - DNA, 40 bp, Homo sapiens
ggtacagagagatccccgaggkgaatgagaaagccctgaa

SEQ ID NO: 59 - DNA, 40 bp, Homo sapiens
agccctgaagagggcagtggccygagtgggacctgtctct

SEQ ID NO: 60 - DNA, 41 bp, Homo sapiens
attctaggtgtgtattatkatgaaagctgcaatagcgataa

SEQ ID NO: 61 - DNA, 41 bp, Homo sapiens
atagcgataatctgaaccatgyggttttggcagtgggatat

SEQ ID NO: 62 - DNA, 40 bp, Homo sapiens
ttcttgattggtcttacagcyggggagaaaactggggaaa

SEQ ID NO: 63 - DNA, 40 bp, Homo sapiens
taagaacaacgcctgtkgcattgccaacctggccagcttc

SEQ ID NO: 64 - DNA, 39 bp, Homo sapiens
gcttccccaagatgtgrctccagccagccaaatccatcc

SEQ ID NO: 65 - DNA, 41 bp, Homo sapiens
aggtggatgaaatctctyggcgtttaatttgggaaaaaaac

SEQ ID NO: 66 - DNA, 42 bp, Homo sapiens
cggcgtttaatttgggaawaaaacctgaagtatatttccatc

SEQ ID NO: 67 - DNA, 41 bp, Homo sapiens
ctggctatgaaccacctgrgggacatggcaagtatagcttc

SEQ ID NO: 68 - DNA, 41 bp, Homo sapiens
caaggttctgctgcyacctgtggtgagctttgctctgtacc

SEQ ID NO: 69 - DNA, 37 bp, Homo sapiens
tcaatggcctgcaagcctrgctcctcacgcacctgct

SEQ ID NO: 70 - DNA, 37 bp, Homo sapiens
agatcaatggcctgcaagcctgrctcctcacgcacct

SEQ ID NO: 71 - DNA, 39 bp, Homo sapiens
atctcctgtcctggttctygcccaccatcatcttcgaca

SEQ ID NO: 72 - DNA, 36 bp, Homo sapiens
caagctgttcttcaatgggygccccgggatcgtcgc

SEQ ID NO: 73 - DNA, 37 bp, Homo sapiens
caagctgttcttcaatgggcrccccgggatcgtcgcc

SEQ ID NO: 74 - DNA, 38 bp, Homo sapiens
ctgccatgaccacttsgggtggtacctgggctggggcg

SEQ ID NO: 75 - DNA, 39 bp, Homo sapiens
cccccagggtctgtacttgktgtaccaccccgtgcagct

SEQ ID NO: 76 - DNA, 36 bp, Homo sapiens
ggtgggctactacatcttccrggtggccaaccacca

SEQ ID NO: 77 - DNA, 36 bp, Homo sapiens
ctggtgggctactacatcttcygggtggccaaccac

SEQ ID NO: 78 - DNA, 36 bp, Homo sapiens
gggcttctggggcgtggccygccacttcaactacgt

SEQ ID NO: 79 - DNA, 36 bp, Homo sapiens
tcgggcttctggggcgtggccmgccacttcaactac

SEQ ID NO: 80 - DNA, 36 bp, Homo sapiens
gccacttcaactacgtcsgcgacctgatgggcagcc

SEQ ID NO: 81 - DNA, 36 bp, Homo sapiens
gcccgccacttcaactacgtcrgcgacctgatgggc

SEQ ID NO: 82 - DNA, 40 bp, Homo sapiens
gccaagactccacctataaygaggaaagccgcccagctct

SEQ ID NO: 83 - DNA, 37 bp, Homo sapiens
tccccctcgccccccarggtctgtacttggtgtacca

SEQ ID NO: 84 - DNA, 40 bp, Homo sapiens
ctttctgtctggttcctcgtgrtcgcaggcttgggtcctt

SEQ ID NO: 85 - DNA, 39 bp, Homo sapiens
gtctggttcctcgtggtygcaggcttgggtccttcagat

SEQ ID NO: 86 - DNA, 39 bp, Homo sapiens
ctgtctggttcctcgtggtcrcaggcttgggtccttcag

SEQ ID NO: 87 - DNA, 40 bp, Homo sapiens
cttaccggcaaggctacratgtcagcattcctgtctatag

SEQ ID NO: 88 - DNA, 41 bp, Homo sapiens
tttggaatggtccttatgaacgwctggagtggtaattactg

SEQ ID NO: 89 - DNA, 41 bp, Homo sapiens
gttttgggaccactgtctctcygtgggtggtgcccatggat

SEQ ID NO: 90 - DNA, 41 bp, Homo sapiens
ttgggaccactgtctctccgtgrgtggtgcccatggatgct

SEQ ID NO: 91 - DNA, 39 bp, Homo sapiens
ggaccatcagcgggccggtgartatctggctgcactgag

SEQ ID NO: 92 - DNA, 41 bp, Homo sapiens
tttttttttctggtgttattccakctaagcctcccgtatat

SEQ ID NO: 93 - DNA, 40 bp, Homo sapiens
ttctaatgaactctcccccakgtaaggctttttttgtagg

SEQ ID NO: 94 - DNA, 40 bp, Homo sapiens
catcttccacagagcggtcccstcaccggcccatcctgca

SEQ ID NO: 95 - DNA, 36 bp, Homo sapiens
tctctccaccagagcgatygcctcaccggcccatcc

SEQ ID NO: 96 - DNA, 36 bp, Homo sapiens
ctctccaccagagcgatsgcctcaccggcccatcct

SEQ ID NO: 97 - DNA, 38 bp, Homo sapiens
ctctccaccagagcgatcgcstcaccggcccatcctcc

SEQ ID NO: 98 - DNA, 38 bp, Homo sapiens
gatgcccagccccacatccmgtggatcaagcacgtgga

SEQ ID NO: 99 - DNA, 38 bp, Homo sapiens
ctggggaatatacgtgcttggsgggtaattctattggg

SEQ ID NO: 100 - DNA, 38 bp, Homo sapiens
gggtaattctattgggatatsctttcactctgcatggt

SEQ ID NO: 101 - DNA, 38 bp, Homo sapiens
agtgtattcatcgagatttarcagccagaaatgttttg

SEQ ID NO: 102 - DNA, 39 bp, Homo sapiens
aaaatagcagactttggactcrccagagatatcaacaat

SEQ ID NO: 103 - DNA, 39 bp, Homo sapiens
cgtcatctgcccccacagagygctccccgcaccggccca

SEQ ID NO: 104 - DNA, 40 bp, Homo sapiens
ctggcgggcaattctattgrgttttctcatcactctgcgt

SEQ ID NO: 105 - DNA, 40 bp, Homo sapiens
ggaggctgacgaggcgggcwgtgtgtatgcaggcatcctc

SEQ ID NO: 106 - DNA, 40 bp, Homo sapiens
ctgacgaggcgggcagtgtgtrtgcaggcatcctcagcta

SEQ ID NO: 107 - DNA, 41 bp, Homo sapiens
cgaggcgggcagtgtgtatgcakgcatcctcagctacgggg

SEQ ID NO: 108 - DNA, 41 bp, Homo sapiens
tgtatgcaggcatcctcagctacsgggtgggcttcttcctg

SEQ ID NO: 109 - DNA, 41 bp, Homo sapiens
cccccgctccgtgcacagacratgccactgacaaggacctg

SEQ ID NO: 110 - DNA, 41 bp, Homo sapiens
aaacacaaaaacatcatcaasctgctgggcgcctgcacgca

SEQ ID NO: 111 - DNA, 38 bp, Homo sapiens
acaacctcgactactacaagragacgaccaacgtgagc

SEQ ID NO: 112 - DNA, 40 bp, Homo sapiens
gtgcacaacctcgactactacaagawgacgaccaacgtga

SEQ ID NO: 113 - DNA, 40 bp, Homo sapiens
aacctcgactactacaagaasacgaccaacgtgagcccgg

SEQ ID NO: 114 - DNA, 40 bp, Homo sapiens
ctcgactactacaagmagacgaccaacgtgagcccggccc

SEQ ID NO: 115 - DNA, 40 bp, Homo sapiens
agcagtgggggctcgcggacgtgwagggccactggtcccc

SEQ ID NO: 116 - DNA, 41 bp, Homo sapiens
cagggctggtgccctyggagcgtgtcctggtggggccccag

SEQ ID NO: 117 - DNA, 40 bp, Homo sapiens
aagttgttgctggagtcctgtcasgtatgggctgatctga

SEQ ID NO: 118 - DNA, 40 bp, Homo sapiens
tcatcccctactgcctcgccyaggtcctgggccagccgca

SEQ ID NO: 119 - DNA, 41 bp, Homo sapiens
ccataggattctctttggacagygtccatactggtgggttt

SEQ ID NO: 120 - DNA, 40 bp, Homo sapiens
ccaagggtggggaggccygaggggagctgttctgggacga

SEQ ID NO: 121 - DNA, 40 bp, Homo sapiens
cgcctccctgctgagcccgcttkcttctcccgcaggcctg

SEQ ID NO: 122 - DNA, 40 bp, Homo sapiens
aatagtgacatgggtgcagrctgctggggtcgcattttaa

SEQ ID NO: 123 - DNA, 40 bp, Homo sapiens
tcatgtgcttccacccctggtyggatgtaacgctgccact

SEQ ID NO: 124 - DNA, 40 bp, Homo sapiens
tccctatctgatagatctytgaaaacaaaggtgccatgat

SEQ ID NO: 125 - DNA, 40 bp, Homo sapiens
acccccacccccactgccrggtaagggtgtcaggggctcc

SEQ ID NO: 126 - DNA, 41 bp, Homo sapiens
aggtatgggccagcagtttccygccagatattgcccagcgt

SEQ ID NO: 127 - DNA, 41 bp, Homo sapiens
aggagcgatctcagcaggcctrtaagagtcagcatggagag

SEQ ID NO: 128 - DNA, 41 bp, Homo sapiens
aagaagctcttgaccaaktatgacaacctctttgagacgtc

SEQ ID NO: 129 - DNA, 40 bp, Homo sapiens
tagcctatccttgtcggtrggtgaatccccagtacgatag

SEQ ID NO: 130 - DNA, 41 bp, Homo sapiens
tttgtccttaccctagarcctcctgtaccatgtggtcggct

SEQ ID NO: 131 - DNA, 41 bp, Homo sapiens
gaggacccaattggktgcgtaactttgtcgacagtcccatc

SEQ ID NO: 132 - DNA, 41 bp, Homo sapiens
attgtagacatcaccaagsacacgttttacaaacagcccat

SEQ ID NO: 133 - DNA, 39 bp, Homo sapiens
tgctgttgtggtcgtgctaaacyggtgagggcaatggtg

SEQ ID NO: 134 - DNA, 40 bp, Homo sapiens
tctgctgttgtggtcgtgctaaaccrgtgagggcaatggt

SEQ ID NO: 135 - DNA, 41 bp, Homo sapiens
cctacctgtggcgtcrccagtgatggagcagatactcaagg

SEQ ID NO: 136 - DNA, 40 bp, Homo sapiens
aggcagtgtcgtgggcatcagrtgagtgagtcaaggcagt

SEQ ID NO: 137 - DNA, 37 bp, Homo sapiens
tcaggacctgcttcgctgcygtgtcctgacttctgga

SEQ ID NO: 138 - DNA, 37 bp, Homo sapiens
ttcaggacctgcttcgctgccrtgtcctgacttctgg

SEQ ID NO: 139 - DNA, 38 bp, Homo sapiens
atgggagcaggcatcgccyaagtctccgtggataaggg

SEQ ID NO: 140 - DNA, 39 bp, Homo sapiens
ggacaagatgcagctgctgsagattatcacgaccgagaa

SEQ ID NO: 141 - DNA, 40 bp, Homo sapiens
actgtctggggagctctcckaggtaacaaattggggctga

SEQ ID NO: 142 - DNA, 40 bp, Homo sapiens
cttgctgttggatacatctcrccattacctgccactctct

SEQ ID NO: 143 - DNA, 40 bp, Homo sapiens
gaaggaggtcattgaatacgcayggctccggggtatccgt

SEQ ID NO: 144 - DNA, 40 bp, Homo sapiens
attgaatacgcacggctcyggggtatccgtgtgcttgcag

SEQ ID NO: 145 - DNA, 40 bp, Homo sapiens
ctttgtcctggggaccargtaagaatgatgtctgggacca

SEQ ID NO: 146 - DNA, 38 bp, Homo sapiens
ggagtccttctacatccagacrtgaggaaggaaggagg

SEQ ID NO: 147 - DNA, 39 bp, Homo sapiens
tggtccccaggctctgstaagggttttcgggggggaggt

SEQ ID NO: 148 - DNA, 40 bp, Homo sapiens
tttgtcagttccgcagaaarggaaccttctcatttacacc

SEQ ID NO: 149 - DNA, 41 bp, Homo sapiens
atcctcgtgatttcttgatayccattgcctggtatgaggat

SEQ ID NO: 150 - DNA, 41 bp, Homo sapiens
gttcaatgttgtggcctggcacrggaattatacaccctaca

SEQ ID NO: 151 - DNA, 41 bp, Homo sapiens
caggacccatccattttcacagkattgactgctaagtctgt

SEQ ID NO: 152 - DNA, 41 bp, Homo sapiens
agggagtctacacagcacartgaccccccatggacctgatg

SEQ ID NO: 153 - DNA, 41 bp, Homo sapiens
ggtgctggtggggaacargtgtgacctggctgcacgcactg

SEQ ID NO: 154 - DNA, 40 bp, Homo sapiens
ctggtggtggtgggcgccgscggtgtgggcaagagtgcgc

SEQ ID NO: 155 - DNA, 39 bp, Homo sapiens
ctggtggtggtgggcgcckgcggtgtgggcaagagtgcg

SEQ ID NO: 156 - DNA, 40 bp, Homo sapiens
agctggtggtggtgggcgccrgcggtgtgggcaagagtgc

SEQ ID NO: 157 - DNA, 39 bp, Homo sapiens
tggtggtgggcgccggcgrtgtgggcaagagtgcgctga

SEQ ID NO: 158 - DNA, 39 bp, Homo sapiens
ggtggtggtgggcgccggckgtgtgggcaagagtgcgct

SEQ ID NO: 159 - DNA, 41 bp, Homo sapiens
ccctacatcgagacctcgrccaagacccggcaggtgaggca

SEQ ID NO: 160 - DNA, 40 bp, Homo sapiens
ggtagttggagctggtggcrtaggcaagagtgccttgacg

SEQ ID NO: 161 - DNA, 41 bp, Homo sapiens
tttttatgtatttcagggtgktgatgatgccttctatacat

SEQ ID NO: 162 - DNA, 41 bp, Homo sapiens
atgtatttcagggtgttgwtgatgccttctatacattagtt

SEQ ID NO: 163 - DNA, 40 bp, Homo sapiens
ggtgttgatgatgccwtctatacattagttcgagaaattc

SEQ ID NO: 164 - DNA, 42 bp, Homo sapiens
gagtgccttgacgatacrgctaattcagaatcatgtaaatct

SEQ ID NO: 165 - DNA, 39 bp, Homo sapiens
gcaagagtgccttgacgatacmaacaatagaggtaaatc

SEQ ID NO: 166 - DNA, 39 bp, Homo sapiens
caagagtgccttgacgatacyaacaatagaggtaaatct

SEQ ID NO: 167 - DNA, 42 bp, Homo sapiens
ttgtggacgaatatgatccaacaatrgaggtaaatcttgttt

SEQ ID NO: 168 - DNA, 41 bp, Homo sapiens
acctgtctcttggatattctcgacayagcaggtcaagagga

SEQ ID NO: 169 - DNA, 38 bp, Homo sapiens
aagtcccatgtgggtggygattcctgcgacacctgtga

SEQ ID NO: 170 - DNA, 39 bp, Homo sapiens
agacttcggtaagacctgrcgagtgtaccagtacctggc

SEQ ID NO: 171 - DNA, 39 bp, Homo sapiens
aactcaaagtcaaaaaattcaargtcagtgtggttactt

SEQ ID NO: 172 - DNA, 39 bp, Homo sapiens
ccagcgcctactatgctgtgtccyagctccgtctgcagg

SEQ ID NO: 173 - DNA, 39 bp, Homo sapiens
ggcgcccgggagcttccattyaggagacctgcatctgtg

SEQ ID NO: 174 - DNA, 40 bp, Homo sapiens
gggaggacccggtttctcygagcttcatctacctgtggac

SEQ ID NO: 175 - DNA, 39 bp, Homo sapiens
cccgctgtgaccagtgccagygaggctactgtaatcgct

SEQ ID NO: 176 - DNA, 40 bp, Homo sapiens
gggtttcaggttctcttagtgctygatgtgacaactccgg

SEQ ID NO: 177 - DNA, 37 bp, Homo sapiens
cagacagccaggcgcaccctccgkagctgctgttctc

SEQ ID NO: 178 - DNA, 38 bp, Homo sapiens
acagcggcacctggagctagagyggtcggtggggccga

SEQ ID NO: 179 - DNA, 38 bp, Homo sapiens
cttctacacagacagcaatggcygggagatcctggaga

SEQ ID NO: 180 - DNA, 38 bp, Homo sapiens
gcagcctgagagatggctcgcyggagctcatggtgagt

SEQ ID NO: 181 - DNA, 39 bp, Homo sapiens
ctggacattgggccagccgacacgygggtggcagtggtg

SEQ ID NO: 182 - DNA, 38 bp, Homo sapiens
cacagtccccagggaaaagcctttygctctaaagtgga

SEQ ID NO: 183 - DNA, 38 bp, Homo sapiens
tgggagagggagcccctcccggygagagcagaaaccac

SEQ ID NO: 184 - DNA, 38 bp, Homo sapiens
tgatcaaacgccccggcaggaagygaaaagctgaggcc

SEQ ID NO: 185 - DNA, 38 bp, Homo sapiens
tcaggccattcccaagaaacggggcygaaagccgggga

SEQ ID NO: 186 - DNA, 39 bp, Homo sapiens
aaagccgtgaaggagtcttctatcygatctgtgcaggag

SEQ ID NO: 187 - DNA, 39 bp, Homo sapiens
actaactcttatgaaacagctatgygaacagcccaaaac

SEQ ID NO: 188 - DNA, 39 bp, Homo sapiens
tcacacccagtcaagtgtacrccactttgccctaaatgt

SEQ ID NO: 189 - DNA, 39 bp, Homo sapiens
taaagcattaattttattcttayagacgcaaaatgattt

SEQ ID NO: 190 - DNA, 39 bp, Homo sapiens
agaccgtgacaaccctgagacccgcygtaaaacactggt

SEQ ID NO: 191 - DNA, 39 bp, Homo sapiens
gccatggcaccagggtcggagycacgtacttcatgacct

SEQ ID NO: 192 - DNA, 39 bp, Homo sapiens
ctgcagacctctgctgactttattgacrctctgaagaaa

SEQ ID NO: 193 - DNA, 39 bp, Homo sapiens
ttgacgctctgaagaaagcccgacttayagccagtaatg

SEQ ID NO: 194 - DNA, 39 bp, Homo sapiens
gacaaggccctgggactcctgtrtgggaaggacgctgac

SEQ ID NO: 195 - DNA, 40 bp, Homo sapiens
cgggattggcagtcttcattgactttcttctgcmgattac

SEQ ID NO: 196 - DNA, 41 bp, Homo sapiens
tggatggagttataaaggaagtgaatrtgagcccatgcccc

SEQ ID NO: 197 - DNA, 41 bp, Homo sapiens
tgaatgtgagcccatgccccaccyaaccctgccagctgagc

SEQ ID NO: 198 - DNA, 41 bp, Homo sapiens
gagcccatgccccacccaaccctgmcagctgagcaaaggac

SEQ ID NO: 199 - DNA, 41 bp, Homo sapiens
ctctttttttctcttagatattcagyctaaaagcagcaagg

SEQ ID NO: 200 - DNA, 41 bp, Homo sapiens
gatggttgtaagagtggaattaacygccctatccaaaaaga

SEQ ID NO: 201 - DNA, 39 bp, Homo sapiens
caatgtcaccttcaccagcagtgcrtaaaagtggctctt

SEQ ID NO: 202 - DNA, 41 bp, Homo sapiens
gcataaacctagagacctggrttgggacaagattggtgggt

SEQ ID NO: 203 - DNA, 40 bp, Homo sapiens
ggtgaagtgctccctgtgtgttgtgrggatccaggccctg

SEQ ID NO: 204 - DNA, 40 bp, Homo sapiens
ggccctggcagaaatggatyggtggcaagaagtcctctcc

SEQ ID NO: 205 - DNA, 39 bp, Homo sapiens
tttagaatttgctggtgaccrgggcggttgactgtagtt

SEQ ID NO: 206 - DNA, 40 bp, Homo sapiens
ttagaatttgctggtgaccggggyggttgactgtagtttg

SEQ ID NO: 207 - DNA, 41 bp, Homo sapiens
cggctacgccgccgagttctycccgtacctgccgggccgcc

SEQ ID NO: 208 - DNA, 40 bp, Homo sapiens
cttcttgaaacagtggagcatcrtacagagtttacttgtg

SEQ ID NO: 209 - DNA, 40 bp, Homo sapiens
tgcgccaccgcgcagcactactasggcatcgcgggtgagg

SEQ ID NO: 210 - DNA, 39 bp, Homo sapiens
cttttgctttctaaacacttttcartgtttttaggtgta

SEQ ID NO: 211 - DNA, 39 bp, Homo sapiens
tcagtcttcagagccccactcagstaacggatacaatct

SEQ ID NO: 212 - DNA, 41 bp, Homo sapiens
aaactcccttttattccgtaggwgggcagtggctcagagat

SEQ ID NO: 213 - DNA, 41 bp, Homo sapiens
tgtaggtgtttttggactccctygatgcccaggagagagct

SEQ ID NO: 214 - DNA, 37 bp, Homo sapiens
aatatcctctgaactgtgcagmtcctacctctgaaag

SEQ ID NO: 215 - DNA, 37 bp, Homo sapiens
actgtgcagatcctacctctgmaaggtcagtaacatt

SEQ ID NO: 216 - DNA, 33 bp, Homo sapiens
gttttcttgtacgagasagccagagccaccctg

SEQ ID NO: 217 - DNA, 34 bp, Homo sapiens
ggtagttttcttgtacgagakagccagagccacc

SEQ ID NO: 218 - DNA, 39 bp, Homo sapiens
ggagggcgggaggaacatgayatcgcgaggtgaggagcc

SEQ ID NO: 219 - DNA, 35 bp, Homo sapiens
tctttccagacactacaacracaggagtgcaaact

SEQ ID NO: 220 - DNA, 34 bp, Homo sapiens
ttctttccagacactacaamaacaggagtgcaaa

SEQ ID NO: 221 - DNA, 38 bp, Homo sapiens
agatataaaaacatcctgcccygtaagtatcaatattc

SEQ ID NO: 222 - DNA, 35 bp, Homo sapiens
tggtctctttttcttctagktgatcataccagggt

SEQ ID NO: 223 - DNA, 35 bp, Homo sapiens
tctctttttcttctagtkgatcataccagggttgt

SEQ ID NO: 224 - DNA, 35 bp, Homo sapiens
ggtctctttttcttctagytgatcataccagggtt

SEQ ID NO: 225 - DNA, 35 bp, Homo sapiens
tttcagattacatcaatgcaratatcatcatggta

SEQ ID NO: 226 - DNA, 35 bp, Homo sapiens
tcagattacatcaatgcaartatcatcatggtaag

SEQ ID NO: 227 - DNA, 35 bp, Homo sapiens
tttcagattacatcaatgcaamtatcatcatggta

SEQ ID NO: 228 - DNA, 38 bp, Homo sapiens
tcagattacatcaatgcaaatrtcatcatggtaagctt

SEQ ID NO: 229 - DNA, 37 bp, Homo sapiens
tttttcttggctctactccaggsgaatacggagagaa

SEQ ID NO: 230 - DNA, 37 bp, Homo sapiens
ctctactccaggggaatayggagagaacggtctggca

SEQ ID NO: 231 - DNA, 38 bp, Homo sapiens
aaagtaaccctggagacttcrcactttccgttaggtaa

SEQ ID NO: 232 - DNA, 36 bp, Homo sapiens
tttgtccttctgcccgcagtrctggaattggccgga

SEQ ID NO: 233 - DNA, 37 bp, Homo sapiens
ctgcccgcagtgctggaattgsccggacagggacgtt

SEQ ID NO: 234 - DNA, 34 bp, Homo sapiens
aattggccggacagggaygttcattgtgattgat

SEQ ID NO: 235 - DNA, 35 bp, Homo sapiens
actgcgatattgacgttcmcaaaaccatccagatg

SEQ ID NO: 236 - DNA, 35 bp, Homo sapiens
gactgcgatattgacgttcycaaaaccatccagat

SEQ ID NO: 237 - DNA, 34 bp, Homo sapiens
gttgactgcgatattgacgttyccaaaaccatcc

SEQ ID NO: 238 - DNA, 34 bp, Homo sapiens
cccaaaaccatccagatggtgckgtctcagaggt

SEQ ID NO: 239 - DNA, 35 bp, Homo sapiens
ccaaaaccatccagatggtgyggtctcagaggtca

SEQ ID NO: 240 - DNA, 37 bp, Homo sapiens
ccagatggtgcggtctcagargtcagggatggtccag

SEQ ID NO: 241 - DNA, 35 bp, Homo sapiens
ggtgcggtctcagaggkcagggatggtccagacag

SEQ ID NO: 242 - DNA, 34 bp, Homo sapiens
ggtgcggtctcagaggtcarggatggtccagaca

SEQ ID NO: 243 - DNA, 34 bp, Homo sapiens
gatggtgcggtctcagaggtyagggatggtccag

SEQ ID NO: 244 - DNA, 35 bp, Homo sapiens
gatggtgcggtctcagaggwcagggatggtccaga

SEQ ID NO: 245 - DNA, 37 bp, Homo sapiens
cggtctcagaggtcagggrtggtccagacagaagcac

SEQ ID NO: 246 - DNA, 37 bp, Homo sapiens
tcagaggtcagggatggtccmgacagaagcacagtac

SEQ ID NO: 247 - DNA, 35 bp, Homo sapiens
atggtccagacagaagcacrgtaccgatttatcta

SEQ ID NO: 248 - DNA, 34 bp, Homo sapiens
atggtccagacagaagcasagtaccgatttatct

SEQ ID NO: 249 - DNA, 35 bp, Homo sapiens
gtccagacagaagcacmgtaccgatttatctatat

SEQ ID NO: 250 - DNA, 37 bp, Homo sapiens
gtggagatcagagccctytcccgccttgtactccaac

SEQ ID NO: 251 - DNA, 36 bp, Homo sapiens
cccacatcaagattcagracactggtgattactatg

SEQ ID NO: 252 - DNA, 36 bp, Homo sapiens
cacccacatcaagattcagmacactggtgattacta

SEQ ID NO: 253 - DNA, 36 bp, Homo sapiens
acccacatcaagattcagaasactggtgattactat

SEQ ID NO: 254 - DNA, 35 bp, Homo sapiens
atcaagattcagaacactgstgattactatgacct

SEQ ID NO: 255 - DNA, 36 bp, Homo sapiens
atcaagattcagaacactkgtgattactatgacctg

SEQ ID NO: 256 - DNA, 36 bp, Homo sapiens
agattcagaacactggtrattactatgacctgtatg

SEQ ID NO: 257 - DNA, 36 bp, Homo sapiens
aagattcagaacactggtgrttactatgacctgtat

SEQ ID NO: 258 - DNA, 35 bp, Homo sapiens
ttcagaacactggtgatwactatgacctgtatgga

SEQ ID NO: 259 - DNA, 35 bp, Homo sapiens
gattcagaacactggtgatkactatgacctgtatg

SEQ ID NO: 260 - DNA, 38 bp, Homo sapiens
gattcagaacactggtgattactrtgacctgtatggag

SEQ ID NO: 261 - DNA, 38 bp, Homo sapiens
tatgacctgtatggagggsagaaatttgccactttggc

SEQ ID NO: 262 - DNA, 36 bp, Homo sapiens
atgacctgtatggaggggagaaawttgccactttgg

SEQ ID NO: 263 - DNA, 35 bp, Homo sapiens
ctgtatggaggggagaaayttgccactttggctga

SEQ ID NO: 264 - DNA, 36 bp, Homo sapiens
tgtatggaggggagaaatttgscactttggctgagt

SEQ ID NO: 265 - DNA, 35 bp, Homo sapiens
cctgtatggaggggagaaatttkccactttggctg

SEQ ID NO: 266 - DNA, 36 bp, Homo sapiens
gtatggaggggagaaatttgccaytttggctgagtt

SEQ ID NO: 267 - DNA, 36 bp, Homo sapiens
caaatttgccactttggctgasttggtccagtatta

SEQ ID NO: 268 - DNA, 34 bp, Homo sapiens
gagaaatttgccactttggctgakttggtccagt

SEQ ID NO: 269 - DNA, 35 bp, Homo sapiens
ccactttggctgagttggtccrgtattacatggaa

SEQ ID NO: 270 - DNA, 35 bp, Homo sapiens
tttggctgagttggtccmgtattacatggaacatc

SEQ ID NO: 271 - DNA, 39 bp, Homo sapiens
acgctacctgtgcacttctacrgccatgtggagcacacc

SEQ ID NO: 272 - DNA, 40 bp, Homo sapiens
ccgcaatgtggccaccccaygagactactactttgctctg

SEQ ID NO: 273 - DNA, 39 bp, Homo sapiens
tgacctgcagaacccaagagagyggacgcggatggtgat

SEQ ID NO: 274 - DNA, 40 bp, Homo sapiens
tctctctgggcagaggatctamtacctgtctttagagttc

SEQ ID NO: 275 - DNA, 41 bp, Homo sapiens
cctctcccagaggcagagktcgacatccacacctaatgtcc

SEQ ID NO: 276 - DNA, 41 bp, Homo sapiens
tccctctcccagaggcagaggtygacatccacacctaatgt

SEQ ID NO: 277 - DNA, 41 bp, Homo sapiens
cccagaggcagaggtcgacatycacacctaatgtccacatg

SEQ ID NO: 278 - DNA, 41 bp, Homo sapiens
gaggcagaggtcgacatccasacctaatgtccacatggtca

SEQ ID NO: 279 - DNA, 39 bp, Homo sapiens
agaggtcgacatccacasctaatgtccacatggtcagca

SEQ ID NO: 280 - DNA, 38 bp, Homo sapiens
ggcagaggtcgacatccacacytaatgtccacatggtc

SEQ ID NO: 281 - DNA, 39 bp, Homo sapiens
cagaggtcgacatccacayctaatgtccacatggtcagc

SEQ ID NO: 282 - DNA, 39 bp, Homo sapiens
tcgacatccacacctaatgyccacatggtcagcaccacc

SEQ ID NO: 283 - DNA, 38 bp, Homo sapiens
gcttaacagtgaaaattggarattttggtttggcaaca

SEQ ID NO: 284 - DNA, 38 bp, Homo sapiens
gcttaacagtgaaaattggagrttttggtttggcaaca

SEQ ID NO: 285 - DNA, 39 bp, Homo sapiens
ttggagattttggtttggcaasagtaaagtcacgctgga

SEQ ID NO: 286 - DNA, 40 bp, Homo sapiens
ttggagattttggtttggcaayagtaaagtcacgctggag

SEQ ID NO: 287 - DNA, 41 bp, Homo sapiens
ttgagctgctccaacacwctctaccgaagatcaaccggagc

SEQ ID NO: 288 - DNA, 41 bp, Homo sapiens
agctgctccaacactctstaccgaagatcaaccggagcgct

SEQ ID NO: 289 - DNA, 38 bp, Homo sapiens
caaacctggtgcaggcrgcaagctctctgaccggcccc

SEQ ID NO: 290 - DNA, 39 bp, Homo sapiens
gcaaacatgagtgcarcaaggaggctccggcagagcccg

SEQ ID NO: 291 - DNA, 40 bp, Homo sapiens
gggcctgatggggagygagctccaggggattccaccacct

SEQ ID NO: 292 - DNA, 39 bp, Homo sapiens
actcgggcgactacgagtgscacgtctaccgcctgctct

SEQ ID NO: 293 - DNA, 36 bp, Homo sapiens
gcagctggaggaggatgagygcttcgagggccgcgt

SEQ ID NO: 294 - DNA, 37 bp, Homo sapiens
gttgcagctggaggaggatgagcrcttcgagggccgc

SEQ ID NO: 295 - DNA, 38 bp, Homo sapiens
ctccctggctacccctmgatcctgcgctatgagaatga

SEQ ID NO: 296 - DNA, 37 bp, Homo sapiens
tccctgcggacactgcrggccctgcgtcccctgaggg

SEQ ID NO: 297 - DNA, 37 bp, Homo sapiens
gcccccaggtggtggtgaacgmcctcctaggcgccat

SEQ ID NO: 298 - DNA, 37 bp, Homo sapiens
gtgaacgccctcctaggcrccatcccctccatcatga

SEQ ID NO: 299 - DNA, 38 bp, Homo sapiens
gccctcctaggcgccatcycctccatcatgaatgtgct

SEQ ID NO: 300 - DNA, 38 bp, Homo sapiens
ggcgccatcccctccrtcatgaatgtgctgcttgtctg

SEQ ID NO: 301 - DNA, 35 bp, Homo sapiens
gggaaagacatctttatgrcggaggaacagaagaa

SEQ ID NO: 302 - DNA, 35 bp, Homo sapiens
gaaagacatctttatgayggaggaacagaagaaat

SEQ ID NO: 303 - DNA, 36 bp, Homo sapiens
aggccttcgacatcaccatcrtgatcctcatctgcc

SEQ ID NO: 304 - DNA, 38 bp, Homo sapiens
tgcctcaacatggtcaccrtgatggtggagacagacaa

SEQ ID NO: 305 - DNA, 38 bp, Homo sapiens
tccccgcaggcctgccckctctgacctgatccagaagt

SEQ ID NO: 306 - DNA, 35 bp, Homo sapiens
gtgtcacccacgctgttcygtgtgatccgcctggc

SEQ ID NO: 307 - DNA, 35 bp, Homo sapiens
gtgtcacccacgctgttccrtgtgatccgcctggc

SEQ ID NO: 308 - DNA, 35 bp, Homo sapiens
tgtcacccacgctgttccktgtgatccgcctggcg

SEQ ID NO: 309 - DNA, 38 bp, Homo sapiens
tcttcctggtcatgttcwtctactccatcttcggcatg

SEQ ID NO: 310 - DNA, 38 bp, Homo sapiens
ccttcctcatcgtggtcaacrtgtacatcgccatcatc

SEQ ID NO: 311 - DNA, 38 bp, Homo sapiens
gccctcaagcagaccatgraggagaagttcatggcagc

SEQ ID NO: 312 - DNA, 38 bp, Homo sapiens
cagggactgtctgtgctacrgctccttccgtctggtac

SEQ ID NO: 313 - DNA, 35 bp, Homo sapiens
gtctgtgctacgctccttcygtctggtacacaaaa

SEQ ID NO: 314 - DNA, 36 bp, Homo sapiens
tgctacgctccttcsgtctggtacacaaaagcccca

SEQ ID NO: 315 - DNA, 36 bp, Homo sapiens
gtgctacgctccttccrtctggtacacaaaagcccc

SEQ ID NO: 316 - DNA, 36 bp, Homo sapiens
actgtctgtgctacgctccttcmgtctggtacacaa

SEQ ID NO: 317 - DNA, 37 bp, Homo sapiens
gtggccaacgctgaacatgmtcatcaagatcattggc

SEQ ID NO: 318 - DNA, 37 bp, Homo sapiens
tcgtggccaacgctgaacatgstcatcaagatcattg

SEQ ID NO: 319 - DNA, 39 bp, Homo sapiens
tgaacatgctcatcaagatcaytggcaattcagtggggg

SEQ ID NO: 320 - DNA, 39 bp, Homo sapiens
ggggcgctgggtaacctgaygctggtgctggctatcatc

SEQ ID NO: 321 - DNA, 39 bp, Homo sapiens
aagccatgtgcctcaccrtcttcctcatggtcatggtca

SEQ ID NO: 322 - DNA, 37 bp, Homo sapiens
atgattggtgagacagttgacygagaactacagaaag

SEQ ID NO: 323 - DNA, 37 bp, Homo sapiens
tgggctcaaccttcctyggactaatggtgtgggctca

SEQ ID NO: 324 - DNA, 38 bp, Homo sapiens
tgcatactatagtgattgacwgcagtgcaattcaattt

SEQ ID NO: 325 - DNA, 35 bp, Homo sapiens
agctggagtttatcaggyaagcagcaatgaaacaa

SEQ ID NO: 326 - DNA, 37 bp, Homo sapiens
gtattgggagctgtatttkgtttctcctcgtatggcc

SEQ ID NO: 327 - DNA, 41 bp, Homo sapiens
ctttatctctcccagtaraaaaaattcatcctttattaaag

SEQ ID NO: 328 - DNA, 40 bp, Homo sapiens
ggccatatagaagatamagtagaaatgacagatgaaggca

SEQ ID NO: 329 - DNA, 38 bp, Homo sapiens
agaagatacagtagaaakgacagatgaaggcagtcccc

SEQ ID NO: 330 - DNA, 38 bp, Homo sapiens
agaagatacagtagaaaygacagatgaaggcagtcccc

SEQ ID NO: 331 - DNA, 40 bp, Homo sapiens
ttttgcgacctggttttcatkatcgtttccttagtcagtt

SEQ ID NO: 332 - DNA, 40 bp, Homo sapiens
tcaaagaagctgttcaatrtgttttacccaggctgcttct

SEQ ID NO: 333 - DNA, 41 bp, Homo sapiens
ttcagaagaatattgatggtygggagggaaaagacattgga

SEQ ID NO: 334 - DNA, 41 bp, Homo sapiens
agaagaatattgatggttggragggaaaagacattggacag

SEQ ID NO: 335 - DNA, 37 bp, Homo sapiens
gaatattgatggttgggagrgaaaagacattggacag

SEQ ID NO: 336 - DNA, 37 bp, Homo sapiens
gaatattgatggttgggagsgaaaagacattggacag

SEQ ID NO: 337 - DNA, 41 bp, Homo sapiens
aaaagacattggacagtgttrtaatgaatttataatggaag

SEQ ID NO: 338 - DNA, 40 bp, Homo sapiens
atcaaatcatgggcagcsaagacttcctggtgctagcaat

SEQ ID NO: 339 - DNA, 40 bp, Homo sapiens
gatatctttacagtaccggmgtacactggaaaggatgctt

SEQ ID NO: 340 - DNA, 41 bp, Homo sapiens
tttacagtaccggagtacacyggaaaggatgcttgatgtaa

SEQ ID NO: 341 - DNA, 39 bp, Homo sapiens
taccggagtacactggaarggatgcttgatgtaacaatg

SEQ ID NO: 342 - DNA, 38 bp, Homo sapiens
ccggagtacactggaaargatgcttgatgtaacaatgc

SEQ ID NO: 343 - DNA, 39 bp, Homo sapiens
ggagtacactggaaagsatgcttgatgtaacaatgctac

SEQ ID NO: 344 - DNA, 41 bp, Homo sapiens
ttcttcttagatcccaatwttgttcggacatttcttacaac

SEQ ID NO: 345 - DNA, 40 bp, Homo sapiens
tgaaattccagagcctgagcyaacagaagctgatcgcata

SEQ ID NO: 346 - DNA, 41 bp, Homo sapiens
ctgggtagagcaccacttcyatgattttgaaagagatgcat

SEQ ID NO: 347 - DNA, 41 bp, Homo sapiens
gtaaagcaatgaaaaaatkggttgaatccatcactaaaata

SEQ ID NO: 348 - DNA, 40 bp, Homo sapiens
aaaaatgggttgaatccwtcactaaaataatccaaaggaa

SEQ ID NO: 349 - DNA, 40 bp, Homo sapiens
gtagaaactgaaaatttaraagaaagagtagctgtggtga

SEQ ID NO: 350 - DNA, 41 bp, Homo sapiens
tctgtgatccgtaagygatacaacttgacctcacaagacgt

SEQ ID NO: 351 - DNA, 39 bp, Homo sapiens
cctgacttctccctacastggggggactgcaccgttttc

SEQ ID NO: 352 - DNA, 37 bp, Homo sapiens
tataaacgattttctccktaaaacaagtctcaaagaa

SEQ ID NO: 353 - DNA, 36 bp, Homo sapiens
gagtactcacccttgtaygaataactcctgtacctt

SEQ ID NO: 354 - DNA, 37 bp, Homo sapiens
catcttcaaacagttccaytatttatgtctggtgcac

SEQ ID NO: 355 - DNA, 40 bp, Homo sapiens
ctgactgctcatgagccccygctgctctatgacctgtcca

SEQ ID NO: 356 - DNA, 33 bp, Homo sapiens
ttcttccgcctgttccrtgtcatgaggctgatc

SEQ ID NO: 357 - DNA, 33 bp, Homo sapiens
ttcttccgcctgttcsgtgtcatgaggctgatc

SEQ ID NO: 358 - DNA, 40 bp, Homo sapiens
gagacatggtttgattcctacractgttccaaatttgtgt

SEQ ID NO: 359 - DNA, 37 bp, Homo sapiens
gtggtcttggacacaaccatgyggggtggccgcctgg

SEQ ID NO: 360 - DNA, 39 bp, Homo sapiens
gctgcaatgtctcttcctmcccaggccgcaatgcccggg

SEQ ID NO: 361 - DNA, 39 bp, Homo sapiens
tcctgttcatcctggtggtggmggctgtgacgctctgcc

SEQ ID NO: 362 - DNA, 40 bp, Homo sapiens
gcctctggtcggggccgamgtctgcggcttcctgggcaac

SEQ ID NO: 363 - DNA, 40 bp, Homo sapiens
ccagtcagaagaacgaccyggacgcagtggcactgatgca

SEQ ID NO: 364 - DNA, 39 bp, Homo sapiens
cctgaaggctggacayggaagcttaagcaaaggaaatct

SEQ ID NO: 365 - DNA, 39 bp, Homo sapiens
ctaatgattttgacttcayggtaactgggagagggagcc

SEQ ID NO: 366 - DNA, 38 bp, Homo sapiens
gtactccccatcaagaagygcaagacccgggagacggt

SEQ ID NO: 367 - DNA, 40 bp, Homo sapiens
tacagagtttacttgtggttwagacttcagtcttcagagc

SEQ ID NO: 368 - DNA, 35 bp, Homo sapiens
actcggccgccttggtgagcygcaccttcctgtcg

SEQ ID NO: 369 - DNA, 36 bp, Homo sapiens
ctcggccgccttggtgagccrcaccttcctgtcggt

SEQ ID NO: 370 - DNA, 36 bp, Homo sapiens
cttcgtcaacagtgccatcygttacctggagggcca

SEQ ID NO: 371 - DNA, 36 bp, Homo sapiens
ggcccacgcctaccgcctctmcttctcccagcagac

SEQ ID NO: 372 - DNA, 36 bp, Homo sapiens
tggcccacgcctaccgcctctrcttctcccagcaga

SEQ ID NO: 373 - DNA, 38 bp, Homo sapiens
gccttctcgcccaagttcrgggagctggtggcagagga

SEQ ID NO: 374 - DNA, 38 bp, Homo sapiens
gtgtggtggccaactcgraggagatcgccttctatggg

SEQ ID NO: 375 - DNA, 36 bp, Homo sapiens
aagagctccctgttccrgatcctgggtgggctctgg

SEQ ID NO: 376 - DNA, 36 bp, Homo sapiens
gcaagagctccctgttcyggatcctgggtgggctct

SEQ ID NO: 377 - DNA, 38 bp, Homo sapiens
ccccagcgcatgttctacatccygcagaggtaaggaag

SEQ ID NO: 378 - DNA, 38 bp, Homo sapiens
gtctgtgggctccctgcrtgaccaggtgatctacccgg

SEQ ID NO: 379 - DNA, 38 bp, Homo sapiens
cgtgaccaggtgatctaccyggactcagtggaggacat

SEQ ID NO: 380 - DNA, 38 bp, Homo sapiens
tgactggaaggacgtcctgtygggtggcgagaagcaga

SEQ ID NO: 381 - DNA, 38 bp, Homo sapiens
gacgtcctgtcgggtggcragaagcagagaatcggcat

SEQ ID NO: 382 - DNA, 36 bp, Homo sapiens
gcagatgccattgagcrgatcatgtcgtcgtacaag

SEQ ID NO: 383 - DNA, 36 bp, Homo sapiens
gctgcagatgccattgagyggatcatgtcgtcgtac

SEQ ID NO: 384 - DNA, 36 bp, Homo sapiens
cttcgtcaacagtgccatcmgttacctggagggcca

SEQ ID NO: 385 - DNA, 41 bp, Homo sapiens
acccaatggccaatatccrcaccttttctgcctgcctaggt

SEQ ID NO: 386 - DNA, 44 bp, Homo sapiens
ttacatggggatggggaatacraggtaagcatatcaccctagcc

SEQ ID NO: 387 - DNA, 40 bp, Homo sapiens
ttcaggcccttgtgtctakgtgtataagaatctcagaccc

SEQ ID NO: 388 - DNA, 40 bp, Homo sapiens
caagttcagcctgcccyaattgcctccaaatcctctggaa

SEQ ID NO: 389 - DNA, 42 bp, Homo sapiens
ttcccacattgtcacaggacygaatcgaccccttaaccctga

SEQ ID NO: 390 - DNA, 42 bp, Homo sapiens
attgtcacaggaccgaatcraccccttaaccctgaaggagat

SEQ ID NO: 391 - DNA, 44 bp, Homo sapiens
agatgctggagagcatccrgtgagaggctgccttccccttcata

SEQ ID NO: 392 - DNA, 40 bp, Homo sapiens
catcgagctgagcgccyagcctgtgggacttatccgggta

SEQ ID NO: 393 - DNA, 39 bp, Homo sapiens
aggtcctagtggtgrgcagcacccaagacagcctgcatg

SEQ ID NO: 394 - DNA, 40 bp, Homo sapiens
gctttggccggtacgggcggkaggacaacaccctcatcat

SEQ ID NO: 395 - DNA, 41 bp, Homo sapiens
acaacaccctcatcakgaccactcgaggtgagtggagtcag

SEQ ID NO: 396 - DNA, 39 bp, Homo sapiens
gaaactcaatgtgcccygaaagacccggctttacgtgga

SEQ ID NO: 397 - DNA, 39 bp, Homo sapiens
cgaaagacccggctttmcgtggatcagacactgcgagag

SEQ ID NO: 398 - DNA, 39 bp, Homo sapiens
ttacgtggatcagacactgygagagcgggaggctggcac

SEQ ID NO: 399 - DNA, 38 bp, Homo sapiens
agccccctgtccacgacagccygagagccactcaagct

SEQ ID NO: 400 - DNA, 35 bp, Homo sapiens
gtcctgtcctggggctgcwggtctgcttcctgtac

SEQ ID NO: 401 - DNA, 37 bp, Homo sapiens
tcctgtcctggggctgcyggtctgcttcctgtacaac

SEQ ID NO: 402 - DNA, 40 bp, Homo sapiens
cttgctggtgccagggcwcaactaccccctggagaccttt

SEQ ID NO: 403 - DNA, 39 bp, Homo sapiens
ggctcaactaccccctgkagacctttgtggagagtctca

SEQ ID NO: 404 - DNA, 43 bp, Homo sapiens
ggaaccaggccaaagagrtaaataaataacatgggagttggga

SEQ ID NO: 405 - DNA, 42 bp, Homo sapiens
catctatattctgagaagrtagccacatccgtggtctccggg

SEQ ID NO: 406 - DNA, 42 bp, Homo sapiens
acagtgtgttgtttattccasagagactccaagcaccccaag

SEQ ID NO: 407 - DNA, 41 bp, Homo sapiens
tggcttcacccacaagrtgcagcccccagcaagcagcagcc

SEQ ID NO: 408 - DNA, 40 bp, Homo sapiens
tctgggacccttctccacrgccatgcaccgggccttccag

SEQ ID NO: 409 - DNA, 39 bp, Homo sapiens
ccgctgcagggtctgkgaaggcggcgttgcaggtggccg

SEQ ID NO: 410 - DNA, 37 bp, Homo sapiens
tggggcccgagggacsgcaagttttgtgtacgaagcc

SEQ ID NO: 411 - DNA, 39 bp, Homo sapiens
cgaggtgcttctcagcyggaatggaggccgcctcctgga

SEQ ID NO: 412 - DNA, 40 bp, Homo sapiens
atttattatctttctttgscatttgcttagaggacttcat

SEQ ID NO: 413 - DNA, 39 bp, Homo sapiens
gtgtaggagctcttyagagttgctcttagaagcatactt

SEQ ID NO: 414 - DNA, 38 bp, Homo sapiens
atttcacagttgatgtgkgactactttttcaagtgtat

SEQ ID NO: 415 - DNA, 39 bp, Homo sapiens
tcacagttgatgtgtgactrctttttcaagtgtatgact

SEQ ID NO: 416 - DNA, 39 bp, Homo sapiens
gatcatagctggtcttgkgcttcagaaagatttttctgt

SEQ ID NO: 417 - DNA, 39 bp, Homo sapiens
gtcagaatgtaaaattkctcatatctagtgtgaaacaac

SEQ ID NO: 418 - DNA, 40 bp, Homo sapiens
atgtaaaattgctcatakctagtgtgaaacaaccagattt

SEQ ID NO: 419 - DNA, 40 bp, Homo sapiens
agatttagttagttaktatgcaggggtgaatggcatatca

SEQ ID NO: 420 - DNA, 40 bp, Homo sapiens
aggggtgaatggcatatyagtggttgagtgtttatcatca

SEQ ID NO: 421 - DNA, 39 bp, Homo sapiens
cttttcgcagtgtgaaatacytaacactgctttggtgaa

SEQ ID NO: 422 - DNA, 39 bp, Homo sapiens
aacaacatgaggatgcttyacatggagcacttaaaatgc

SEQ ID NO: 423 - DNA, 39 bp, Homo sapiens
taccagtgagctgtargttaccgaatatgggtacttccc

SEQ ID NO: 424 - DNA, 36 bp, Homo sapiens
gatcttgttacattactrtcttctcaattatgccaa

SEQ ID NO: 425 - DNA, 37 bp, Homo sapiens
gagatcttgttacattacyatcttctcaattatgcca

SEQ ID NO: 426 - DNA, 39 bp, Homo sapiens
tggtaagcagtcagacagktttggaatcagtaatgggta

SEQ ID NO: 427 - DNA, 39 bp, Homo sapiens
gggtaaataccagctactamcttcagttcttcagtgttt

SEQ ID NO: 428 - DNA, 39 bp, Homo sapiens
tagtgtaagtttgtgtcyttttctacaggtcccttcaga

SEQ ID NO: 429 - DNA, 39 bp, Homo sapiens
gaagttagtagaagaascagtacagctgcaatatcagaa

SEQ ID NO: 430 - DNA, 39 bp, Homo sapiens
cagtatctaataatcctgtgaycaaggaattgcagaatc

SEQ ID NO: 431 - DNA, 39 bp, Homo sapiens
tgcagaatcagcctgtgygaatagttctcattgagggtg

SEQ ID NO: 432 - DNA, 39 bp, Homo sapiens
aaggaattaatttggttayggccgtgctcactaacccag

SEQ ID NO: 433 - DNA, 39 bp, Homo sapiens
aggtcttccttggaggtgktgcagttgaatttttgtgtc

SEQ ID NO: 434 - DNA, 39 bp, Homo sapiens
ggctttctatttttgtastgttactggctaagtctttgg

SEQ ID NO: 435 - DNA, 41 bp, Homo sapiens
cccgaatggtggccatagggcsctacgacgggactcacccg

SEQ ID NO: 436 - DNA, 40 bp, Homo sapiens
gcatccagggtcttcyagagccccctggaatctgatgttt

SEQ ID NO: 437 - DNA, 39 bp, Homo sapiens
tcagcattaaccaggcagkcagctgtctgactgcaggcg

SEQ ID NO: 438 - DNA, 41 bp, Homo sapiens
actaatcttttggcttatgmtgtctacaataattcggattt

SEQ ID NO: 439 - DNA, 40 bp, Homo sapiens
ccctcttgcgattattgktggcaattgtgctctgcaaggt

SEQ ID NO: 440 - DNA, 41 bp, Homo sapiens
gtgtgactttgatggtgawggaaagaaagaggtatgtgggg

SEQ ID NO: 441 - DNA, 40 bp, Homo sapiens
gatctgaggattttgatatcygagtttttaaggaagatga

SEQ ID NO: 442 - DNA, 39 bp, Homo sapiens
cccatgtatggcagtygatttggttatgccctttccaat

SEQ ID NO: 443 - DNA, 40 bp, Homo sapiens
ttggagtttatgacaaaacatccygatactggagaattaa

SEQ ID NO: 444 - DNA, 40 bp, Homo sapiens
ttgatgctcgaagtgacygaactggggaggtcatctttaa

SEQ ID NO: 445 - DNA, 42 bp, Homo sapiens
ggttttttccttctgttcagtccrgggctacctgcctggcac

SEQ ID NO: 446 - DNA, 42 bp, Homo sapiens
ggttttttccttctgttcagtcyggggctacctgcctggcac

SEQ ID NO: 447 - DNA, 38 bp, Homo sapiens
gaagaagcagaatctgtkgctggaactccgtaactatg

SEQ ID NO: 448 - DNA, 40 bp, Homo sapiens
ctgcagacaccatcatcygagcagtattgatttttgcaga

SEQ ID NO: 449 - DNA, 40 bp, Homo sapiens
ggtagatcactataaataytgatgatattgatttggctgg

SEQ ID NO: 450 - DNA, 35 bp, Homo sapiens
aaaacaatgaagagtcrttatatggaactctatga

SEQ ID NO: 451 - DNA, 37 bp, Homo sapiens
gcacaatgccctgaatcttmataggcacgatctgact

SEQ ID NO: 452 - DNA, 39 bp, Homo sapiens
cagctgcctgaaacsagccaactacttggcaccctttga

SEQ ID NO: 453 - DNA, 39 bp, Homo sapiens
gtatgcatcagcttttcattttcycagtgcggccatcaa

SEQ ID NO: 454 - DNA, 40 bp, Homo sapiens
tggctctgaccaatckggaagatatagaaaatgccaagag

SEQ ID NO: 455 - DNA, 41 bp, Homo sapiens
caagagagcctacgcagaagmagtccacctggataagtatg

SEQ ID NO: 456 - DNA, 44 bp, Homo sapiens
agaagcagtccacctggrtaagtatgcactttgttgagaatggt

SEQ ID NO: 457 - DNA, 39 bp, Homo sapiens
caaccagcaaacctgccaktttccagcagcctctgggct

SEQ ID NO: 458 - DNA, 39 bp, Homo sapiens
cctctggagccagagcytgcggtggaatcaagtccaact

SEQ ID NO: 459 - DNA, 43 bp, Homo sapiens
agcatttttctccctctttcrggctgttatcaaagaacagctt

SEQ ID NO: 460 - DNA, 43 bp, Homo sapiens
gaatatgctatctatgtccaagstaagacacatacttcttgtt

SEQ ID NO: 461 - DNA, 42 bp, Homo sapiens
ccttcttttttatgagcctmggagatcagccataacctagga

SEQ ID NO: 462 - DNA, 43 bp, Homo sapiens
ttttggattttagctgtcrgttacaattgcatattgaatatta

SEQ ID NO: 463 - DNA, 39 bp, Homo sapiens
tttaggaaccttttttattrccaatgtgagaattgtgtg

SEQ ID NO: 464 - DNA, 40 bp, Homo sapiens
aggaaccttttttattaccartgtgagaattgtgtggcat

SEQ ID NO: 465 - DNA, 42 bp, Homo sapiens
ggaatttatccagtgatcaggtrttgtgcaaagagctagtga

SEQ ID NO: 466 - DNA, 40 bp, Homo sapiens
ctttacccgggccgaagwttgcaaggctggaactgggagg

SEQ ID NO: 467 - DNA, 39 bp, Homo sapiens
gagaagaccttttgtttgggayatcagacggaaaacttg

SEQ ID NO: 468 - DNA, 39 bp, Homo sapiens
gacaacagagcccattcrtaaggaaagtggaccaggaga

SEQ ID NO: 469 - DNA, 44 bp, Homo sapiens
attactattttaatgttctcrggcacatatctggctcagacctc

SEQ ID NO: 470 - DNA, 41 bp, Homo sapiens
gcctgcaatatgacctatrgatcatttggtggtgtaaaagg

SEQ ID NO: 471 - DNA, 40 bp, Homo sapiens
tgagtgatgatggtcacttgyagtgttcatacctggggac

SEQ ID NO: 472 - DNA, 45 bp, Homo sapiens
cttaatttttttctctcagaaygatatcgcattcagagtgaacaa

SEQ ID NO: 473 - DNA, 43 bp, Homo sapiens
caagtggaaagttataastaagtttggatgttaagtcttcaga

SEQ ID NO: 474 - DNA, 41 bp, Homo sapiens
gaagacactcaagaattgrtaaggacctgaaagcctgtggt

SEQ ID NO: 475 - DNA, 37 bp, Homo sapiens
cgggaggcagaccatcagyctcctggccactgtacac

SEQ ID NO: 476 - DNA, 38 bp, Homo sapiens
gctgaccgtggtaactatcrtatacaagtctttacccg

SEQ ID NO: 477 - DNA, 38 bp, Homo sapiens
ctggccagtttgtagtaaccratgtggaaggtggaaag

SEQ ID NO: 478 - DNA, 41 bp, Homo sapiens
gttaccacctgaagtaagakgtctcgtttggaagctaagaa

SEQ ID NO: 479 - DNA, 40 bp, Homo sapiens
cactttctgtcttgaaaagaatkgtaacatcatgctatgg

SEQ ID NO: 480 - DNA, 39 bp, Homo sapiens
aggttacgtgtgtacarcctcacagtcctcagctctgct

SEQ ID NO: 481 - DNA, 39 bp, Homo sapiens
gtctgagacctgtggttgtygaatcccagtggactttag

SEQ ID NO: 482 - DNA, 39 bp, Homo sapiens
agtggactttagtagtactyagatcctcctttgtttggt

SEQ ID NO: 483 - DNA, 40 bp, Homo sapiens
atcctcctttgtttggtgcktagtatattaacaagtaaac

SEQ ID NO: 484 - DNA, 39 bp, Homo sapiens
cagtgctttgatcctgagascctttttgcttacaattcc

SEQ ID NO: 485 - DNA, 39 bp, Homo sapiens
gctattacctatcaaaaaaycaactgccctcaaggtggc

SEQ ID NO: 486 - DNA, 39 bp, Homo sapiens
tattacctatcaaaaaatcamctgccctcaaggtggcac

SEQ ID NO: 487 - DNA, 39 bp, Homo sapiens
actgtggtggtcagttawggggtttctcttgaaaatgca

SEQ ID NO: 488 - DNA, 39 bp, Homo sapiens
cagtcttggaccagctgcytaacctaggaaggcagctaa

SEQ ID NO: 489 - DNA, 40 bp, Homo sapiens
ggaaggcagctaatcagtgmccacgtagatcttgtcctgt

SEQ ID NO: 490 - DNA, 40 bp, Homo sapiens
tattggatccctaggctcartatgtcctaatagttatgga

SEQ ID NO: 491 - DNA, 40 bp, Homo sapiens
aatatgtcctaatagttatgraagtgtgaaagatgtgtgc

SEQ ID NO: 492 - DNA, 40 bp, Homo sapiens
cctagaatctgttgttggcyctttagaacatgatggaggt

SEQ ID NO: 493 - DNA, 38 bp, Homo sapiens
tgaagtatggacacctttggtsagttcaggcagattct

SEQ ID NO: 494 - DNA, 39 bp, Homo sapiens
cctgtgttgctaactggccaratttgctttcacagtgtg

SEQ ID NO: 495 - DNA, 36 bp, Homo sapiens
gctttcacagtgtggctstggattatacaatagcca

SEQ ID NO: 496 - DNA, 38 bp, Homo sapiens
gccaggaagaactcaactggkctttcttaagaagcaca

SEQ ID NO: 497 - DNA, 38 bp, Homo sapiens
cttaagaagcacacgtcrtccatttgtgccacaaagct

SEQ ID NO: 498 - DNA, 39 bp, Homo sapiens
tagataatagtggcaaaasgacgatcattaacaaactta

SEQ ID NO: 499 - DNA, 39 bp, Homo sapiens
gataatagtggcaaaaygacgatcattaacaaacttaaa

SEQ ID NO: 500 - DNA, 42 bp, Homo sapiens
ttttagatattaaacaccgtygaattccaatcttattctttg

SEQ ID NO: 501 - DNA, 40 bp, Homo sapiens
atgccataaaaggagaagscttgcaagaaggtgtagactg

SEQ ID NO: 502 - DNA, 37 bp, Homo sapiens
ccataaaaggagaaggctkgcaagaaggtgtagactg

SEQ ID NO: 503 - DNA, 42 bp, Homo sapiens
cctagccaggccgttagrtatgtacttctgcttcataacctc

SEQ ID NO: 504 - DNA, 42 bp, Homo sapiens
agatttgtcaggctgggaacgrtaaattctatcagctttccc

SEQ ID NO: 505 - DNA, 43 bp, Homo sapiens
agaaacctaagttggcaaagrtatgtacttaaaatgattttga

SEQ ID NO: 506 - DNA, 37 bp, Homo sapiens
gcgaaagcgccttgaggcctytcttacccagaagcag

SEQ ID NO: 507 - DNA, 38 bp, Homo sapiens
tgggagaactgaaggatgacractttgagaagatcagt

SEQ ID NO: 508 - DNA, 36 bp, Homo sapiens
catgagtgcaactctcmgtacatcgtgggcttctat

SEQ ID NO: 509 - DNA, 35 bp, Homo sapiens
catgagtgcaactctcygtacatcgtgggcttcta

SEQ ID NO: 510 - DNA, 37 bp, Homo sapiens
actctccgtacatcgtggkcttctatggtgcgttcta

SEQ ID NO: 511 - DNA, 38 bp, Homo sapiens
ccgtacatcgtgggcttctrtggtgcgttctacagcga

SEQ ID NO: 512 - DNA, 37 bp, Homo sapiens
ctagtcaactcccgtgggsagatcaagctctgtgact

SEQ ID NO: 513 - DNA, 36 bp, Homo sapiens
agaagcggctggaagcctktctcacccagaaagcca

SEQ ID NO: 514 - DNA, 37 bp, Homo sapiens
gaagcggctggaagccttwctcacccagaaagccaag

SEQ ID NO: 515 - DNA, 36 bp, Homo sapiens
gaagaagcggctggaagcckttctcacccagaaagc

SEQ ID NO: 516 - DNA, 36 bp, Homo sapiens
gaagcctttctcacccagraagccaaggtcggcgaa

SEQ ID NO: 517 - DNA, 37 bp, Homo sapiens
tggaagcctttctcacccagamagccaaggtcggcga

SEQ ID NO: 518 - DNA, 37 bp, Homo sapiens
agcctttctcacccagaaasccaaggtcggcgaactc

SEQ ID NO: 519 - DNA, 38 bp, Homo sapiens
ctgcacgaatgcaactcgcsgtacatcgtgggcttcta

SEQ ID NO: 520 - DNA, 38 bp, Homo sapiens
cgccgtacatcgtggkcttctacggggccttctacagt

SEQ ID NO: 521 - DNA, 38 bp, Homo sapiens
cgccgtacatcgtgggcttcyacggggccttctacagt

SEQ ID NO: 522 - DNA, 37 bp, Homo sapiens
cccccgcccgacgccaragagctggaggccatctttg

SEQ ID NO: 523 - DNA, 39 bp, Homo sapiens
cttgtggtagttggagctrgtggcgtaggcaagagtgcc

SEQ ID NO: 524 - DNA, 40 bp, Homo sapiens
aagagtgccttgacgatasagctaattcagaatcattttg

SEQ ID NO: 525 - DNA, 43 bp, Homo sapiens
attttgtggacgaatatgatcsaacaatagaggtaaatcttgt

SEQ ID NO: 526 - DNA, 40 bp, Homo sapiens
atattctcgacacagcasgtcaagaggagtacagtgcaat

SEQ ID NO: 527 - DNA, 39 bp, Homo sapiens
gtacgaaaaacgtttttcmccttagcattttgtgacttt

SEQ ID NO: 528 - DNA, 39 bp, Homo sapiens
gaaaaacgtttttcaccttascattttgtgacttttgtc

SEQ ID NO: 529 - DNA, 37 bp, Homo sapiens
tcgaaagctgcttttccrgggtttccgctgtcaaaca

SEQ ID NO: 530 - DNA, 37 bp, Homo sapiens
gtcgaaagctgcttttcmagggtttccgctgtcaaac

SEQ ID NO: 531 - DNA, 36 bp, Homo sapiens
tccagggtttccgctgtcraacatgtggttataaat

SEQ ID NO: 532 - DNA, 38 bp, Homo sapiens
tccagggtttccgctgtmaaacatgtggttataaattt

SEQ ID NO: 533 - DNA, 39 bp, Homo sapiens
cagtgggacaaagaattsgatctggatcatttggaacag

SEQ ID NO: 534 - DNA, 39 bp, Homo sapiens
aaagaattggatctggakcatttggaacagtctacaagg

SEQ ID NO: 535 - DNA, 40 bp, Homo sapiens
aagaattggatctggatcatytggaacagtctacaaggga

SEQ ID NO: 536 - DNA, 40 bp, Homo sapiens
ttggatctggatcatttgraacagtctacaagggaaagtg

SEQ ID NO: 537 - DNA, 39 bp, Homo sapiens
tgtggcagtgaaaatgttsaatgtgacagcacctacacc

SEQ ID NO: 538 - DNA, 38 bp, Homo sapiens
gcagtgaaaatgttgaatgkgacagcacctacacctca

SEQ ID NO: 539 - DNA, 37 bp, Homo sapiens
gcagttacaagccttcaamaatgaagtaggagtactc

SEQ ID NO: 540 - DNA, 38 bp, Homo sapiens
cctcagcagttacaagccttcraaaatgaagtaggagt

SEQ ID NO: 541 - DNA, 39 bp, Homo sapiens
tacaagccttcaaaaatgragtaggagtactcaggtgag

SEQ ID NO: 542 - DNA, 38 bp, Homo sapiens
ttacaagccttcaaaaatraagtaggagtactcaggtg

SEQ ID NO: 543 - DNA, 38 bp, Homo sapiens
gttacaagccttcaaaaatgwagtaggagtactcaggt

SEQ ID NO: 544 - DNA, 40 bp, Homo sapiens
ctattccacaaagccacaacyggctattgttacccagtgg

SEQ ID NO: 545 - DNA, 39 bp, Homo sapiens
attgttacccagtggtgtgagsgctccagcttgtatcac

SEQ ID NO: 546 - DNA, 44 bp, Homo sapiens
ccacagagacctcaagagtratagtatccttcctgaaatttgtc

SEQ ID NO: 547 - DNA, 34 bp, Homo sapiens
aaaaataggtgatttwggtctagctacagtgaaa

SEQ ID NO: 548 - DNA, 35 bp, Homo sapiens
gtaaaaataggtgatttkggtctagctacagtgaa

SEQ ID NO: 549 - DNA, 39 bp, Homo sapiens
aaaaataggtgattttgktctagctacagtgaaatctcg

SEQ ID NO: 550 - DNA, 41 bp, Homo sapiens
catacagctttcagtcagawgtatatgcatttggaattgtt

SEQ ID NO: 551 - DNA, 41 bp, Homo sapiens
cttacaggagcccaggctygtgtgctcgtgttctctaccac

SEQ ID NO: 552 - DNA, 39 bp, Homo sapiens
ctggcaaaaaggttaaagtwaagattctacagaacatca

SEQ ID NO: 553 - DNA, 45 bp, Homo sapiens
atgccaagggagacagcygatacatcctgtaagtgtttgcctctg

SEQ ID NO: 554 - DNA, 41 bp, Homo sapiens
tttcgccgggcgcgatrgagccggggcgccggggggccgcg

SEQ ID NO: 555 - DNA, 39 bp, Homo sapiens
gttctggaatgcaaaatayagtgtgaagagaacctcacc

SEQ ID NO: 556 - DNA, 36 bp, Homo sapiens
gcagttcgcttacttcaagscaagtccgcctcgccc

SEQ ID NO: 557 - DNA, 37 bp, Homo sapiens
agataatgaatgacacacagstgggtcccccgaggat

SEQ ID NO: 558 - DNA, 39 bp, Homo sapiens
gcatcatggagtcctamttccgcctggatacgcccctct

SEQ ID NO: 559 - DNA, 38 bp, Homo sapiens
ccagatccatcggcccccgtgagktgagagacttcctt

SEQ ID NO: 560 - DNA, 38 bp, Homo sapiens
gcagagactgaccaatktaagggaagcccagtgactgc

SEQ ID NO: 561 - DNA, 40 bp, Homo sapiens
gctcaaaggctacgactrgacgctggtgcccatgccggtg

SEQ ID NO: 562 - DNA, 39 bp, Homo sapiens
ccgcacgtcaagcggcycatgaacgccttcatggtgtgg

SEQ ID NO: 563 - DNA, 37 bp, Homo sapiens
gcggcccatgaacgccytcatggtgtgggcgcaggcg

SEQ ID NO: 564 - DNA, 37 bp, Homo sapiens
gcggcccatgaacgcctycatggtgtgggcgcaggcg

SEQ ID NO: 565 - DNA, 39 bp, Homo sapiens
cttcatggtgtgggcgyaggcggcgcgcaggaagctcgc

SEQ ID NO: 566 - DNA, 39 bp, Homo sapiens
ggtgtgggcgcaggcggygcgcaggaagctcgcggacca

SEQ ID NO: 567 - DNA, 39 bp, Homo sapiens
caagacgctgggcaagctcyggaggtaggacccggcggg

SEQ ID NO: 568 - DNA, 39 bp, Homo sapiens
cccgagcagacttctgaackagagcgagaagcggccctt

SEQ ID NO: 569 - DNA, 39 bp, Homo sapiens
ttctgaacgagagcgagaagcsgcccttcgtggaggagg

SEQ ID NO: 570 - DNA, 39 bp, Homo sapiens
gagcggctgcgcgtgcagyacaagaaggaccacccggat

SEQ ID NO: 571 - DNA, 39 bp, Homo sapiens
cacaagaaggaccaccsggattacaagtaccagccgcgg

SEQ ID NO: 572 - DNA, 39 bp, Homo sapiens
ggcagaggaggccacggagyagacgcacatctcccccaa

SEQ ID NO: 573 - DNA, 39 bp, Homo sapiens
agccggcggcacccccgyagcagccacaggcgcacacgc

SEQ ID NO: 574 - DNA, 39 bp, Homo sapiens
gaacgcacatcaagacgkagcagctgagccccagccact

SEQ ID NO: 575 - DNA, 39 bp, Homo sapiens
ccatcacccgctcacagtasgactacaccgaccaccaga

SEQ ID NO: 576 - DNA, 38 bp, Homo sapiens
cccgccccgccccgagcmgacttctgaacgagagcgag

SEQ ID NO: 577 - DNA, 38 bp, Homo sapiens
ccccggcgagcactcggrtgagtcgcccctcgacccca

SEQ ID NO: 578 - DNA, 41 bp, Homo sapiens
ccccgtcctcctggactrgcatccgaaatactactcagttt

SEQ ID NO: 579 - DNA, 40 bp, Homo sapiens
accaaggggaaggcctgargttcgtggacggcatcgtgga

SEQ ID NO: 580 - DNA, 40 bp, Homo sapiens
tctccgtgtccaacttcrtggacaacctttacggctaccc

SEQ ID NO: 581 - DNA, 40 bp, Homo sapiens
tacaaaaaggacaagaggygccatgagactcacaggcgcc

SEQ ID NO: 582 - DNA, 41 bp, Homo sapiens
acaatatccttttgaagaccrtaacccaccacagctagaac

SEQ ID NO: 583 - DNA, 40 bp, Homo sapiens
gggaagacaagttcatgtactytgagttccctcagccgtt

SEQ ID NO: 584 - DNA, 40 bp, Homo sapiens
ccgttacctgtgtgtggtgrtatcaaagtagagttcttcc

SEQ ID NO: 585 - DNA, 40 bp, Homo sapiens
taacaaaaaatgatcttracaaagcaaataaagacaaagc

SEQ ID NO: 586 - DNA, 40 bp, Homo sapiens
acaaccctgagacccgcygtaaaacactggtggcactctt

SEQ ID NO: 587 - DNA, 39 bp, Homo sapiens
aaggcggccacgtcagaggstgtgcaggtgaaaagggtc

SEQ ID NO: 588 - DNA, 36 bp, Homo sapiens
accaccactcagagtcccsaaaggcccccgtgccac

SEQ ID NO: 589 - DNA, 38 bp, Homo sapiens
cccaaatctcccaaagytccaggaactggcagaggccg

SEQ ID NO: 590 - DNA, 35 bp, Homo sapiens
accaccactcagagtccycaaaggcccccgtgcca

SEQ ID NO: 591 - DNA, 38 bp, Homo sapiens
cgaggaccccaccagccyccctgagccccaggacttga

SEQ ID NO: 592 - DNA, 40 bp, Homo sapiens
tctcaagcaggaaaacawtgtggagttgaaggaagcattt

SEQ ID NO: 593 - DNA, 39 bp, Homo sapiens
tttttatcttgacactccrgatataaaaccagaaaatct

SEQ ID NO: 594 - DNA, 38 bp, Homo sapiens
accagcattcgatccatgstgagcattttggtttgttt

SEQ ID NO: 595 - DNA, 40 bp, Homo sapiens
gtaaaaagctacatctatyagctaatcaaggctattcact

SEQ ID NO: 596 - DNA, 39 bp, Homo sapiens
cttaaatgcagacacaagkcaagtacattatttttaaaa

SEQ ID NO: 597 - DNA, 38 bp, Homo sapiens
gaacattcagagttctccragcattgaaaacaatttca

SEQ ID NO: 598 - DNA, 39 bp, Homo sapiens
cttggtattggccatcatcrtcttcatttttgctgtggt

SEQ ID NO: 599 - DNA, 38 bp, Homo sapiens
atgatgataacgaaatgaawaatctccagattgctgtg

SEQ ID NO: 600 - DNA, 38 bp, Homo sapiens
tgataacgaaatgaataatmtccagattgctgtgggaa

SEQ ID NO: 601 - DNA, 37 bp, Homo sapiens
cactgagagctttgtcccrgtttgaaggaatgagggt

SEQ ID NO: 602 - DNA, 38 bp, Homo sapiens
ggttgttgtaaatgctyttttaggagccattccatcta

SEQ ID NO: 603 - DNA, 38 bp, Homo sapiens
caagaaatgacaaacattstgtactggattaatctggt

SEQ ID NO: 604 - DNA, 38 bp, Homo sapiens
gtggccatggcctatgagsaacagaatcaggccacatt

SEQ ID NO: 605 - DNA, 37 bp, Homo sapiens
tcactattggatggaatakttttgattttgtggtggt

SEQ ID NO: 606 - DNA, 37 bp, Homo sapiens
tacgaccacgttgaaaygcaaacaagaggaggtgtct

SEQ ID NO: 607 - DNA, 38 bp, Homo sapiens
ctcccgccaggcaccatkgtgcagaagtcgcgcaacgg

SEQ ID NO: 608 - DNA, 38 bp, Homo sapiens
ctcccgccaggcaccayggtgcagaagtcgcgcaacgg

SEQ ID NO: 609 - DNA, 38 bp, Homo sapiens
gcctcccgccaggcaccrtggtgcagaagtcgcgcaac

SEQ ID NO: 610 - DNA, 38 bp, Homo sapiens
aacgtctttgccacatctgygctccggagcctgcgctt

SEQ ID NO: 611 - DNA, 39 bp, Homo sapiens
tgcgcttcctgcagattctgyggatgatccgcatggacc

SEQ ID NO: 612 - DNA, 39 bp, Homo sapiens
gcttcctgcagattctgcggrtgatccgcatggaccggc

SEQ ID NO: 613 - DNA, 39 bp, Homo sapiens
cggatgatccgcatggacyggcggggaggcacctggaag

SEQ ID NO: 614 - DNA, 39 bp, Homo sapiens
atgatccgcatggaccggyggggaggcacctggaagctg

SEQ ID NO: 615 - DNA, 39 bp, Homo sapiens
gctctgtggtctatgcccamagcaaggtgagtcacggcc

SEQ ID NO: 616 - DNA, 39 bp, Homo sapiens
tacatcggcttcctttgtytcatcctggcctcgttcctg

SEQ ID NO: 617 - DNA, 39 bp, Homo sapiens
cctttgtctcatcctggcctsgttcctggtgtacttggc

SEQ ID NO: 618 - DNA, 39 bp, Homo sapiens
cctggcctcgttcctggkgtacttggcagagaaggggga

SEQ ID NO: 619 - DNA, 39 bp, Homo sapiens
cttggcagagaagggggagarcgaccactttgacaccta

SEQ ID NO: 620 - DNA, 39 bp, Homo sapiens
cacctacgcggatgcactctgrtggggcctggtgagttg

SEQ ID NO: 621 - DNA, 39 bp, Homo sapiens
cattggctacggggacaagtrcccccagacctggaacgg

SEQ ID NO: 622 - DNA, 39 bp, Homo sapiens
ggaacggcaggctccttgsggcaaccttcaccctcatcg

SEQ ID NO: 623 - DNA, 39 bp, Homo sapiens
ctcatcggtgtctccttcttcrcgctgcctgcagtaagt

SEQ ID NO: 624 - DNA, 39 bp, Homo sapiens
cctgaaggttcaggagyagcacaggcagaagcactttga

SEQ ID NO: 625 - DNA, 36 bp, Homo sapiens
agcactttgagaagaggcrgaacccggcagcaggcc

SEQ ID NO: 626 - DNA, 36 bp, Homo sapiens
gcactttgagaagaggyggaacccggcagcaggcct

SEQ ID NO: 627 - DNA, 39 bp, Homo sapiens
gaacccggcagcaggcckgatccaggtgagtccaggtgt

SEQ ID NO: 628 - DNA, 39 bp, Homo sapiens
ctacgccaccaacctctcgsgcacagacctgcactccac

SEQ ID NO: 629 - DNA, 39 bp, Homo sapiens
tcgtgtcttctccagccccygaggcgtggctgccaaggg

SEQ ID NO: 630 - DNA, 38 bp, Homo sapiens
gcggttcctggtgtccaagcrgaagttcaaggagagcc

SEQ ID NO: 631 - DNA, 38 bp, Homo sapiens
tcctggtgtccaagcggaakttcaaggagagcctgcgg

SEQ ID NO: 632 - DNA, 39 bp, Homo sapiens
ccacctggacatgctgtccygaattaagagcctgcagtc

SEQ ID NO: 633 - DNA, 38 bp, Homo sapiens
tcttgtccatggagaagaagckggacttcctggtgaat

SEQ ID NO: 634 - DNA, 37 bp, Homo sapiens
tcatctaccacgcctacgtrtgagtggccggcggggc

SEQ ID NO: 635 - DNA, 38 bp, Homo sapiens
cggtcaccgtgcccatgtacagrtaccgccgccgggca

SEQ ID NO: 636 - DNA, 38 bp, Homo sapiens
aacctacggggcctccaggkaggaaatgcatggacaga

SEQ ID NO: 637 - DNA, 37 bp, Homo sapiens
tgtctccttccccccagaascaagcctccccggagag

SEQ ID NO: 638 - DNA, 37 bp, Homo sapiens
tcagcatcagagccgtgtgrtgaggcccctgcccagc

SEQ ID NO: 639 - DNA, 35 bp, Homo sapiens
ctttggggtctctgttccmggtagagtggaccaga

SEQ ID NO: 640 - DNA, 35 bp, Homo sapiens
gggtctctgttcccggtaragtggaccagatcgtg

SEQ ID NO: 641 - DNA, 35 bp, Homo sapiens
ggggtctctgttcccggtakagtggaccagatcgt

SEQ ID NO: 642 - DNA, 34 bp, Homo sapiens
agcccagcagccccttttgcrggtcttgtccatg

SEQ ID NO: 643 - DNA, 39 bp, Homo sapiens
gaaggatatgacaataaacttcrgcctgatataggaggt

SEQ ID NO: 644 - DNA, 38 bp, Homo sapiens
ctgagaatttggaatgatggtsgagtgctctacaccct

SEQ ID NO: 645 - DNA, 38 bp, Homo sapiens
cccggaaatcgctccccawggtctcctatgtcacagcg

SEQ ID NO: 646 - DNA, 38 bp, Homo sapiens
ccgcccaagatcagcaaccattyaaatgaataatgcta

SEQ ID NO: 647 - DNA, 38 bp, Homo sapiens
aagattgtcgaacaggagcttgragacatgggaggata

SEQ ID NO: 648 - DNA, 38 bp, Homo sapiens
cctcatcatcccctgcctgctcawctcctgcctcactg

SEQ ID NO: 649 - DNA, 38 bp, Homo sapiens
ggcgagaagatcacgctgtgcatctycgtgctgctgtc

SEQ ID NO: 650 - DNA, 38 bp, Homo sapiens
tcaccgtcttcctgctgctcatcaycgagatcatcccg

SEQ ID NO: 651 - DNA, 35 bp, Homo sapiens
tcctgctgctcatctccaagatcstgcctcccacc

SEQ ID NO: 652 - DNA, 35 bp, Homo sapiens
ctgctgctcatctccaagatcrtgcctcccacctc

SEQ ID NO: 653 - DNA, 38 bp, Homo sapiens
gtgccgctcgtcggcaagtacstcatgttcaccatggt

SEQ ID NO: 654 - DNA, 38 bp, Homo sapiens
ctcatgttcaccatggtgcttgycaccttctccatcgt

SEQ ID NO: 655 - DNA, 38 bp, Homo sapiens
catggtgcttgtcaccttctccatsgtcaccagcgtgt

SEQ ID NO: 656 - DNA, 41 bp, Homo sapiens
cgtcgccgccaagatgatgtgcsgggcgccctccgccacgc

SEQ ID NO: 657 - DNA, 40 bp, Homo sapiens
tcaagagccaggtggtcgcggrgacaaactacttcatcaa

SEQ ID NO: 658 - DNA, 40 bp, Homo sapiens
cgacgaggacttcgtacacctgygagtgttccaatctctc

SEQ ID NO: 659 - DNA, 37 bp, Homo sapiens
ccctccgtcgccgccaasatgatgtgcggggcgccag

SEQ ID NO: 660 - DNA, 37 bp, Homo sapiens
tcgctcactccgctctcttcccargtgcacgtcggcg

SEQ ID NO: 661 - DNA, 37 bp, Homo sapiens
cttcgctcactccgctctcttcccrggtgcacgtcgg

SEQ ID NO: 662 - DNA, 40 bp, Homo sapiens
cgccgcccgccatgcgcttccgctytggggtggtggtgcc

SEQ ID NO: 663 - DNA, 39 bp, Homo sapiens
cccggccggagctgctggtggtggggycgcggcccgagc

SEQ ID NO: 664 - DNA, 39 bp, Homo sapiens
gctgctggtggtggggtcgcggcccragctggggcgttg

SEQ ID NO: 665 - DNA, 39 bp, Homo sapiens
tcgcggcccgagctggggcgtkgggagccgcgcggtgcc

SEQ ID NO: 666 - DNA, 39 bp, Homo sapiens
ggcgacggggccctggccctgyaggagccgggcctgtgg

SEQ ID NO: 667 - DNA, 39 bp, Homo sapiens
ctggccctgcaggagccgggcctgtrgctcggggaggtg

SEQ ID NO: 668 - DNA, 39 bp, Homo sapiens
ggagccgggccgcgtggacacgttstggtacaagttcct

SEQ ID NO: 669 - DNA, 39 bp, Homo sapiens
gtggacacgttctggtasaagttcctgaagcgggagccg

SEQ ID NO: 670 - DNA, 39 bp, Homo sapiens
cgtggacacgttctggtacaagytcctgaagcgggagcc

SEQ ID NO: 671 - DNA, 39 bp, Homo sapiens
cacgttctggtacaagttcctgaagcsggagccgggagg

SEQ ID NO: 672 - DNA, 39 bp, Homo sapiens
aggcaatggacctcatcatgacygttgctgtacttacaa

SEQ ID NO: 673 - DNA, 39 bp, Homo sapiens
gattgaggccactgggcacaccaatkaaatgaagcacac

SEQ ID NO: 674 - DNA, 39 bp, Homo sapiens
ttagaattctaccaaatatctgrctgggtagctgccctc

SEQ ID NO: 675 - DNA, 39 bp, Homo sapiens
aatatctggctgggtagctgccctcrtcaggtggaacat

SEQ ID NO: 676 - DNA, 39 bp, Homo sapiens
aactgaagcatgaattggggattrcagctgtaatgaatt

SEQ ID NO: 677 - DNA, 39 bp, Homo sapiens
agcatgaattggggattacagstgtaatgaatttccaga

SEQ ID NO: 678 - DNA, 39 bp, Homo sapiens
ctgtaatgaatttccagaytgaatgggatattgtacaga

SEQ ID NO: 679 - DNA, 39 bp, Homo sapiens
acaccagatatgagcaccgaargtaaggatcagaactgt

SEQ ID NO: 680 - DNA, 38 bp, Homo sapiens
tgctgtgctttccccaccgcaggcygagtacagatgct

SEQ ID NO: 681 - DNA, 39 bp, Homo sapiens
ccgctccaccgcggctgtctgmggctggctccagtatgt

SEQ ID NO: 682 - DNA, 38 bp, Homo sapiens
ggtgggccgctccaccgcggctgtctgcrgctggctcc

SEQ ID NO: 683 - DNA, 39 bp, Homo sapiens
gggctggaatctgaggaaggtgcwgtatttcctcatggc

SEQ ID NO: 684 - DNA, 39 bp, Homo sapiens
gggctggaatctgaggaaggtgcagwatttcctcatggc

SEQ ID NO: 685 - DNA, 39 bp, Homo sapiens
gtatttcctcatggccaagaggcyggctgtctacattga

SEQ ID NO: 686 - DNA, 39 bp, Homo sapiens
gggcacaccaatgaaatgaascacacaacagacttctat

SEQ ID NO: 687 - DNA, 39 bp, Homo sapiens
gaagcacacaacagacttctattttwatattgcaggcca

SEQ ID NO: 688 - DNA, 39 bp, Homo sapiens
gcaggccaccaagccatgcattattsaaggtaaaaatag

SEQ ID NO: 689 - DNA, 39 bp, Homo sapiens
ttcctcaggctgtaaccgctacccaragcccatgactcc

SEQ ID NO: 690 - DNA, 39 bp, Homo sapiens
gctgtctacattgacgaagaggcctkggcccgggcacaa

SEQ ID NO: 691 - DNA, 40 bp, Homo sapiens
gctcatgcgcgaggcggagatcmgcctgctcgagtgcaag

SEQ ID NO: 692 - DNA, 36 bp, Homo sapiens
ggagatcagcctgctcgagtgmaaggtgtgctttga

SEQ ID NO: 693 - DNA, 39 bp, Homo sapiens
gagtgcaaggtgtgctttgagaagtytggccaccggcag

SEQ ID NO: 694 - DNA, 37 bp, Homo sapiens
gcacccgcgcactctggccctcsagtgcccattctgc

SEQ ID NO: 695 - DNA, 36 bp, Homo sapiens
cgcacccgcgcactctggccctckagtgcccattct

SEQ ID NO: 696 - DNA, 40 bp, Homo sapiens
gcgcactctggccctcgagtrcccattctgcaggcgagct

SEQ ID NO: 697 - DNA, 40 bp, Homo sapiens
agcgactgcctgccggtgcygcacctcatagagctcctgg

SEQ ID NO: 698 - DNA, 39 bp, Homo sapiens
ctgccggtgctgcacctcataragctcctgggctcagcg

SEQ ID NO: 699 - DNA, 38 bp, Homo sapiens
cttcggcggctgggggacccyggtcaaccccaccggac

SEQ ID NO: 700 - DNA, 39 bp, Homo sapiens
ggctgggggaccctggtcaaccmcaccggactggcgctt

SEQ ID NO: 701 - DNA, 38 bp, Homo sapiens
cggggcgtgtcgtggtggtgcacracggcaggaggcgt

SEQ ID NO: 702 - DNA, 38 bp, Homo sapiens
cgacggcaggaggcgtgtcaagatktttgactcagggg

SEQ ID NO: 703 - DNA, 39 bp, Homo sapiens
gatttttgactcagggggaggaygcgcgcatcagtttgg

SEQ ID NO: 704 - DNA, 39 bp, Homo sapiens
tgccatgtggttgtcactgacgcckgcgatcgctccatc

SEQ ID NO: 705 - DNA, 38 bp, Homo sapiens
catgtggttgtcactgacgccggcratcgctccatcaa

SEQ ID NO: 706 - DNA, 38 bp, Homo sapiens
tcactgacgccggcgatcgctccawcaaagtgtttgat

SEQ ID NO: 707 - DNA, 39 bp, Homo sapiens
gcttgtcattggaggccaattctccttaycttggggtgt

SEQ ID NO: 708 - DNA, 36 bp, Homo sapiens
gaggccaattctccttacctyggggtgtggagacca

SEQ ID NO: 709 - DNA, 35 bp, Homo sapiens
aggccaattctccttaccttrgggtgtggagacca

SEQ ID NO: 710 - DNA, 39 bp, Homo sapiens
ttggggtgtggagaccacccctyagaatgggattgtggt

SEQ ID NO: 711 - DNA, 39 bp, Homo sapiens
tcagaatgggattgtggtaactgmtgcggaggcagggtc

SEQ ID NO: 712 - DNA, 39 bp, Homo sapiens
cagggtccctgcacctcctggacgtcracttcgcggaag

SEQ ID NO: 713 - DNA, 38 bp, Homo sapiens
cgacttcgcggaaggggtccttcggaraactgaaaggt

SEQ ID NO: 714 - DNA, 39 bp, Homo sapiens
gcaagctcatctgtgcaatcccygaggggtggcagtgtc

SEQ ID NO: 715 - DNA, 38 bp, Homo sapiens
ggctcaccggggccattgcggtccyggagcaccccctg

SEQ ID NO: 716 - DNA, 38 bp, Homo sapiens
tcaccggggccattgcggtcctgragcaccccctggcc

SEQ ID NO: 717 - DNA, 39 bp, Homo sapiens
gtttgcagcaccagggtgaaagygtttagctcaagtatg

SEQ ID NO: 718 - DNA, 39 bp, Homo sapiens
tgaaagtgtttagctcaagtatgcmgcttgtcggccaag

SEQ ID NO: 719 - DNA, 39 bp, Homo sapiens
atgcagcttgtcggccaagtggwtacctttgggctgagc

SEQ ID NO: 720 - DNA, 39 bp, Homo sapiens
cactcatggtctttcgcatcytgtggctcttaccttcac

SEQ ID NO: 721 - DNA, 39 bp, Homo sapiens
ggagaattctcttcttgtgcyggacacagcatctcattc

SEQ ID NO: 722 - DNA, 38 bp, Homo sapiens
agggcgtgtataatggaagctgrggaggccggggagag

SEQ ID NO: 723 - DNA, 38 bp, Homo sapiens
agattcctgctccaaaaygaggagaaatagtaagacag

SEQ ID NO: 724 - DNA, 37 bp, Homo sapiens
cggcattcaatttccctgtggyagtgtatggttggaa

SEQ ID NO: 725 - DNA, 37 bp, Homo sapiens
tttccctgtggcagtgtatgkttggaacaacgccatc

SEQ ID NO: 726 - DNA, 37 bp, Homo sapiens
atataatttttttcttttaagrgagaagtctgttgga

SEQ ID NO: 727 - DNA, 37 bp, Homo sapiens
gttggaacttggaggaaacawtgccattattggtaag

SEQ ID NO: 728 - DNA, 35 bp, Homo sapiens
gaggtgtaccactgcgaggcractggtgagtatat

SEQ ID NO: 729 - DNA, 33 bp, Homo sapiens
gaggtgtaccactgcgaggygactggtgagtat

SEQ ID NO: 730 - DNA, 37 bp, Homo sapiens
gcaaagaaagaaggtggcacagkggtctatgggggca

SEQ ID NO: 731 - DNA, 38 bp, Homo sapiens
tgcattaggttatggatcgccctrgaaattatgtagaa

SEQ ID NO: 732 - DNA, 37 bp, Homo sapiens
gttatggatcgccctggaaattakgtagaaccgacaa

SEQ ID NO: 733 - DNA, 37 bp, Homo sapiens
cgatgcgtccattgcacacacasagacttttgctccg

SEQ ID NO: 734 - DNA, 37 bp, Homo sapiens
tgcacacacagagacttttgctcygattctctatgtc

SEQ ID NO: 735 - DNA, 37 bp, Homo sapiens
gtaaaacagggactttcaagtarcatctttaccaaag

SEQ ID NO: 736 - DNA, 37 bp, Homo sapiens
tttacacagacctaaaggatcaractgtggcattgta

SEQ ID NO: 737 - DNA, 36 bp, Homo sapiens
agctggggaggccggggagaggtwcgcgggcgctca

SEQ ID NO: 738 - DNA, 36 bp, Homo sapiens
aagcatggaaaatctgggcagatgwaagtatggcct

SEQ ID NO: 739 - DNA, 36 bp, Homo sapiens
tccatcctttttctgtcctcasgatctggccatgca

SEQ ID NO: 740 - DNA, 37 bp, Homo sapiens
gtaattgctttttcctttctrggataatagccaaggt

SEQ ID NO: 741 - DNA, 36 bp, Homo sapiens
tgttattttttcccactaktactatcaactacagta

SEQ ID NO: 742 - DNA, 41 bp, Homo sapiens
tcctagagatggaaaaccctctgctygcatgttgctgctga

SEQ ID NO: 743 - DNA, 40 bp, Homo sapiens
ggtcaaaccaaccgcctgcatgacyggatagtctttcggc

SEQ ID NO: 744 - DNA, 40 bp, Homo sapiens
gctctatgagagacttgcacctyaactctgggacctgctg

SEQ ID NO: 745 - DNA, 39 bp, Homo sapiens
ggctgtggattctcttttacttctargactctaatccct

SEQ ID NO: 746 - DNA, 41 bp, Homo sapiens
agcgaagccaaaatgccctgccgtgygtacttgtaccaaag

SEQ ID NO: 747 - DNA, 37 bp, Homo sapiens
gttgcagctggaggaggatgagygcttcgagggccgc

SEQ ID NO: 748 - DNA, 37 bp, Homo sapiens
tgttgcagctggaggaggatgagcrcttcgagggccg

SEQ ID NO: 749 - DNA, 39 bp, Homo sapiens
tacaaccactcgggcgactacgagtgscacgtctaccgc

SEQ ID NO: 750 - DNA, 39 bp, Homo sapiens
ttcccctccctggctacccctmgatcctgcgctatgaga

SEQ ID NO: 751 - DNA, 38 bp, Homo sapiens
gctgtgcatctccgtgctgctgtygctcaccgtcttcc

SEQ ID NO: 752 - DNA, 39 bp, Homo sapiens
cgaggcggagatcagcctgctcgagwgcaaggtgtgctt

SEQ ID NO: 753 - DNA, 39 bp, Homo sapiens
cgcgcactctggccctcgagtgcscattctgcaggcgag

SEQ ID NO: 754 - DNA, 39 bp, Homo sapiens
tcgcgccgcccccagcgcccycggagccctcacctgcca

SEQ ID NO: 755 - DNA, 40 bp, Homo sapiens
actggtctttcttaagaagcacaygtcgtccatttgtgcc

SEQ ID NO: 756 - DNA, 40 bp, Homo sapiens
ctctaatcaagctctaggacaggcartgtcttcagcagct

SEQ ID NO: 757 - DNA, 40 bp, Homo sapiens
agcagctgcacaatggctttggagrttacgtgtgtacaac

SEQ ID NO: 758 - DNA, 40 bp, Homo sapiens
tttctttttcattttgtatctagcrttcaataaagattag

SEQ ID NO: 759 - DNA, 39 bp, Homo sapiens
ggagctcctggtgcttgaccccraggccttcaccatttt

SEQ ID NO: 760 - DNA, 41 bp, Homo sapiens
ctggaatctgatgtttctcttctcarcattaaccaggcagt

SEQ ID NO: 761 - DNA, 40 bp, Homo sapiens
aaatgatgttttgtttttcagktacttacacgccaagtca

SEQ ID NO: 762 - DNA, 40 bp, Homo sapiens
cacagagacctcaagagtaatrgtatccttcctgaaattt